(19) United States
(12) Patent Application Publication
(10) Pub. No.: US 2024/0212388 A1
(43) Pub. Date: Jun. 27, 2024

(54) WEARABLE DEVICES TO DETERMINE FACIAL OUTPUTS USING ACOUSTIC SENSING

(71) Applicant: Cornell University, Ithaca, NY (US)

(72) Inventors: Ke Li, Ithaca, NY (US); Cheng Zhang, Ithaca, NY (US); Francois Guimbretiere, Ithaca, NY (US); Ruidong Zhang, Ithaca, NY (US)

(21) Appl. No.: 18/597,419

(22) Filed: Mar. 6, 2024

Related U.S. Application Data
(63) Continuation-in-part of application No. 17/986,102, filed on Nov. 14, 2022.
Application No. 17/986,102 is a continuation-in-part of application No. PCT/US2021/032511, filed on May 14, 2021.
(60) Provisional application No. 63/450,344, filed on Mar. 6, 2023.
(60) Provisional application No. 63/343,023, filed on May 17, 2022.
(60) Provisional application No. 63/025,979, filed on May 15, 2020.

(51) Int. Cl. G06V 40/16; G06F 3/01; G06V 40/18

(52) U.S. Cl. CPC G06V 40/168; G06F 3/013; G06V 40/174; G06V 40/193

(57) ABSTRACT

This technology provides systems and methods for tracking facial movements and reconstructing facial expressions by learning skin deformation patterns and facial features. Frontal view images of a user making a variety of facial expressions are acquired to create a data training set for use in a machine-learning process. Head-mounted or neck-mounted wearable devices are equipped with one or more camera(s) or acoustic device(s) in communication with a data processing system. The cameras capture images of contours of the users face from either the cheekbone or the chin profile of the user. The acoustic devices transmit and receive signals to calculate a representation of the skin deformation. A data processing system uses the images, the profile of the contours, or skin deformation to track facial movement or to reconstruct facial expressions of the user based on the data training set.

### CROSS-REFERENCE TO RELATED APPLICATIONS

This application is a continuation-in-part of U.S. patent application Ser. No. 17/986,102, filed Nov. 14, 2022 and entitled “Wearable Facial Movement Tracking Devices,” which claims the benefit of U.S. Provisional Patent Application Ser. No. 63/343,023, filed May 17, 2022 and entitled “Wearable Facial Movement Tracking Devices” and is a continuation-in-part of PCT Patent Application No. PCT/US2021/032511, filed May 14, 2021 and entitled “Wearable Devices For Facial Expression Recognition,” which claims the benefit of U.S. Provisional Patent Application Ser. No. 63/025,979, filed May 15, 2020 and entitled “C-Face: Continuously Reconstructing Facial Expressions by Deep Learning Contours of the Face with Ear-Mounted Miniature Cameras.” The present application also claims the benefit of U.S. Provisional Patent Application Ser. No. 63/450,344, filed Mar. 6, 2023 and entitled “Wearable Devices to Determine Facial Outputs Using Acoustic Sensing.” The entire contents of the above-identified priority applications are hereby fully incorporated herein by reference.

### TECHNICAL FIELD

This disclosure relates to systems and methods to determine facial outputs from wearable devices.

### BACKGROUND

Humans use facial expressions as a natural mode of communication. The ability to continuously record and understand facial movements can improve interactions between humans and computers in a variety of applications.

Conventional facial reconstruction methods require a camera to be positioned in front of a user's face with a specified position and angle relative to the user's face. To achieve reliable facial reconstruction, the camera needs an entire view of the face without occlusions. Conventional facial reconstruction methods do not perform well if the user is in motion, the camera is not appropriately set up, the camera is not in front of the user, or the user's face is partially occluded or not fully visible to the camera due to the camera's position or angle relative to the user's face.

As an alternative to frontal camera systems, wearable devices for facial expression reconstruction have been developed using sensing techniques, such as acoustic interference, pressure sensors, electrical impedance tomography, and electromyography. These wearable devices use instrumentation that is mounted directly on a user's face. These conventional devices often cover the user's face and only recognize discrete facial expressions. Examples of these conventional wearable devices include face masks with built-in ultrasonic transducers or electrodes secured to a human face with electromyography or capacitive sensing abilities. These wearable devices are attached directly to the user's face or body and may block the field of vision and interfere with normal daily activities, such as eating or socializing.

Another alternative to frontal camera systems is smart eyewear including smart glasses, augmented reality glasses, and virtual reality headsets. However, these smart eyewear devices cannot track high-quality facial movements continuously. For example, virtual reality devices cannot depict 3D avatars in virtual worlds with facial expressions of the user.

### BRIEF DESCRIPTION OF THE DRAWINGS

FIG. 1 is a block diagram depicting a facial expression reconstruction system.

FIGS. 2A and 2B are perspective views of head-mounted wearable devices for facial expression reconstruction.

FIGS. 3A, 3B, and 3C are illustrations depicting examples of head-mounted wearable devices on a user.

FIG. 4 is a block diagram depicting a deep-learning model process.

FIG. 5 is a block diagram depicting a classifier process.

FIG. 6 is a diagram depicting the correlation between frontal view camera images, landmark training data, predicted facial expression landmarks, and right and left facial contour images.

FIG. 7 is a diagram depicting the correlation between frontal view camera images, two-dimensional training data, predicted two-dimensional facial expressions, and right and left facial contour images.

FIG. 8 is a block flow diagram depicting a method to reconstruct facial expressions.

FIG. 9 is a block flow diagram depicting a method to create a data training set using frontal view digital images.

FIG. 10 is a block flow diagram depicting a method to reconstruct facial expressions using one or more facial digital image(s).

FIG. 11 is a block flow diagram depicting a method to pre-process each pair of synchronized facial digital images.

FIGS. 12A, 12B, and 12C are perspective views of neck-mounted wearable devices for facial expression reconstruction.

FIGS. 13A and 13B are illustrations depicting examples of neck-mounted wearable devices on a user.

FIG. 14 is a block diagram depicting an alternate embodiment of a deep-learning model process.

FIG. 15A is a diagram depicting the correlation between frontal view camera images, three-dimensional training data, predicted three-dimensional face expressions, and infrared facial images.

FIG. 15B is a diagram depicting the correlation between frontal view camera images, three-dimensional training data, predicted three-dimensional face expressions, and infrared facial images.

FIG. 16 is a block flow diagram depicting an alternative method to create a data training set using frontal view images.

FIG. 17 is a block flow diagram depicting an alternative method to reconstruct facial expressions using one or more facial digital image(s).

FIG. 18 is a block flow diagram depicting an alternative method to pre-process the one or more digital facial image(s).

FIG. 19 is a block diagram depicting an acoustic sensor system based facial expression reconstruction system.

FIG. 20A is a block diagram depicting a first embodiment of an acoustic sensor system.

FIG. 20B is a block diagram depicting a second embodiment of an acoustic sensor system. FIG. 20C is a block diagram depicting a third embodiment of an acoustic sensor system.

FIG. 21 is a block diagram depicting a data processing module.

FIG. 22A depicts a first embodiment of a head-mounted acoustic sensor system wearable device. FIG. 22B is an illustration depicting the first embodiment of the head-mounted acoustic sensor system wearable device on a user.

FIG. 23A depicts a second embodiment of a head-mounted acoustic sensor system wearable device. FIG. 23B is an illustration depicting the second embodiment of the head-mounted acoustic sensor system wearable device on a user.

FIG. 24A depicts a third embodiment of a head-mounted acoustic sensor system wearable device. FIG. 24B is an illustration depicting the third embodiment of the head-mounted acoustic sensor system wearable device on a user.

FIG. 25 is a block flow diagram depicting a method to reconstruct facial expressions based on acoustic signals.

FIG. 26 is a diagram depicting an acoustic sensor system based facial expression reconstruction process.

FIG. 27 is a diagram depicting an acoustic sensor system based facial expression reconstruction output process.

FIG. 28 is a diagram depicting the correlation between frontal view camera images, predicted facial expressions, and left and right differential echo profiles.

FIG. 29 is a diagram depicting the correlation between frontal view camera images, training data, predicted facial expressions, and left and right differential echo profiles.

FIG. 30A is a diagram depicting the correlation between frontal view camera images of an open mouth, a left view image, a left and right echo profile, and a right view image. FIG. 30B is a diagram depicting the correlation between frontal view camera images of a right sneer, a left view image, a left and right echo profile, and a right view image.

FIG. 31 is a block diagram depicting a computing machine and a module.

FIG. 32 illustrates an example wearable device configured for acoustic-based eye tracking in an illustrative embodiment.

FIG. 33 illustrates example signal processing operations for acoustic-based eye tracking in an illustrative embodiment.

FIG. 34 shows aspects of additional illustrative embodiments of wearable devices configured for acoustic-based eye tracking.

FIG. 35 is a plot comparing eye tracking performance of an example wearable device in an illustrative embodiment with that of a conventional eye tracking system, across multiple study participants.

FIG. 36 illustrates an example wearable device configured for acoustic-based silent speech recognition in an illustrative embodiment.

FIG. 37 shows additional examples of wearable devices configured for acoustic-based silent speech recognition in illustrative embodiments.

FIG. 38 shows aspects of additional illustrative embodiments of wearable devices configured for acoustic-based silent speech recognition.

FIG. 39 shows plots of silent speech recognition performance in illustrative embodiments, across multiple study participants.

FIG. 40 shows plots of silent speech recognition performance in illustrative embodiments, for different signal paths and sensor configurations.

FIG. 41 is a block diagram of an information processing system comprising an acoustic interface system that includes a processing platform configured to implement machine learning based acoustic signal processing in an illustrative embodiment.

### DETAILED DESCRIPTION

The present technology in some embodiments allows reconstruction of facial expressions and tracking of facial movements using non-obtrusive, wearable devices that capture optical or acoustical images of facial contours, chin profiles, or skin deformation of a user's face. The wearable devices include head-mounted technology that continuously reconstruct full facial expressions by capturing the positions and shapes of the mouth, eyes, and eyebrows. Miniature cameras capture contours of the sides of the face, which are used to train a deep-learning model to predict facial expressions. An alternate embodiment of this technology includes a neck-mounted technology to continuously reconstruct facial expressions. Infrared cameras capture chin and face shapes underneath the neck, which are used to train a deep-learning model to predict facial expressions.

Additional embodiments include various camera types or acoustic imaging systems for the wearable devices. The acoustic imaging systems may comprise microphones and speakers. For example, the wearable devices may use the microphones and speakers to transmit and receive acoustical signals to determine skin deformation of a user. Full facial movements and expressions can be reconstructed from subtle skin deformations. The wearable devices may comprise ear mounted devices, eye mounted devices, or neck mounted devices.

The systems of this technology include wearable devices configured with miniature cameras or acoustical imaging systems in communication with computing devices to transmit images or acoustical signals from the cameras or acoustical imaging systems to a remote server, data acquisition system, or data processing device for facial expression reconstruction or to track facial movement. The wearable devices include headphone, earbud, necklace, neckband, glasses, virtual reality (“VR”) headsets, augmented reality (“AR”) headsets, and other form factors. Each of the form factors include miniature cameras or acoustical imaging systems and micro computing devices, such as Raspberry Pi™.

The exemplary headphone device includes two cameras and may include functionality with Bluetooth or Wi-Fi connectivity and speakers embedded within the earpieces of the headphone. The cameras are attached to the earpieces of the headphone device and are connected to a computing device to transmit acquired images to a remote server. The headphone device is configured to acquire images of the contours of a user's face by directing the cameras at adjustable angles and positions.

The exemplary earbud devices are constructed for wearing as a left-side earbud and a right-side earbud. Both the left and right earbud devices include a camera to acquire images of the contours of a user's face. Each camera is connected to a computing device to transmit acquired images to a remote server.

The exemplary necklace device includes an infrared (“IR”) camera with an IR LED and an IR bandpass filter. The necklace device is configured to acquire images of a user's chin profile by directing the camera at the profile of a user's chin. The IR LED projects IR light onto a user's chin to enhance the quality of the image captured by the camera. The IR bandpass filter filters visible light such that the camera captures infrared light reflected by a user's skin. The camera is connected to a computing device to transmit acquired images to a remote server.

The exemplary neckband device includes two cameras fashioned to be positioned on the left and right sides of a user's neck. The neckband device includes IR LEDs and IR bandpass filters configured in proximity to each camera, similar to the necklace device. Each camera is connected to a computing device to transmit acquired images to a remote server.

Using one of the wearable devices, facial expressions can be reconstructed from images acquired from the cameras within the devices. A data training set is created using frontal view images of a user in a machine learning algorithm. Multiple frontal view images of a user are acquired with a variety of facial expressions. The frontal view images are transmitted to a data processing system to create the data training set.

The wearable device captures one or more facial digital image(s) and transmits the digital images to data acquisition computing devices connected to each of the cameras of the wearable device. The data acquisition computing devices subsequently transmit the images to a remote server or data processing system. The data processing system reconstructs facial expressions using the images. The data processing system pre-processes the images by reducing the image size, removing noise from the image, extracting skin color from the background of the image, and binarizing each the image. In some embodiments, a wearable imaging system comprises one or more imaging sensor(s), wherein the one or more imaging sensor(s) are positioned to capture one or more image(s) with incomplete side contours of a face (for example, from car(s) and/or from neck), a processor, and a non-transitory machine-readable storage medium comprising machine-readable instructions executed by the processor to extract a plurality of features (for example, landmarks or parameters) from the one or more image(s), compare the extracted features and/or changes of the extracted features with features from a ground truth, and output one or more recognition or prediction result(s), wherein the results comprise a word or a phrase spoken by a user, an emoji of a facial expression of a user, and/or a real-time avatar of a facial expression of a user.

The data processing system applies a deep-learning model to the pre-processed images for facial expression reconstruction. The reconstructed facial expressions may be used in applications such as silent speech and emoji recognition.

In an alternate embodiment, acoustic sensing technology can be used to reconstruct facial expressions using an array of microphones and speakers and deep-learning models. Acoustic sensing technology is small, lightweight and, therefore, suitable to mount to a variety of wearable devices. Facial movements may be tracked by detecting skin deformations observed from different positions on a user's head. When a user performs facial movements, the skin on the face deforms with unique patterns. Using acoustic sensing technology, skin deformations may be captured without capturing images of the entire face. The acoustic technology comprises a wearable device such as headphones, earbuds, necklaces, neckbands, and any other suitable form factors such that the microphones and speakers can be mounted or attached to the wearable device. The positions of the microphones and speakers may be adjustable to optimize the recording of reflected signals.

The acoustic wearable device actively sends signals from the speakers towards a user's face. The signals are reflected by the user's face and captured by the microphones on the acoustic wearable device. The signals are reflected differently back towards the microphones based on different facial expressions or movements. The acoustic wearable device sends the transmitted and reflected signals to a computing device for further processing. An echo profile is calculated based on the transmitted and reflected acoustic signals. The echo profile is calculated by calculating a cross-correlation between the received acoustic signals and the transmitted acoustic signals, which can display the deformations of the skin in temporal and spatial domains. The echo profile is input into a deep learning module to reconstruct the facial expressions of the user.

While acoustic sensing technology may be used to determine facial expressions by detecting skin deformations, acoustic sensing technology may also be used to directly determine other outputs associated with skin deformation without the need to first determine facial expressions. For example, the acoustic sensing technology may track blinking patterns and eyeball movements of a user. Blinking patterns and eyeball movements can be applied to the diagnosis and treatment processes of eye diseases. The acoustic sensing technology may detect movements of various parts of the face associated with speech, whether silent or voiced. While speaking, different words and/or phrases lead to subtle, yet distinct, skin deformations. The acoustic sensing technology can capture the skin deformation to recognize silent speech or to vocalize sound. The acoustic sensing technology may also be used to recognize and track physical activities. For example, while eating, a user opens the mouth, chews, and swallows. During each of those movements, the user's skin deforms in a certain way such that opening the mouth is distinguishable from chewing and from swallowing. The detected skin deformations may be used to determine the type and quantity of food consumed by a user. Similar to eating, a type and quantity of a consumed drink may be determined by skin deformation. The acoustic sensing technology may also be used to determine an emotional status of a user. An emotional status may be related to skin deformations. By detecting skin deformations, an emotional status can be determined and reported to corresponding applications.

These and other aspects, objects, features, and advantages of the disclosed technology will become apparent to those having ordinary skill in the art upon consideration of the following detailed description of illustrated examples.

### Example System Architecture

Turning now to the drawings, in which like numerals indicate like (but not necessarily identical) elements throughout the figures, examples of the technology are described in detail.

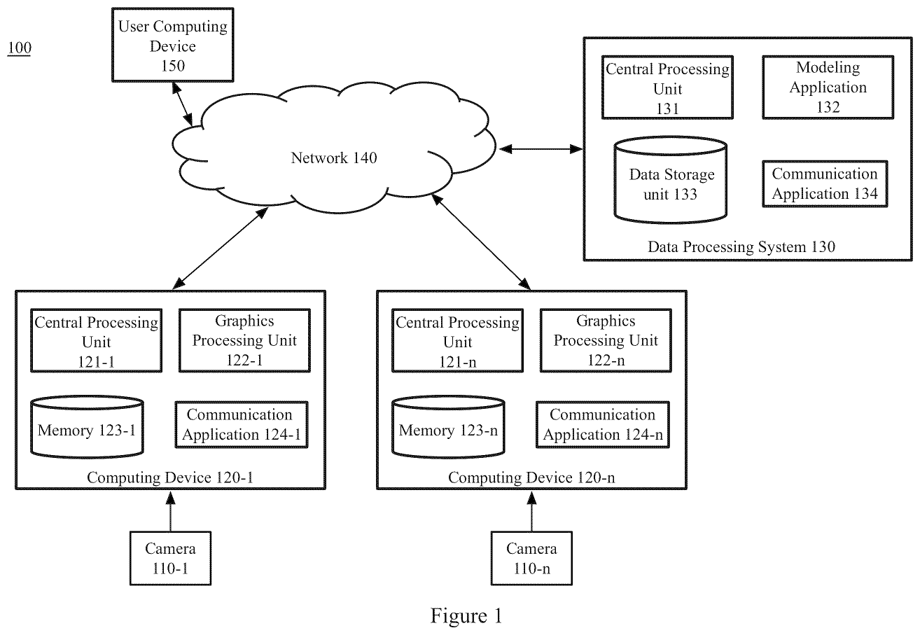

FIG. 1 is a block diagram depicting a facial expression reconstruction system 100, in accordance with certain examples. As depicted in FIG. 1, the facial expression reconstruction system 100 comprises cameras 110-1 through 110-n, computing devices 120-1 through 120-n, data processing system 130, and user computing device 150. Computing devices 120, data processing system 130, and user computing device 150 are configured to communicate via a network 140.

In example embodiments, network 140 includes one or more wired or wireless telecommunications system(s) by which network devices may exchange data. For example, the network 140 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a BLUETOOTH® wireless technology connection, a near field communication (NFC) connection, any combination thereof, and any other appropriate architecture or system that facilitates the communication of signals, data, and/or messages.

Facial expression reconstruction system 100 comprises cameras 110 that may be any suitable sensors for capturing images. For example, cameras 110 may include depth cameras, red-green-blue (“RGB”) cameras, infrared (“IR”) sensors, acoustic cameras or sensors, speakers, microphones, thermal imaging sensors, charge-coupled devices (“CCDs”), complementary metal oxide semiconductor (“CMOS”) devices, active-pixel sensors, radar imaging sensors, fiber optics, and any other suitable image device technology.

The image frame resolution of the camera 110 may be defined by the number of pixels in a frame. The image frame resolution of the camera 110 may comprise any suitable resolution, including of the following resolutions, without limitation: 32×24 pixels; 32×48 pixels; 48×64 pixels; 160×120 pixels, 249×250 pixels, 250×250 pixels, 320×240 pixels, 420×352 pixels, 480×320 pixels, 640×480 pixels, 720×480 pixels, 1280×720 pixels, 1440×1080 pixels, 1920×1080 pixels, 2048×1080 pixels, 3840×2160 pixels, 4096×2160 pixels, 7680×4320 pixels, or 15360×8640 pixels. The image frame resolution of the camera 110 may comprise a resolution within a range defined by any two of the preceding pixel resolutions, for example, within a range from 32×24 pixels to 250×250 pixels (for example, 249×250 pixels). In some embodiments, at least one dimension (the height and/or the width) of the image frame resolution of the camera 110 can be any of the following, including but not limited to 8 pixels, 16 pixels, 24 pixels, 32 pixels, 48 pixels, 72 pixels, 96 pixels, 108 pixels, 128 pixels, 256 pixels, 360 pixels, 480 pixels, 720 pixels, 1080 pixels, 1280 pixels, 1536 pixels, or 2048 pixels. The camera 110 may have a pixel size smaller than 1 micron, 2 microns, 3 microns, 5 microns, 10 microns, 20 microns, and the like. The camera 110 may have a footprint (for example, a dimension in a plane parallel to a lens) on the order of 10 mm×10 mm, 8 mm×8 mm, 5 mm×5 mm, 4 mm×4 mm, 2 mm×2 mm, or 1 mm×1 mm, 0.8 mm×0.8 mm, or smaller.

Each camera 110 is in communication with a computing device 120. Each camera 110 is configured to transmit images or data to a computing device 120. Each camera 110 may be communicatively coupled to a computing device 120. In an alternate example, each camera 110 may communicate wirelessly with a computing device 120, such as via near field communication (“NFC”) or other wireless communication technology, such as Bluetooth, Wi-Fi, infrared, or any other suitable technology.

Computing devices 120 comprise a central processing unit 121, a graphics processing unit 122, a memory 123, and a communication application 124. In an example, computing devices 120 may be small, single-board computing devices, such as a Raspberry Pi™ device. Computing devices 120 function to receive images or data from cameras 110 and to transmit the images via network 140 to a data processing system 130.

Computing device 120 comprises a central processing unit 121 configured to execute code or instructions to perform the operations and functionality described herein, manage request flow and address mappings, and perform calculations and generate commands. Central processing unit 121 may be configured to monitor and control the operation of the components in the computing device 120. Central processing unit 121 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. Central processing unit 121 may be a single processing unit, multiple processing units, a single processing core, multiple processing cores, special purpose processing cores, co-processors, or any combination thereof. Central processing unit 121 along with other components of the computing device 120 may be a virtualized computing machine executing within one or more other computing machine(s).

Computing device 120 comprises a graphics processing unit 122 that serves to accelerate rendering of graphics and images in two- and three-dimensional spaces. Graphics processing unit 122 can process multiple images, or data, simultaneously for use in machine learning and high-performance computing.

Computing device 120 comprises a memory 123. Memory 123 may include non-volatile memories, such as read-only memory (“ROM”), programmable read-only memory (“PROM”), erasable programmable read-only memory (“EPROM”), flash memory, or any other device capable of storing program instructions or data with or without applied power. Memory 123 may also include volatile memories, such as random access memory (“RAM”), static random access memory (“SRAM”), dynamic random access memory (“DRAM”), and synchronous dynamic random access memory (“SDRAM”). Other types of RAM also may be used to implement memory 123. Memory 123 may be implemented using a single memory module or multiple memory modules. While memory 123 is depicted as being part of the computing device 120, memory 123 may be separate from the computing device 120 without departing from the scope of the subject technology.

Computing device 120 comprises a communication application 124. Communication application 124 interacts with web servers or other computing devices or systems connected via network 140, including data processing system 130.

Facial expression reconstruction system 100 comprises a data processing system 130. Data processing system 130 serves to receive images or data from cameras 110 via computing devices 120 and network 140. Data processing system 130 comprises a central processing unit 131, a modeling application 132, a data storage unit 133, and a communication application 134.

Data processing system 130 comprises central processing unit 131 configured to execute code or instructions to perform the operations and functionality described herein, manage request flow and address mappings, and perform calculations and generate commands. Central processing unit 131 may be configured to monitor and control the operation of the components in the data processing system 130. Central processing unit 131 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. Central processing unit 131 may be a single processing unit, multiple processing units, a single processing core, multiple processing cores, special purpose processing cores, co-processors, or any combination thereof. Central processing unit 131 along with other components of the data processing system 130 may be a virtualized computing machine executing within one or more other computing machine(s).

Data processing system 130 comprises a modeling application 132. The modeling application 132 employs a variety of tools, applications, and devices for machine learning applications. The modeling application 132 may receive a continuous or periodic feed of images or data from one or more of the computing device(s) 120, the central processing unit 131, or the data storage unit 133. Collecting the data allows the modeling application 132 to leverage a rich dataset to use in the development of a training set of data or ground truth for further use in facial expression reconstructions. The modeling application 132 may use one or more machine learning algorithm(s) to develop facial expression reconstructions, such as a convolution neural network (“CNN”), Naïve Bayes Classifier, K Means Clustering, Support Vector Machine, Apriori, linear regression, logistic regression, decision trees, random forest, or any other suitable machine learning algorithm.

Data processing system 130 comprises a data storage unit 133. Data storage unit 133 may be accessible by the modeling application 132 and the communication application 134. The example data storage unit 133 can include one or more tangible computer-readable storage device(s). The data storage unit 133 can be within the data processing system 130 or can be logically coupled to the data processing system 130. For example, the data storage unit 133 can include on-board flash memory and/or one or more removable memory device(s) or removable flash memory. In certain embodiments, the data storage unit 133 may reside in a cloud-based computing system.

Data processing system 130 comprises a communication application 134. Communication application 134 interacts with web servers or other computing devices or systems connected via network 140, including the computing devices 120 and user computing device 150.

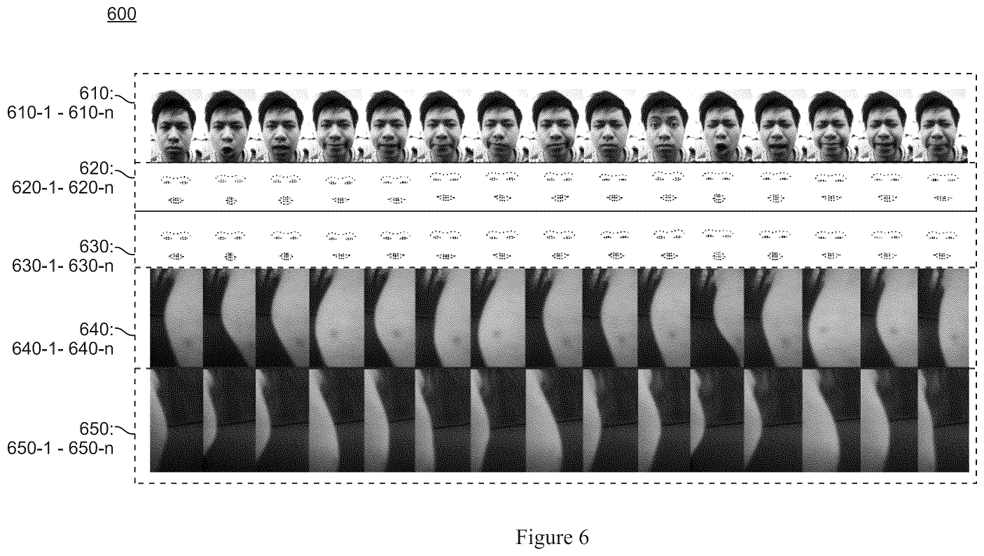

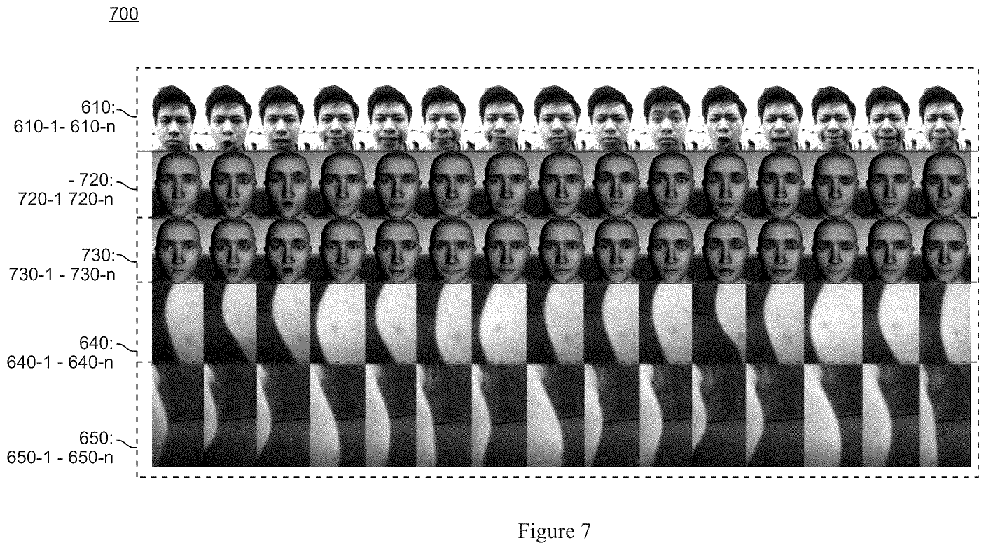

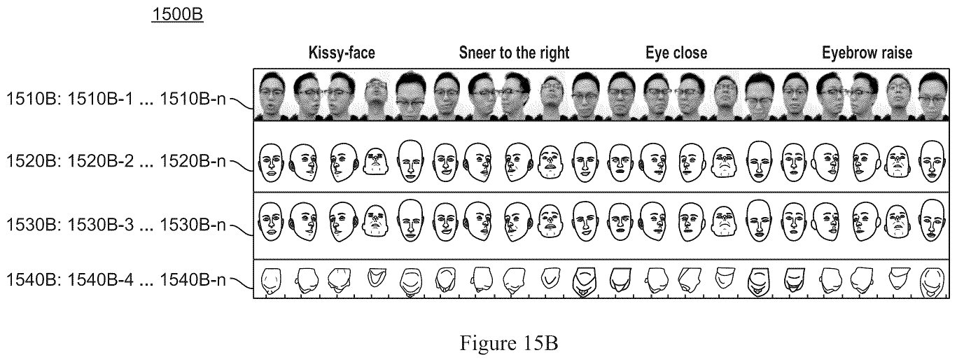

User computing device 150 is a computing device configured to receive and communicate results of facial expression reconstruction or facial movement. The results of the facial expression reconstruction may be displayed as a graphical representation of a facial expression, such as 630 of FIG. 6, a predicted facial expression with three-dimensional visualization, such as 730 of FIG. 7, a three-dimensional facial expression, such as 1530A of FIG. 15A, an emoji, text or audio representing silent speech recognition, or any other suitable display of facial expression reconstruction results. The user computing device 150 also may comprise a speaker to audibly communicate the facial expression reconstruction results directed to silent speech recognition. In an alternate embodiment by tracking facial movement, user computing device 150 may determine skin deformation or stretching and, subsequently, directly determine one or more of facial expression(s), eyeball movement, or eye-related disease. By tracking facial movement, user computing device 150 may recognize, or make audible, silent speech, and recognize and track human activities involving facial movements such as eating or drinking. By tracking facial movement, user computing device 150 may synthesize a user's voice or determine a user's emotional status.

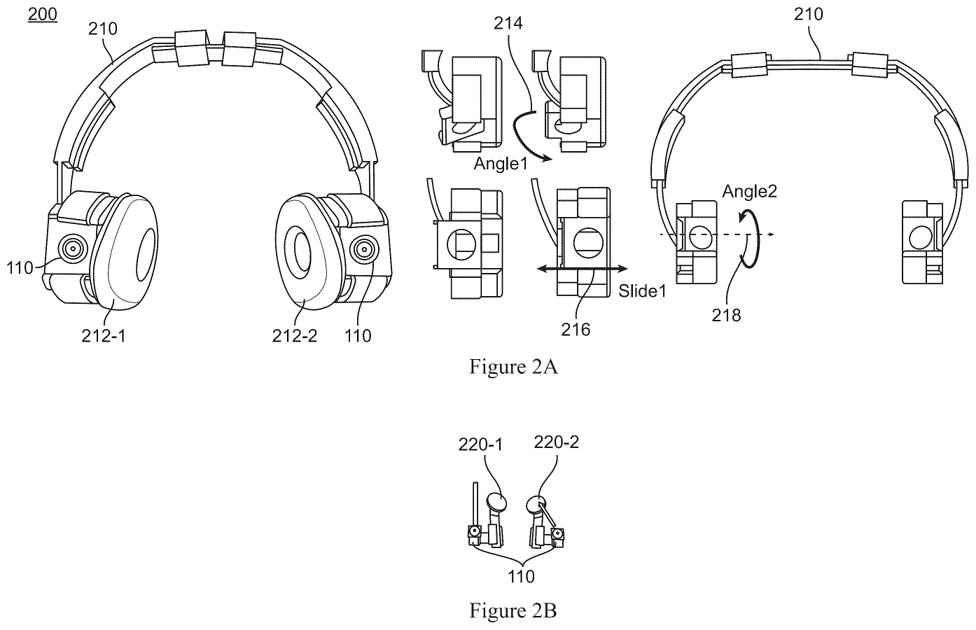

FIGS. 2A and 2B are perspective views 200 of head-mounted wearable devices 210, 220, respectively, for facial expression reconstruction, in accordance with certain examples.

FIG. 2A depicts a headphone-style wearable device 210 (herein referred to as headphone device 210 or headphone 210) as a form factor to acquire images or data for use in facial expression reconstruction, in accordance with certain examples. Headphone device 210 comprises two cameras 110-1 and 110-2 to acquire images of a left and a right contour, respectively. Cameras 110 were previously described herein with reference to FIG. 1. In an example, headphone device 210 is a device constructed of a band suitable to wear across the top of a user's head with a left-side earpiece 212-1 and a right-side earpiece 212-2. In an example, headphone device 210 may be over-the-ear headphones or outside-the-ear headphones. In an example, headphone device 210 may include functionality with Bluetooth or Wi-Fi connectivity and speakers embedded within the earpieces 212. Camera 110-1 is connected to left-side earpiece 212-1, and camera 110-2 is connected to right-side earpiece 212-2. In an alternate example, two cameras 110 are connected to each of the left-side earpiece 212-1 and right-side earpiece 212-2. Any suitable number of cameras may be connected to each of the earpieces 212. Each camera 110 is in communication with a computing device 120, as previously described with respect to FIG. 1. In an example, computing device 120 may be connected to each camera 110 and be embedded within the headphone device 210. In an alternate example, each camera 110 may communicate with a computing device 120 via a wireless technology, such as Bluetooth or Wi-Fi.

Headphone device 210 is configured to acquire images of a left and a right contour of a user's face by directing cameras 110-1 and 110-2 at adjustable angles and positions. Each of the cameras 110 are independently adjustable by a first angle 214, a slide 216, and second angle 218. First angle 214 adjusts a tilt of the position of the camera 110 relative to a plane parallel to an exterior surface of a user's ear. The first angle 214 may be adjusted so that the camera 110/earpiece 212 assembly is tilted closer to a user's ear, or the first angle 214 may be adjusted so that the camera 110 via the earpiece 212 is tilted farther away or offset from a user's ear. In an example, first angle 214 may be 0° indicating that the camera 110/earpiece 212 assembly is in a vertical position relative to a plane parallel to the exterior surface of a user's ear. First angle 214 may be adjusted by −10°, −20°, −30°, −40°, or any suitable angle measure relative to the plane parallel to the exterior surface of a user's ear, such that each camera 110 may be aligned with the left and right contours of a user's face.

Slide 216 adjusts a position of the camera 110 relative to the earpiece 212 in a direction that is perpendicular to a plane parallel to the exterior surface of a user's ear, in other words, the position of the camera 110 may change along the slide 216 while the position of the earpiece 212 is fixed. The position of the camera 110 via the slide 216 may be adjusted such that the earpiece 212 is in close contact with an exterior surface of a user's ear. The position of the camera 110 via the slide 216 may be adjusted such that the camera 110 is extended a distance away from the plane parallel to the exterior surface of a user's ear. In an example, the extended distance may be 1 cm, 2 cm, 3 cm, or any suitable distance away from the plane parallel to the exterior surface of a user's car. The slide 216 positions the cameras 110 in a manner similar to positioning the earpieces 212 of the headphone device 210. In some embodiments, the position of an imaging sensor or a camera (for example, the optical center of the lens in the camera) is less than 5 cm, less than 4 cm, less than 3 cm, less than 2 cm, less than 1 cm, or less than 0.5 cm away from the surface plane of a user's ear. In some embodiments, the position of an imaging sensor or a camera projected to the closest skin surface is within the region of a user's ear or less than 5 cm, less than 4 cm, less than 3 cm, less than 2 cm, or less than 1 cm away from the nearest contour edge of a user's ear. In some embodiments, the system comprises at least one, at least two, or at least three imaging sensors (for example, cameras) located in different positions as described above. In some embodiments, an imaging sensor, such as a camera, is positioned below a chin of a user and less than 25 cm, less than 20 cm, less than 15 cm, less than 10 cm, or less than 5 cm away from the chin of a user, or 2-30 cm below and away from the chin of the user.

Second angle 218 adjusts a rotational position of the camera 110 along a horizontal axis through earpieces 212-1 and 212-2. In an example, second angle 218 adjusts an angular position of the camera 110 relative to the horizontal axis while the position of the earpiece 212 remains unchanged. In an alternate example, second angle 218 adjusts an angular position of the camera 110/earpiece 212 assembly. Relative to a left or right contour of a user's face, second angle 218 may be 0° indicating that the camera 110 is in a horizontal position. A second angle 218 of 10° indicates that the camera 110 is directed 10° upwards. A second angle 218 of −10° indicates that the camera 110 is directed 10° downwards. Any suitable measure of second angle 218 may be used to align the cameras 110 with the contour of a user's face.

Each of the cameras 110 are independently adjustable by the first angle 214 and the second angle 218, by any suitable mechanism, for example, by mounting the cameras 110 to the headphone device 210 via rotational positioning devices allowing incremental changes of the direction of the cameras 110.

FIG. 2B depicts earbud-style wearable devices 220-1 and 220-2 (herein referred to as earbud devices 220 or earbuds 220) as a form factor to acquire images or data for use in facial expression reconstruction, in accordance with certain examples. Earbud device 220-1 is constructed for wear as a left-side earbud, and earbud device 220-2 is constructed for wear as a right-side earbud. In an example, earbud device 220 may be ear pods, earphones, or in-the-car (“ITE”) headphones. Earbud device 220-1 comprises a camera 110-1, and earbud device 220-2 comprises a camera 110-2 to acquire images of a left and a right contour, respectively, of a user's face by directing cameras 110-1 and 110-2 at the left and right contours of a user's face. Cameras 110-1 and 110-2 were previously described in reference to FIG. 1. In an example, earbud devices 220 may include functionality with Bluetooth or Wi-Fi connectivity and speakers embedded within the earbuds 220. Each camera 110 is in communication with a computing device 120, as previously described with respect to FIG. 1. In an example, a computing device 120 may be connected to each camera 110 and be embedded within each earbud device 220. In an alternate example, each camera 110 may communicate with a computing device 120 via a wireless technology, such as Bluetooth or Wi-Fi.

The camera 110 position for each earbud device 220 may be controlled by twisting and/or rotating the earbud device 220 in the user's ear. The earbud device 220 may be rotated such that the camera 110 is angled closer to the contour of a user's face. In an alternate example, the camera 110 may be attached to the earbud device 220 such that the camera 110 may be positioned independently of the earbud device 220. The camera 110 may be attached to the earbud device 220 with a ball and socket joint or any other suitable attachment method such that the position of the camera 110 may be adjusted independently of the earbud device 220.

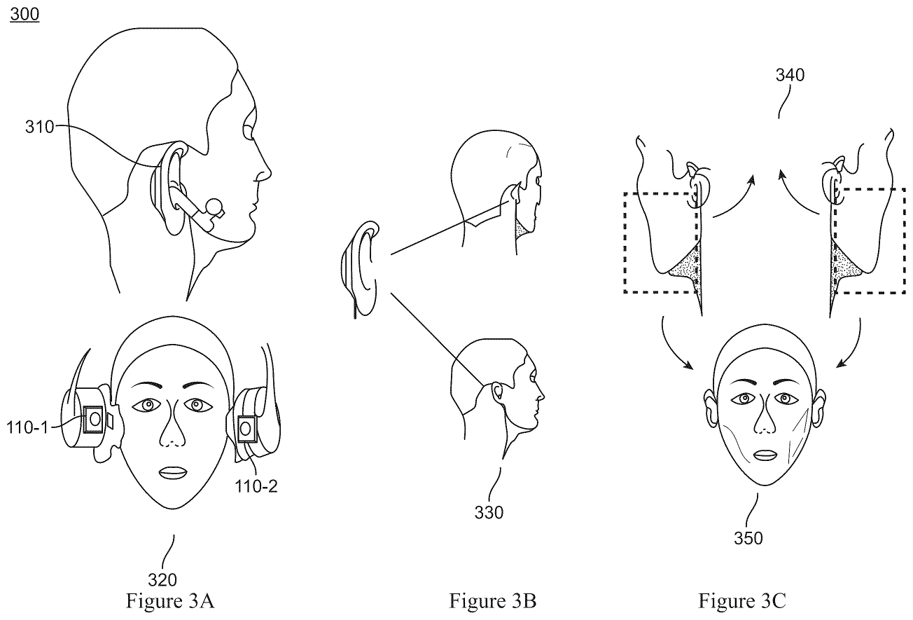

FIGS. 3A, 3B, and 3C are illustrations 300 depicting examples 310-350 of head-mounted, wearable devices 210, 220 on a user, camera views 330, captured facial contours 340, and corresponding facial expressions 350, in accordance with certain examples. In FIG. 3A, earbuds 220 are illustrated in a closeup view of the back of a user's ear. Camera 110 of the earbuds 220 is illustrated in this example as being positioned in a forward direction towards a right contour of a user's face. Although not depicted in FIG. 3A, a second earbud 220 is worn by the user in the opposite, left ear, having a camera 110 positioned in a forward direction towards a left contour of the user's face.

Also, in FIG. 3A, alternative headphone 210 is illustrated in a closeup view from a front perspective of the user. Cameras 110-1 and 110-2 of the headphone 210 are illustrated in this example as being positioned in a forward direction towards left and right contours of a user's face.

FIG. 3B depicts a back and side view of a user to illustrate the contour of the user's face from the point of view of a camera 110 in either the earbud device 220 or headphone device 210 depicted in FIG. 3A.

FIG. 3C depicts the left and right contours of a user's face as captured by cameras 110 through the use of the headphone 210 or the earbuds 220. FIG. 3B also depicts the facial expression of a user a reconstructed through the images captured by cameras 110 through the use of the headphone 210 or the earbuds 220.

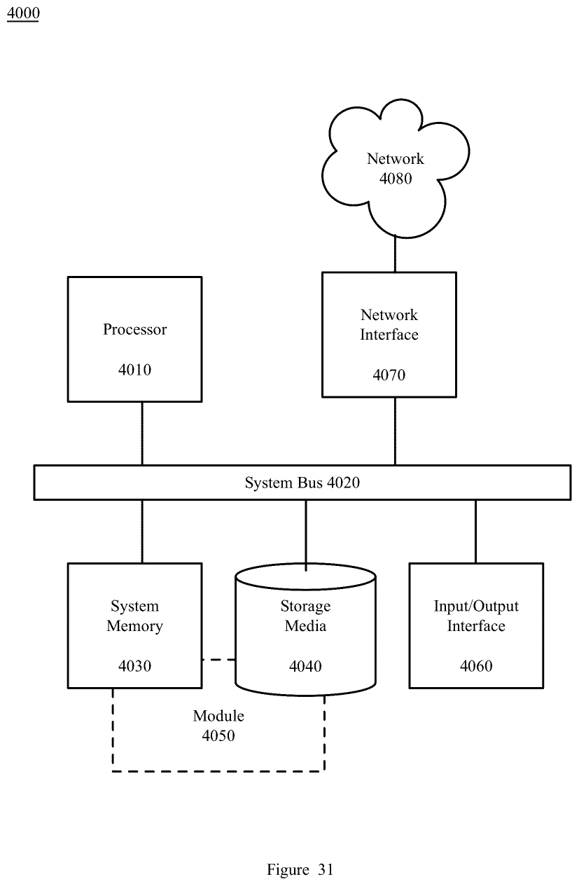

The computing devices 120, data processing system 130, and user computing device 150 and any other network computing devices other computing machines associated with the technology presented herein may be any type of computing machine, such as, but not limited to, those discussed in more detail with respect to FIG. 31. For example, each device can include any suitable processor-driven device.

Furthermore, any functions, applications, or components associated with any of these computing machines, such as those described herein or others (for example, scripts, web content, software, firmware, hardware, or modules) associated with the technology presented herein may be any of the components discussed in more detail with respect to FIG. 31.

The network connections illustrated are examples and other means of establishing a communications link between the computers and devices can be used. The computing machines discussed herein may communicate with one another, as well as with other computing machines or communication systems over one or more network(s). Each network may include various types of data or communications networks, including any of the network technology discussed with respect to FIG. 31.

Additionally, those having ordinary skill in the art having the benefit of the present disclosure will appreciate that the devices illustrated in the figures may have any of several other suitable computer system configurations.

### Example Processes

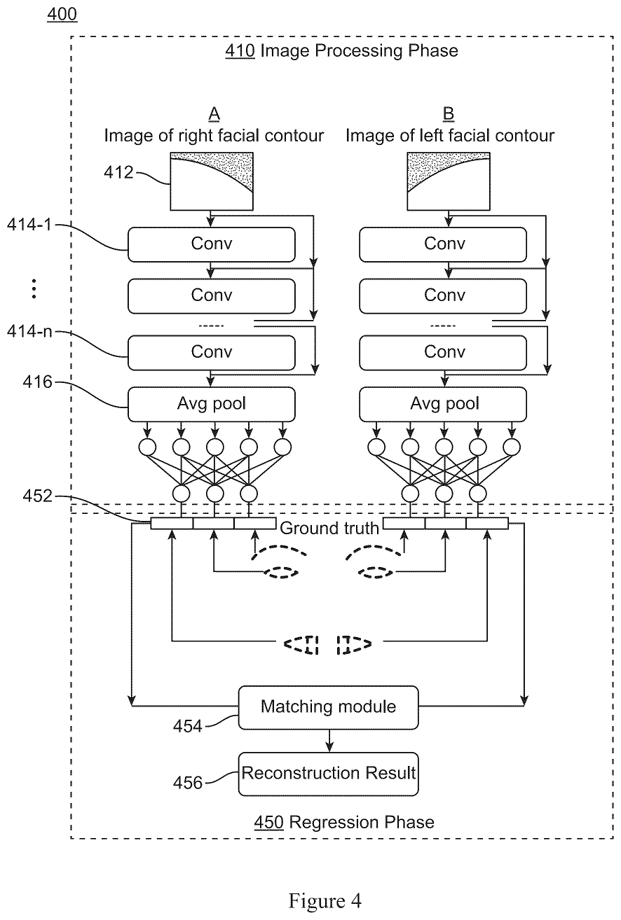

The methods illustrated in FIGS. 4 through 11 are described hereinafter with respect to the components of facial expression reconstruction system 100, headphone device 210 of FIG. 2A, and earbud devices 220 of FIG. 2B. The methods of FIGS. 4 through 11 may also be performed with other systems and in other environments. The operations described with respect to FIGS. 4 through 11 can be implemented as executable code stored on a computer- or machine-readable, non-transitory, tangible storage medium (for example, floppy disk, hard disk, ROM, EEPROM, nonvolatile RAM, CD-ROM, etc.) that are completed based on execution of the code by a processor circuit implemented using one or more integrated circuit(s); the operations described herein also can be implemented as executable logic that is encoded in one or more non-transitory, tangible media for execution (for example, programmable logic arrays or devices, field programmable gate arrays, programmable array logic, application specific integrated circuits, etc.).

FIG. 4 is a block diagram depicting a deep-learning model process 400, in accordance with certain examples. The deep-learning model process 400 may be performed by the modeling application 132 of the data processing system 130, previously described herein in reference to FIG. 1. In an example where the machine learning algorithm is a convolution neural network (“CNN”), the deep-learning model process 400 receives images as an input and assigns importance (learnable weights and biases) to various aspects/objects in the images. The CNN reduces the images into a form that is easier to process without losing the features of the images that are used to get a good prediction. In the current example, the prediction is a reconstructed facial expression based on the received right and left contour facial images.

The deep-learning model process 400 comprises an image processing phase 410 and a regression phase 450. In the image processing phase 410, image processing is divided into two parallel paths. Path A is directed to processing an image of a right facial contour, and path B is directed to processing an image of a left facial contour. The right facial contour images and left facial contour images are processed independently of each other and combined in a matching module 454 of the deep-learning model process 400.

In block 412, the data processing system 130 receives an input of an image of a right facial contour and an input of an image of a left facial contour. Example right facial contour images are depicted in row 640 of FIGS. 6 and 7, and example left facial contour images are depicted in row 650 of FIGS. 6 and 7. The images are transmitted through blocks 414-1 through 414-n. Blocks 414-1 through 414-n comprise layers of the CNN that include multiple convolution filtering operations. In an example, the CNN may comprise between 32 and 512 layers to extract features from the images. The first convolution layer in block 414-1 captures low-level features, such as edges, color, and gradient orientation. As the process progresses through the additional layers to layer 414-n, higher-level features are captured such that the object of the image is captured. In the current example, the object of the image is a facial contour.

From block 414-n, the process proceeds to block 416. Block 416 is a pooling layer. The pooling layer may be a Max Pooling that returns a maximum value from the image. The pooling layer may be an Average Pooling that returns an average of all of the values from the image. The pooling layer of block 416 outputs a vector representation of each input image (in other words, a right image vector for the right facial contour and a left image vector for the left facial contour).

The right image vector and the left image vector are received as inputs to the regression phase 450. Within the regression phase 450, the right image vector and the left image vector are inputs into two fully connected layers 452 with a rectified linear unit (“ReLU”) between the fully connected layer 452. The fully connected layer 452 learns facial landmarks of the right image vector and the left image vector based on facial landmarks in a training data set, or ground truth, set of facial expressions. The fully connected layer 452 compares features of the right image vector to right side facial landmarks in the training data set of facial expressions to match the features of the right image vector to a right side facial expression in the training data set. Similarly, the fully connected layer 452 compares features of the left image vector to left side facial landmarks in the training data set of facial expressions to match the features of the left image vector to a left side facial expression in the training data set. The fully connected layer 452 outputs landmarks of both the right and left side of a user's face. The output landmarks are inputs to the matching module 454. The matching module 454 concatenates the landmarks from the right and left sides by aligning key landmarks that are present in both the right and left sides using translation and scaling. The matching module 454 outputs the final facial expression reconstruction, or predicted facial expression, as a set of facial landmarks as the reconstruction result in block 456. Examples of predicted facial expressions as a set of facial landmarks are depicted in row 630 of FIG. 6. In an alternate example, the facial expression reconstruction is further modeled to create a three-dimensional visualization of the predicted facial expression as depicted in row 730 of FIG. 7. The deep-learning model process 400 continues to repeat as additional right facial contour images and left facial contour images are received.

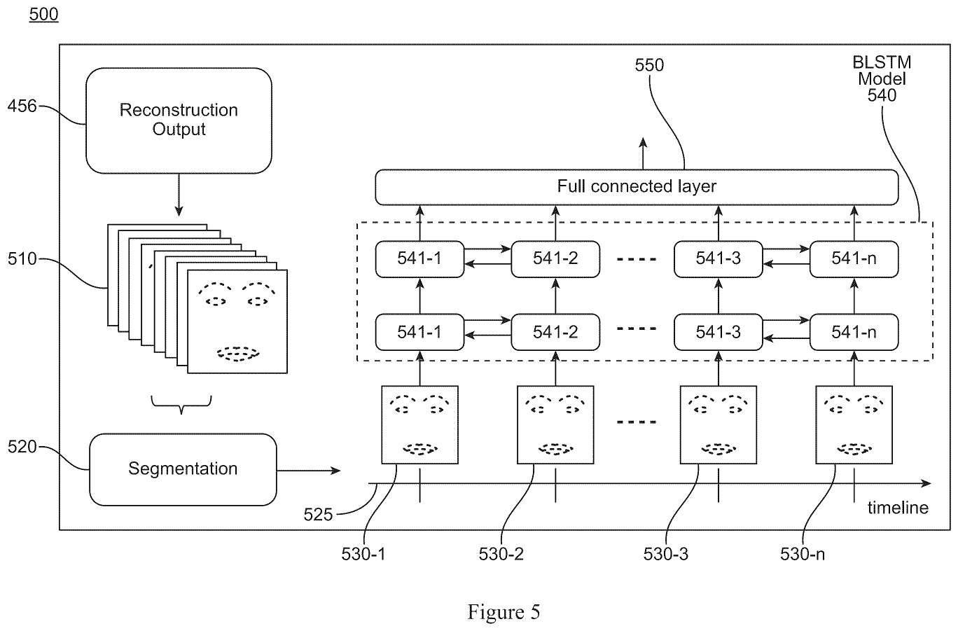

FIG. 5 is a block diagram depicting a classifier process 500, in accordance with certain examples. The classifier process 500 classifies the facial expression reconstruction output 456 of the deep-learning model process 400 for use in applications such as silent speech recognition, emoji input, real-time avatar facial expressions, or other suitable applications. In block 510, the reconstruction output 456 from the deep-learning model process 400 of FIG. 4 is received as input to the classifier process 500. In block 510, a stream of landmark positions from the reconstruction output 456 are received as frames. In block 520, the landmark positions are segmented. Segmentation extracts an event from a stream of data and labels its start and end time. In the example of silent speech recognition, segmentation would identify the initial facial expression associated with the pronunciation of a word and the final facial expression associated with the pronunciation of the same word. For each frame, two indicators are calculated to measure the degree of transformation for the mouth and eyes, known as the Mouth Transformation Degree (“MTD”) and Eye Transformation Degree (“ETD”). The MTD and ETD are calculated by summing the differences between the landmarks outlining the mouth or eye/eyebrow at the time and the landmarks of the natural facial expression. Then, a lowpass filter is applied to filter out high-frequency noise. When an event happens, the MTD or ETD raises to a single peak or a primary peak with several secondary peaks. A peaking seeking algorithm is applied to find the peaks in the stream. Thresholds are set for peak height, peak prominence, and peak width to filter peaks that may be associated with noise. After finding peak positions, the first-order difference of the ETD and MTD are calculated. In the first-order difference sequence, the left nearest peak to the event is labeled as the beginning, and the right nearest valley to the event is labeled as the end. The frames associated with the event are placed sequentially on a timeline 525 as frames 530-1 through frames 530-n.

After the sequential placement of frames 530-1 through 530-n, the process 500 proceeds to block 540 where the frames are inputs into a Bidirectional Long Short-Term Memory (“BLSTM”) model for classification. Block 540 depicts a two-layer BLSTM model. However, any suitable number of layers may be used. The blocks 541-1 through 541-n depicted within the BLSTM model 540 are recurrently connected memory blocks. Each of the blocks 541 have feedback connections such that sequences of data can be processed as opposed to single images or data points. As depicted in block 540, blocks 541-1 through 541-n comprise bidirectional connections within each of the blocks 541 in each layer of block 540. Processing sequences of data allows for speech recognition, emoji recognition, real-time avatar facial expressions, or other suitable applications. The output from block 540 is a vector representation of the input frames.

In block 550, the vector representation is received by a fully connected layer comprising a SoftMax function. The SoftMax function transforms the vector representation into a probability distribution to predict a facial event. The output from block 550 is an encoding of a facial event class. The facial event classification may be a facial expression. In the example of silent speech recognition, the facial event classification may be the pronunciation of a specific word or phrase, such as “hello” or “how are you.” In the example of emoji recognition, the facial event classification may be an emoji indicating a smiling face, a frowning face, a crying face, or any other suitable emoji associated with a facial expression. In the example of real-time avatar facial expressions, the facial event classification may be a three-dimensional visualization of a facial expression.

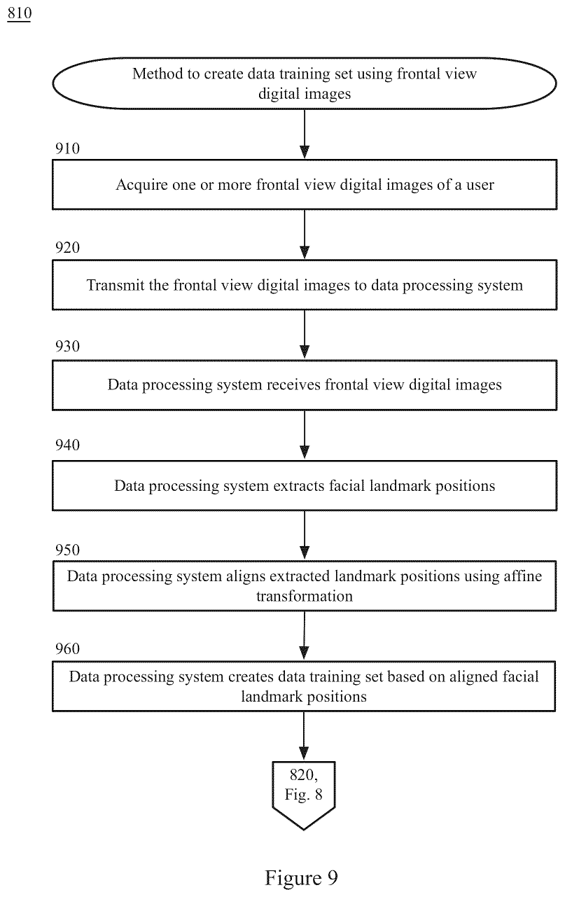

FIG. 6 is a diagram 600 depicting the correlation between frontal view camera images 610, landmark training data images 620, predicted facial expressions 630, and captured right and left facial contour images 640, 650, also referred to herein as respective rows 610-650, in accordance with certain examples. Row 610 illustrates frontal view camera images of a user. To construct a training data set or “ground truth,” frontal view camera images of a user are acquired, via an imaging capturing device, with the user making various different facial expressions as depicted in images 610-1 through 610-n. The method to create the training data set from the frontal view camera images is described herein in greater detail with reference to method 810 of FIG. 9. Row 620 illustrates a training data set in the form of facial landmarks. The landmark training data images depicted in images 620-1 through 620-n correlate with images 610-1 through 610-n. The landmark training data images 620 are the output of method 810 of FIG. 9.

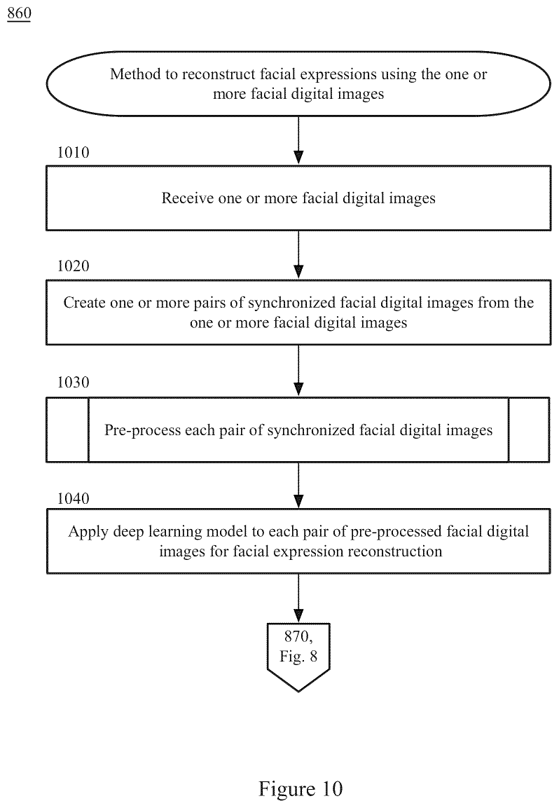

Row 640 depicts right facial contour images 640-1 through 640-n captured by a head-mounted, wearable device, such as headphone device 210 or earbud device 220 described herein with reference to FIG. 2. Row 650 depicts left facial contour images 650-1 through 650-n captured by a head-mounted, wearable device, such as headphone device 210 or earbud device 220 described herein with reference to FIG. 2. The right and left facial contour images 640, 650 are synchronized such that the images are representing the same facial expression. The synchronization of the images is described in greater detail herein with reference to block 1020 of FIG. 10. The synchronized images are used as inputs to the deep-learning model process 400, previously described herein with reference to FIG. 4.

The right facial contour images 640, the left facial contour images 650, and the landmark training data images 620 are used in the deep-learning model process 400 to construct the predicted facial expressions in row 630. The predicted facial expressions 630 are depicted as landmark images in images 630-1 through 630-n. The predicted facial expressions 630 are illustrated in FIG. 6 beneath the landmark training data images 620 to illustrate the accuracy of predicting facial expressions using right facial contour images 640 and left facial contour images 650 acquired from headphone device 210 or earbud device 220.

FIG. 7 is a diagram 700 depicting the correlation between frontal view camera images 610, training data with three-dimensional visualization 720, predicted facial expressions with three-dimensional visualization 730, also referred to herein as respective rows 720 and 730, and right and left facial contour images 640, 650, in accordance with certain examples. FIG. 7 is an alternate embodiment of FIG. 6, wherein training data images with three-dimensional visualization are depicted in row 720 and predicted facial expressions with three-dimensional visualization are depicted in row 730. The training data images 720-1 through 720-n are correlated with predicted facial expression images 730-1 through 730-n. The three-dimensional visualizations depicted in rows 720 and 730 are created using the facial landmarks described in rows 620 and 630 in reference to FIG. 6. The facial landmarks are input into a three-dimensional modeling application to create a three-dimensional visualization of the training data and the predicted facial expressions.

FIG. 6 and FIG. 7 present two-dimensional and three-dimensional correlations between training data and predicted facial expressions. Any suitable correlation can be made based on the type of camera used and the type of data collected. For example, correlations can be made based on imaging data such as thermal gradients or acoustic reflections.

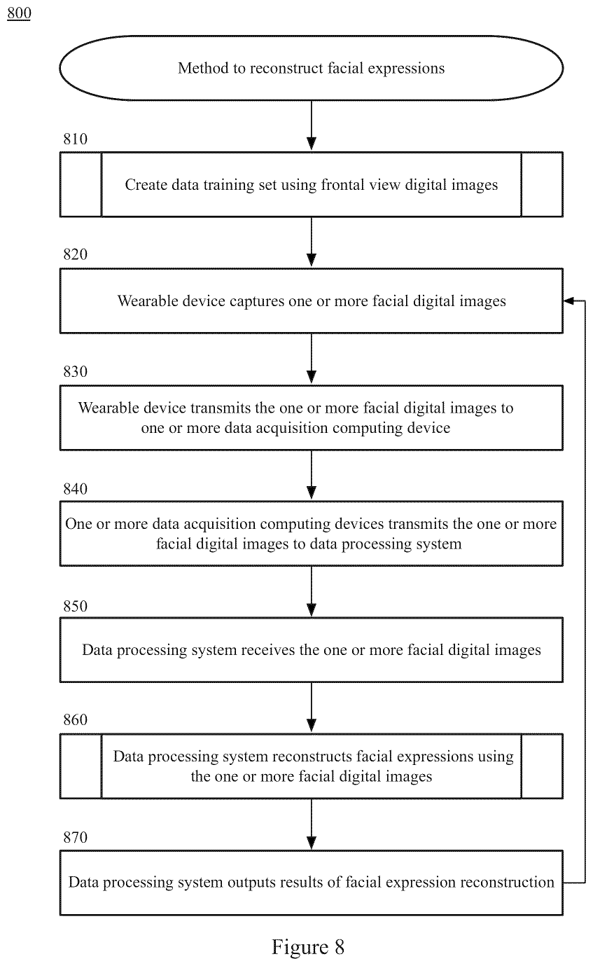

FIG. 8 is a block flow diagram depicting a method 800 to reconstruct facial expressions, in accordance with certain examples. In block 810, a data training set is created using frontal view digital images. Block 810 is described in greater detail in method 810 of FIG. 9.

FIG. 9 is a block flow diagram depicting a method 810 to create a data training set using frontal view digital images, in accordance with certain examples. In block 910, one or more frontal view digital image(s) of a user are acquired. The one or more frontal view digital image(s) depict the user making a variety of facial expressions. For example, the user may smile, frown, squint, close one or both eyes, make an angry facial expression, raise one or both eyebrows, or any other suitable expressions such that the one or more frontal view digital image(s) represent a wide range of potential facial expressions. Example frontal view digital images are depicted in row 610 of FIG. 6. The user may take the one or more frontal view digital image(s) of himself, another person may take the one or more frontal view digital image(s), or any other suitable method to acquire the one or more frontal view digital image(s) may be used. The one or more frontal view digital image(s) may be taken by any device or sensor capable of capturing a digital image including, but not limited to, depth cameras, red-green-blue (“RGB”) cameras, infrared (“IR”) sensors, thermal imaging sensors, charge-coupled devices (“CCDs”), complementary metal oxide semiconductor (“CMOS”) devices, active-pixel sensors, radar imaging sensors, fiber optics, and any other suitable image device technology.

In block 920, the frontal view digital images are transmitted to data processing system 130. The frontal view digital images may be transmitted to the data processing system 130 by a user's computing device, such as user computer device 150, or any other suitable device to transmit data.

In block 930, the data processing system 130 receives the frontal view digital images.

In block 940, the data processing system 130 extracts facial landmark positions. To extract the facial landmark positions, the data processing system 130 uses a computer vision library as a ground truth acquisition method. In an example, the computer vision library is a Dlib library. The computer vision library is used to extract key feature points or landmarks from the frontal view digital images. The computer vision library may extract 42, 68, or any suitable number of key feature points.

In block 950, the data processing system 130 aligns the extracted landmark positions using an affine transformation. Aligning the extracted landmark positions accounts for variations in a user's head position in the frontal view digital images. When a user acquires the frontal view digital images as described in block 910, the same facial expressions may vary if the user slightly changes his face orientation. To align the extracted landmark positions, a set of landmarks are selected whose relative positions change very little when making facial expressions. For example, the selected landmarks may be one or more of a right canthus, left canthus, or apex of the nose. The selected landmarks are used to calculate an affine matrix for each frontal view digital image. The landmark positions are aligned to the same range to reduce the influence of head position change when the frontal view digital images are acquired.

In block 960, the data processing system 130 creates the data training set based on the aligned facial landmark positions. In an example, after the extracted landmark positions are aligned, the data processing system 130 selects the most informative feature points from the extracted landmark positions. In an example, the Dlib library may extract 68 facial landmarks from each of the frontal view digital images. When making facial expressions, changes mainly occur in the areas around the mouth, eyes, and eyebrows. The less informative features points may be removed, leaving a smaller set of facial landmarks, such as 42 facial landmarks. Any suitable number of facial landmarks may be used. The data training set is the set of the most informative landmark positions for each facial expression from each of the frontal view digital images. Example data training set images are depicted in row 620 of FIG. 6. In an alternate example, the facial expression reconstruction is further modeled to create a three-dimensional visualization of the training data images as depicted in row 720 of FIG. 7. In an example, the data processing system saves the data training set in the data storage unit 133. In some embodiments, the system may extract information of at least 10, at least 20, at least 30, at least 40, at least 50, at least 60, at least 70, at least 80, at least 90, or at least 100 parameters or features from one or more image(s) captured by one or more imaging sensor(s) for a facial expression, wherein the parameters or features comprise facial landmark positions, shape parameters (for example, blendshape parameters), orientations (for example, head orientations), or any combination thereof.

FIG. 6 depicts frontal view digital images of a user at row 610, which are used to create the corresponding data training set depicted in row 620. In an alternate example, training data with three-dimensional visualization, as depicted in row 720 of FIG. 7, may be utilized. Any suitable method or visualization may be used to create the data training set.

From block 960, the method 810 returns to block 820 of FIG. 8.

Referring back to FIG. 8, in block 820, a wearable device captures one or more facial digital image(s). In an example, the wearable device may be a head-mounted device, such as headphone device 210 or earbud device 220, previously described herein with reference to FIG. 2. The head-mounted device is configured to capture right facial contour images and left facial contour images of a user's face directed towards the right and left cheekbones using two or more cameras 110. In the current example, the right and left facial contour images are two-dimensional images of the contour of a user's face. Example right and left facial contour images are depicted in rows 640 and 650, respectively, of FIGS. 6 and 7.

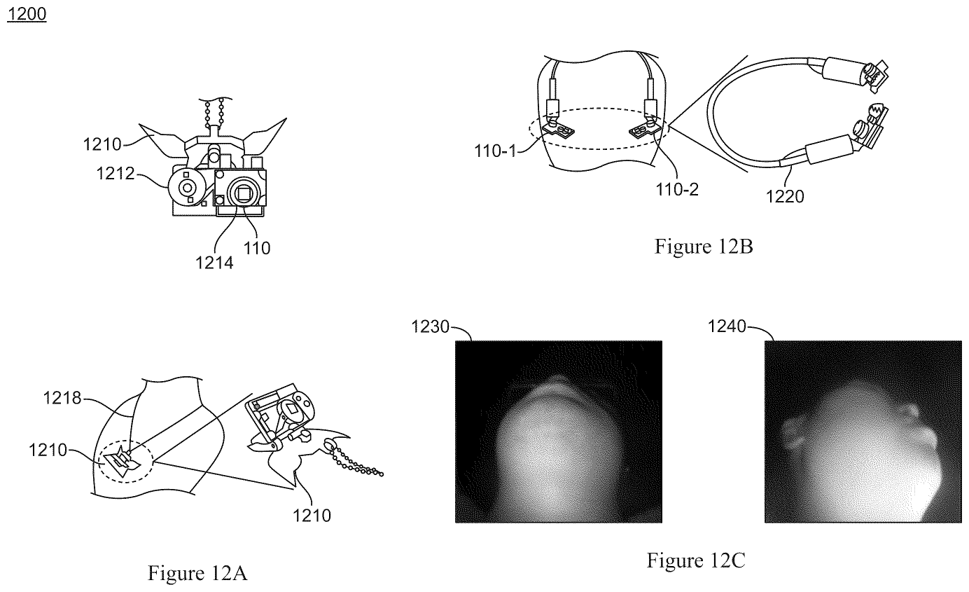

In an alternate example, the wearable device may be a neck-mounted device such as necklace device 1210 or neckband device 1220, described hereinafter with reference to FIG. 12. The neck-mounted device is configured to take digital images of the contour of a user's face directed towards the user's chin using one or more camera(s) 110.

In block 830, the wearable device transmits the one or more facial digital image(s) to one or more data acquisition computing device(s) 120. As depicted and described in reference to FIG. 1, each camera 110 is in communication with a data acquisition computing device 120.

In block 840, the one or more data acquisition computing device(s) 120 transmit the one or more facial digital image(s) to the data processing system 130.

In block 850, the data processing system 130 receives the one or more facial digital image(s).

In block 860, the data processing system 130 reconstructs facial expressions using the one or more facial digital image(s). Block 860 is described in greater detail herein with reference to method 860 of FIG. 10.

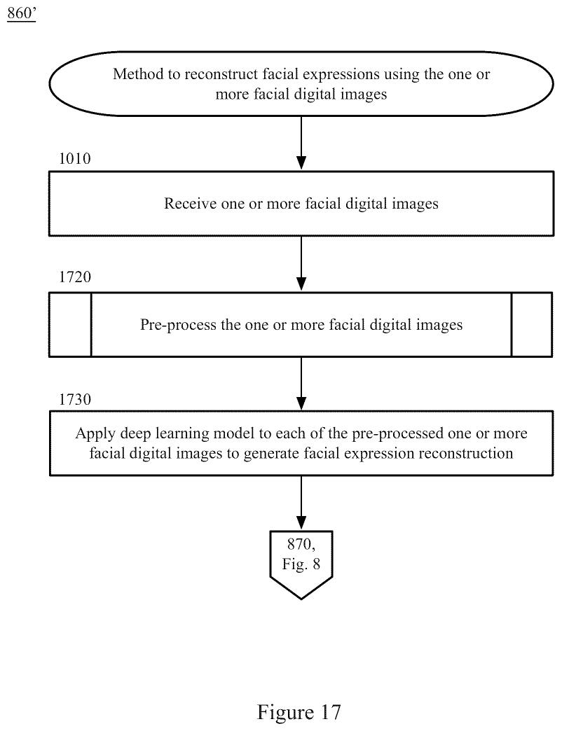

FIG. 10 is a block flow diagram depicting a method 860 to reconstruct facial expressions using one or more facial digital image(s), in accordance with certain examples. The examples of FIG. 10 are directed to the method to reconstruct facial expressions from one or more facial digital image(s) received from a head-mounted wearable device. An alternate method to reconstruct facial expressions from one or more facial digital image(s) received from a neck-mounted wearable device is described herein with reference to method 860′ of FIG. 17.

In block 1010, the data processing system 130 receives the one or more facial digital image(s).

In block 1020, the data processing system 130 creates one or more pair(s) of synchronized facial digital images from the one or more facial digital image(s). In the example where the one or more facial digital image(s) are acquired from a head-mounted wearable device, the wearable device captures right facial contour images and left facial contour images. To accurately reconstruct a facial expression of a user, the data processing system 130 synchronizes the images from the left camera 110-1 and the right camera 110-2 such that each pair of right and left facial contour images represents a particular facial expression.

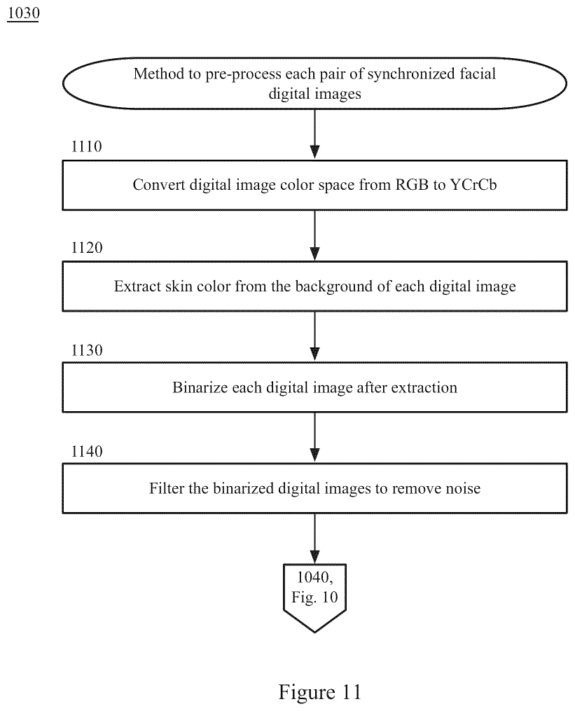

In block 1030, the data processing system 130 pre-processes each pair of synchronized facial digital images. Block 1030 is described in greater detail herein with reference to method 1030 of FIG. 11.

FIG. 11 is a block flow diagram depicting a method 1030 to pre-process each pair of synchronized facial digital images, in accordance with certain examples. In block 1110, the data processing system 130 converts a digital image color space of each pair of synchronized facial digital images from a red-green-blue (“RGB”) color space to a luminance, chrominance (red-yellow), chrominance (blue-yellow) (“YCrCb”) color space. The YCrCb color space is used to take advantage of a lower resolution with respect to luminosity amount of data stored with respect to each pair of synchronized facial digital images. The conversion from the RGB color space to the YCrCb color space is accomplished using a standard process.

In block 1120, the data processing system 130 extracts skin color from the background of each converted pair of facial digital images. In an example, the skin color is extracted using Otsu's thresholding method. Otsu's thresholding method determines whether pixels in an image fall into a foreground or a background. In the current example, the foreground represents a facial contour of each facial digital image, and the background represents an area of the image outside of the facial contour.

In block 1130, the data processing system 130 binarizes each facial digital image after the extraction of the skin color from the background. Image binarization is the process of taking the image in YCrCb color space and converting it to a black and white image. The binarization of the image allows for an object to be extracted from an image, which in this example is a facial contour.

In block 1140, the data processing system 130 filters the binarized digital images to remove noise from the images. Filtering the binarized digital images produces a smoother image to assist in more accurate facial expression reconstructions.

From block 1140, the method 1030 returns to block 1040 of FIG. 10. Referring back to FIG. 10, in block 1040, the data processing system 130 applies a deep-learning model to each pair of pre-processed facial digital images for facial expression reconstruction. The deep-learning model for facial expression reconstruction was described in detail herein in the deep-learning model process 400 with reference to FIG. 4 and in the classifier process 500 with reference to FIG. 5. The results of the facial expression reconstruction from block 1040 may include the reconstruction output from block 456 of FIG. 4 and/or the encoding of a facial event class from block 550 of FIG. 5. For example, the data processing system 130 may output from block 1040 the landmark images from the deep-learning model process 400 of FIG. 4. The data processing system 130 also, or alternatively, may further process the facial expression reconstruction such that the output from block 1040 comprises a three-dimensional visualization of the facial expression, silent speech recognition, an emoji associated with the facial expression reconstruction, and/or real-time avatar facial expressions associated with the facial expression reconstruction, such as described by the classifier process 500 of FIG. 5.

From block 1040, the method 860 returns to block 870 of FIG. 8. Referring back to FIG. 8, in block 870, the data processing system 130 outputs the results of the facial expression reconstruction. In an example, the results may be sent to user computing device 150 to be displayed visually or audibly to a user. In an example, the results of the facial expression reconstruction may be displayed as a graphical representation of a facial expression, such as row 630 of FIG. 6; a predicted facial expression with three-dimensional visualization, such as row 730 of FIG. 7; a three-dimensional facial expression, such as row 1530A of FIG. 15A; an emoji; text representing silent speech recognition; or any other suitable display of facial expression reconstruction results. User computing device 150 may comprise a speaker to audibly communicate the facial expression reconstruction results directed to silent speech recognition.

From block 870 of FIG. 8, the method 800 returns to 820 where the method 800 repeats the process of reconstructing facial expressions by capturing additional facial digital images.

### Other Example Architectures

FIGS. 12A, 12B, and 12C are perspective views 1200 of neck-mounted wearable devices 1210, 1220 for facial expression reconstruction with example IR images 1230 and 1240, in accordance with certain examples.

FIG. 12A depicts a necklace style neck-mounted wearable device 1210 (herein referred to as necklace device 1210) as a form factor to acquire images or data for use in facial expression reconstruction. Necklace device 1210 comprises a camera 110, previously described herein in reference to FIG. 1. In the current example, camera 110 is an infrared (“IR”) camera. Necklace device 1210 also comprises an IR LED 1212 and an IR bandpass filter 1214. Necklace device 1210 is configured to acquire images of a user's chin profile by directing the camera 110 at the profile of a user's chin. The IR LED 1212 projects IR light onto a user's chin to enhance the quality of the image captured by camera 110. The IR bandpass filter 1214 filters visible light such that camera 110 captures infrared light reflected by the skin of a user.

Necklace device 1210 comprises a chain 1218 or other suitable device for securing the necklace device 1210 about the neck of a user. In an alternate example, necklace device 1210 may attach to a user's clothing instead of being secured about the neck of a user. In the current example, necklace device 1210 may be attached to a user's clothing underneath the user's chin. In an alternate example, multiple necklace devices 1210 may be attached to a user's clothing to capture camera 110 images from multiple viewpoints. In the current example, a necklace device 1210 may be attached on a user's clothing close to each shoulder of the user. The necklace device 1210 may comprise a clip, a pin, a clasp, or any other suitable device to attach necklace device 1210 to a user's clothing.

The camera 110 is in communication with a computing device 120, as previously described with respect to FIG. 1. In an example, a computing device 120 may be connected to the camera 110 and be embedded within the necklace device 1210. In an alternate example, the camera 110 may communicate with a computing device 120 via a wireless technology, such as Bluetooth or Wi-Fi.

FIG. 12B depicts a neckband style neck-mounted wearable device 1220 (herein referred to as neckband device 1220) as a form factor to acquire images or data for use in facial expression reconstruction. Neckband device 1220 comprises two cameras 110-1 and 110-2 fashioned to be positioned on the left and right sides of a user's neck. Neckband device 1220 also comprises IR LEDs and IR bandpass filters configured in proximity to each camera 110-1 and 110-2 (not depicted in FIG. 12). In an example, neckband device 1220 may include functionality with Bluetooth or Wi-Fi connectivity and speakers embedded within the neckband device 1220. Each camera 110 is in communication with a computing device 120, as previously described with respect to FIG. 1. In an example, a computing device 120 may be connected to each camera 110 and be embedded within the neckband device 1220. In an alternate example, each camera 110 may communicate with a computing device 120 via a wireless technology, such as Bluetooth or Wi-Fi.

FIG. 12C depicts two example IR images 1230 and 1240. Example 1230 is an IR image acquired from necklace device 1210. Example 1240 is a right camera 110 IR image acquired from neckband device 1220. Additional examples of IR images acquired by either necklace device 1210 or neckband device 1220 are depicted in row 1540A of FIG. 15A and row 1540B of FIG. 15B.

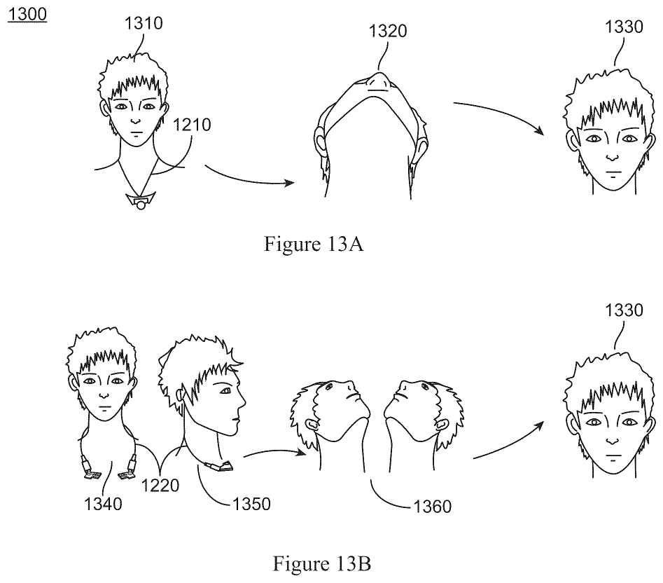

FIGS. 13A and 13B are illustrations 1300 depicting examples 1310-1360 of neck-mounted wearable devices 1210, 1220 on a user, camera views 1320 and 1360, and corresponding facial expressions 1330, in accordance with certain examples. In FIG. 13A, example 1310 illustrates a necklace device 1210 as being worn by a user in a front view of the user. Example 1320 illustrates a view of the user as captured by camera 110 of the necklace device 1210. The corresponding example 1330 illustrates a reconstructed facial expression based on IR images captured by the necklace device 1210.

In FIG. 13B, example 1340 illustrates a neckband device 1220 as being worn by a user in a front view of the user. Example 1350 illustrates a neckband device 1220 as being worn by a user in a right-side view of the user. Example 1360 illustrates two views of the user as captured by cameras 110-1 and 110-2 of the neckband device 1220. The corresponding example 1330 illustrates a reconstructed facial expression based on IR images captured by the necklace device 1220.

### Other Example Processes

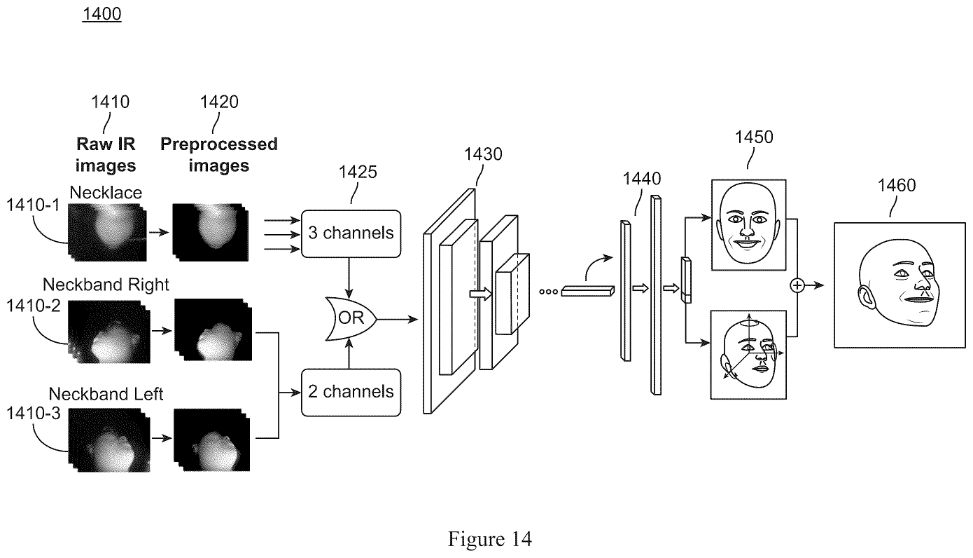

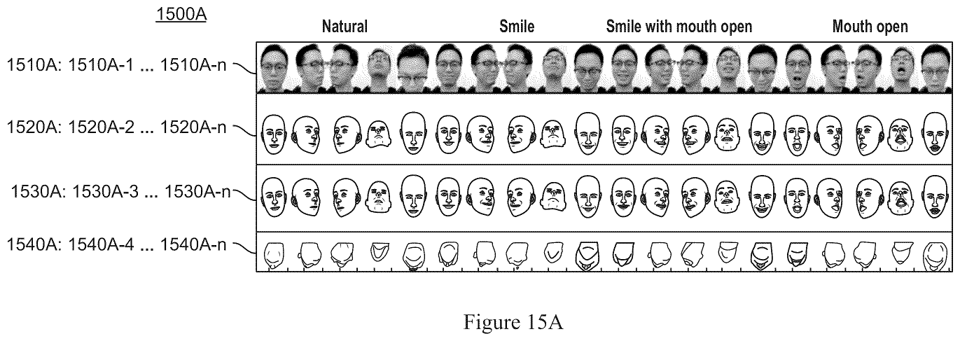

The methods illustrated in FIGS. 14 through 18 are described hereinafter with respect to the components of facial expression reconstruction system 100, necklace device 1210 of FIG. 12A, and neckband device 1220 of FIG. 12B. The methods of FIGS. 14 through 18 may also be performed with other systems and in other environments. The operations described with respect to FIGS. 14 through 18 can be implemented as executable code stored on a computer- or machine-readable, non-transitory, tangible storage medium (for example, floppy disk, hard disk, ROM, EEPROM, nonvolatile RAM, CD-ROM, etc.) that are completed based on execution of the code by a processor circuit implemented using one or more integrated circuit(s); the operations described herein also can be implemented as executable logic that is encoded in one or more non-transitory, tangible media for execution (for example, programmable logic arrays or devices, field programmable gate arrays, programmable array logic, application specific integrated circuits, etc.).

FIG. 14 is a block diagram depicting an alternate embodiment of a deep-learning model process 1400, in accordance with certain examples. The deep-learning model process 1400 may be performed by the modeling application 132 of the data processing system 130, previously described herein with reference to FIG. 1. In an example where the machine learning algorithm is a convolution neural network (“CNN”), the deep-learning model process 1400 receives images as an input and assigns importance (learnable weights and biases) to various aspects/objects in the images. The CNN reduces the images into a form that is easier to process without losing the features of the images that are critical for getting a good prediction. In the current example, the prediction is a reconstructed facial expression based on received IR images of a user's chin profile.

In block 1410, the data processing system 130 receives IR images from either the necklace device 1210 or the neckband device 1220. Example necklace device 1210 IR images are depicted at 1410-1. Example neckband device 1220 IR images are depicted at 1410-2 and 1410-3 as the neckband acquires both a right and left side IR image of a user's chin profile. Other example IR images are depicted in row 1540A of FIG. 15A and row 1540B of FIG. 15B.

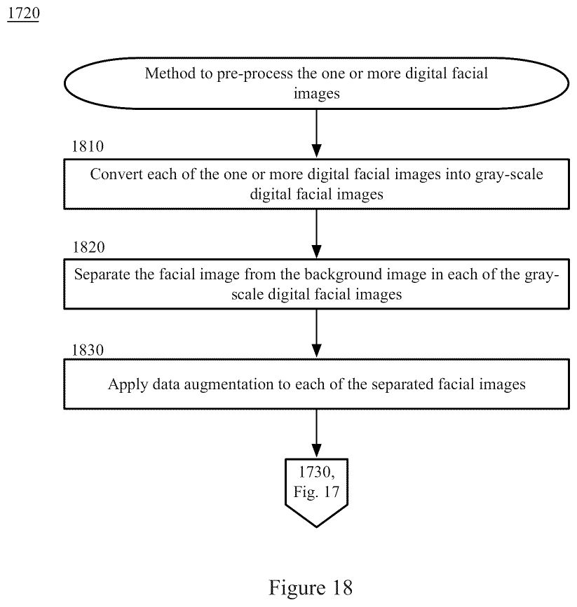

In block 1420, the data processing system 130 pre-processes the IR images. Pre-processing the IR images is described in greater detail in reference to method 1720 of FIG. 18.

In block 1425, the data processing system 130 duplicates the pre-processed IR images of the necklace device 1210 into three channels to improve the expressiveness and the ability to extract features of the model. As the neckband device 1220 already comprises two pre-processed images, the images are not duplicated into additional channels.

The pre-processed IR images are input into an image processing phase of the deep-learning model process 1400 depicted at block 1430. Block 1430 comprises convolution layers, normalization layers, and an averaging pooling layer. The processing of block 1430 is described in greater detail herein with reference to blocks 414 and 416 of FIG. 4. The output from block 1430 is a vector representation of each of the pre-processed IR images.

The vector representations of each of the pre-processed IR images are input into a regression phase 1440 of the deep-learning model process 1400. The architecture of the regression phase 1440 is similar to the architecture of regression phase 450, previously described herein with reference to FIG. 4. Within the regression phase 1440, the data processing system 130 extracts details from the vector representations of the pre-processed IR images regarding facial components including the cheek, mouth, eyes, eyebrows, chin, and nose and three-dimensional head rotation angles. The data processing system 130 represents each facial expression with blend shapes that are a three-dimensional representation of the vector representations. The parameters of the blend shapes and the three-dimensional head rotation angles, or Euler angles, are obtained by learning from the IR images captured from the neck. The data processing system 130 compares the blend shapes and Euler angles from the vector representations to the blend shapes and Euler angles of the data training set to match the blend shapes/Euler angles to a facial expression from the data training set.

In block 1450, the data processing system 130 combines the blend shapes with three-dimensional angles of rotation of the user's head. In an example, the three-dimensional angles of rotation are represented by Euler's angles of roll, yaw, and pitch. In block 1460, the final facial expression reconstruction is output as a three-dimensional image. Example three-dimensional facial expression reconstructions are depicted in row 1530A of FIG. 15A and row 1530B of FIG. 15B. In an example, the three-dimensional facial expression reconstructions may be further processed by a classifier process, such as classifier process 500 for applications such as silent speech recognition, emoji input, real-time avatar facial expressions, or any other suitable applications.

FIG. 15A is a diagram 1500A depicting the correlation between frontal view camera images 1510A, three-dimensional training data 1520A, predicted three-dimensional face expressions 1530A, and infrared facial images 1540A, also referred to herein as respective rows 1510A, 1520A, 1530A and 1540A, in accordance with certain examples.

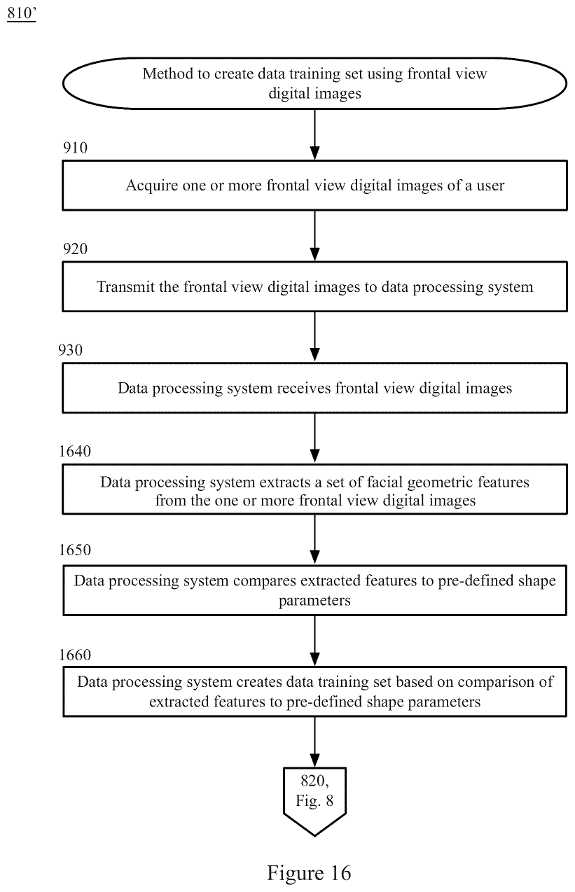

Row 1510A illustrates frontal view camera images of a user. To construct a training data set or ground truth, frontal camera images of a user are acquired with the user making various different facial expressions, as depicted in images 1510A-1 through 1510-n. The method to create the training data set from the frontal view camera images is described herein in greater detail with reference to method 810′ of FIG. 16. Row 1520A illustrates three-dimensional training data in three-dimensional blend shapes and head rotation angles. The three-dimensional training data images depicted in images 1520A-1 through 1520A-n correlate with images 1510A-1 through 1510-n. The three-dimensional training data images 1520A are the output of method 810′ of FIG. 16.

Row 1540A depicts IR images 1540A-1 through 1540A-n captured by a neck-mounted wearable device, such as necklace device 1210 or neckband device 1220 described herein in greater detail in reference to FIG. 12. The IR images 1540A, and the three-dimensional training data images 1520A are used in the deep-learning model process 1400 to construct the predicted facial expressions 1530A illustrated in row 1530A of FIG. 15A. The predicted facial expressions 1530A are depicted as three-dimensional images in images 1530A-1 through 1530A-n. The predicted facial expressions 1530A are illustrated in FIG. 15A beneath the three-dimensional training data images 1520A to illustrate the accuracy of predicting facial expressions using IR images 1540A acquired from necklace device 1210 or neckband device 1220.

FIG. 15B is a diagram 1500B depicting the correlation between additional frontal view camera images 1510B, three-dimensional training data 1520B, predicted three-dimensional face expressions 1530B, and infrared facial images 1540B, in accordance with certain examples. Each of the frontal view camera images 1510B, three-dimensional training data 1520B, predicted three-dimensional face expressions 1530B, and infrared facial images 1540B correspond to the frontal view camera images 1510A, three-dimensional training data 1520A, predicted three-dimensional face expressions 1530A, and infrared facial images 1540A described herein with reference to FIG. 15A, except these items correlate to different facial expressions.

In this example, the images captured by the cameras of the neck-mounted devices can be processed for facial reconstruction similarly to the methods discussed previously with reference to FIGS. 8-11. Various alternatives to the methods of FIGS. 8-11 will be discussed.

FIG. 16 is a block flow diagram depicting an alternative method 810′ to create a data training set using frontal view images, in accordance with certain examples.

Blocks 910, 920, and 930 of FIG. 16 were previously described herein with reference to FIG. 9.

In block 1640, the data processing system 130 extracts a set of facial geometric features from the one or more frontal view digital image(s). In an example, the one or more frontal view digital image(s) are three-dimensional digital images captured from a camera that provides depth data in real time along with visual information. Example frontal view digital images are depicted in rows 1510A and 1510B, respectively, of FIGS. 15A and 15B. In an example, the data processing system 130 extracts full facial expressions using an augmented reality (“AR”) application. The AR application extracts high-quality and fine-grained details of facial expressions/movements of the eyes, eyebrows, cheeks, mouth, nose, and chin. The AR application can extract facial features such as facial geometry and rotation from a depth map associated with the three-dimensional digital images. In an example, the rotation is represented by Euler's angles of roll, yaw, and pitch.

In block 1650, the data processing system 130 compares the extracted features to pre-defined shape parameters. In an example, the AR application comprises pre-defined blend shapes as templates for complex facial animations. In the example, the AR application comprises blend shapes with features for left and right eyes, mouth and jaw movement, eyebrows, cheeks, nose, tongue, and any other suitable facial features.

In block 1660, the data processing system 130 creates a data training set based on the comparison of the extracted features to the pre-defined shape parameters. The data training set comprises a blend shape with a Euler angle of head rotation as depicted in block 1520A of FIG. 15A and block 1520B of FIG. 15B. In an example, the data processing system 130 stores the data training set in the data storage unit 133.

From block 1660, the method 810′ returns to block 820 of FIG. 8.

FIG. 17 is a block flow diagram depicting an alternative method 860′ to reconstruct facial expressions using one or more facial digital image(s), in accordance with certain examples.

Block 1010 of FIG. 17 was previously described herein with reference to FIG. 10.

In block 1720, the data processing system 130 pre-processes the one or more facial digital image(s). Example facial digital images are depicted in rows 1540A and 1540B of FIGS. 15A and 15B, respectively. Block 1720 is described in greater detail herein with reference to method 1720 of FIG. 18.

FIG. 18 is a block flow diagram depicting an alternative method 1720 to pre-process the one or more digital facial image(s), in accordance with certain examples.

In block 1810, the data processing system 130 converts each of the one or more digital facial image(s) into gray-scale digital facial images. The one or more digital facial image(s) are converted to gray-scale to remove any potential color variance. As the IR bandpass filter 1214 only allows monochrome light into the camera 110, any color present in the one or more digital facial image(s) does not represent details related to the facial expression of the user.

In block 1820, the data processing system 130 separates the facial image from the background image in each of the gray-scale digital facial images. Using the IR technology previously discussed in reference to FIG. 12, the user's skin in the images appears brighter than the surrounding background. However, some light sources in the background may contain IR light that would introduce noise in the background. To remove the noise, the gray-scale digital facial images are binarized based on a set brightness threshold. The data processing system 130 separates the facial image as the brighter component of the gray-scale digital facial image.

In block 1830, the data processing system 130 applies data augmentation to each of the separated facial images. As a user wears a necklace device 1210 or a neckband device 1220 and performs activities, the position and angles of the cameras 110 of the necklace device 1210 and neckband device 1220 may not be constant. To mitigate the issue, a probability of 60% to conduct three types of image transformations is set, which can be caused by camera shifting causing translation, rotation, and scaling on the images. In an alternate example, any suitable probability may be used. Three Gaussian Models are deployed to generate the parameters for the translation (μ=0, σ²=30), rotation (μ=0, σ²=10), scaling (μ=1, σ²=0.2) on the synthesized training data. The data augmentation is performed on all the images in the training dataset during each training epoch before feeding the images into deep-learning model process 1400. Data augmentation improves the deep-learning model's ability to confront camera shifting and avoid over-fitting during model training.

From block 1830, the method 1720 returns to block 1730 of FIG. 17.

In block 1730, the data processing system 130 applies the deep-learning model to each of the pre-processed one or more facial digital image(s) to generate facial expression reconstruction. The deep-learning model for facial expression reconstruction was described in the deep-learning model process 1400 herein with reference to FIG. 14 and in the classifier process 500 with reference to FIG. 5. The results of the facial expression reconstruction from block 1730 may include the reconstruction output from block 1460 of FIG. 14 and/or the encoding of a facial event class from block 550 of FIG. 5. For example, the data processing system 130 may output from block 1730 the images from the process 1400 of FIG. 14. The data processing system 130 also, or alternatively, may further process the facial expression reconstruction such that the output from block 1730 comprises a three-dimensional visualization of the facial expression, silent speech recognition, an emoji associated with the facial expression reconstruction, and/or real-time avatar facial expressions associated with the facial expression reconstruction, such as described by the classifier process 500 of FIG. 5.

From block 1730, the method 860′ returns to block 870 of FIG. 8 to output results of the facial reconstruction.

Cameras 110 were described herein with reference to FIG. 1 as any suitable sensors for capturing images. For example, cameras 110 may include depth cameras, red-green-blue (“RGB”) cameras, infrared (“IR”) sensors, acoustic cameras or sensors, microphones and speakers, thermal imaging sensors, charge-coupled devices (“CCDs”), complementary metal oxide semiconductor (“CMOS”) devices, active-pixel sensors, radar imaging sensors, fiber optics, and any other suitable image device technology. While the examples herein described specific cameras for the headphone device 210, earbud devices 220, necklace device 1210, and neckband device 1220, it should be appreciated that any type of camera can be used with any of the wearable devices. The methods to process the images and recreate the facial expressions are adjusted based on camera/image type and are not dependent on the type of device used to acquire the images.

The embodiments herein describe wearable devices in the form of head-mounted devices including headphone device 210 and earbud devices 220, and neck-mounted devices including necklace device 1210 and neckband device 1220. Any suitable wearable device may be used such that the one or more camera(s) may be directed towards a user's face including, but not limited to, glasses, smart glasses, a visor, a hat, a helmet, headgear, a virtual reality (“VR”) headset.

The embodiments herein describe head-mounted and neck-mounted wearable devices comprises cameras 110 with adjustable positions and angles. Each camera 110 may be positioned such that at least one of a buccal region, a zygomatic region, and/or a temporal region of a user's face are included in the field of view of the camera 110.

In an alternate embodiment, the wearable devices previously described herein may be configured for use in a hand-face touching detection system to recognize and predict a time and position that a user's hand touches the user's face. An important step in reducing the risk of infection is avoiding touching the face because a virus, such as COVID-19, may enter the mucous membranes of the eyes, nose, and/or mouth. Touching different areas of the face carries different health related risks. For example, contacting a mucous membrane may introduce a higher risk of transmitting a virus than touching non-mucous areas such as the chin and check. In addition, the frequency of touching the face may be an indicator regarding the stress level of a person. Understanding how people touch their face may alleviate multiple health challenges. Accurately recognizing where the hand touches the face is an important step towards alleviating health risks introduced by hand-face touching behaviors. In order to implement behavior intervention technologies, the hand-face touching detection system predicts the behavior in advance rather than simply detecting the touching behavior.

A data training set is created similar to the data training sets described herein with reference to FIGS. 9 and 16. The difference is that instead of frontal view images of a user capturing just the user's face, the data training set uses frontal view images of a user with different hand-face touching positions. For example, frontal view images of the user may be acquired with the user touching his eye, nose, mouth, check, or any other suitable facial feature. In addition to touching faces directly, people move their hands closer to their faces when performing daily activities such as eating and drinking. The daily activities are classified as separate behaviors to avoid false-positive errors of a person touching their face. Additional frontal view images are acquired for the data training set depicting example daily activities. For example, the frontal view images may comprise a user eating with his hand, a fork, a spoon, or chopsticks. The user may be drinking with a straw, a bottle, or a cup. The user may be placing an earbud in or out, putting on or taking off eyeglasses, adjusting eyeglasses, applying lip balm, or adjusting his hair. Any suitable daily activities may be used in the frontal view images to create the data training set.

The frontal view images of the user are sent to a server, such as data processing system 130, to create the data training set, as previously described herein with reference to FIGS. 9 and 16. However, instead of extracting facial landmark positions as described in block 940 of FIG. 9 or facial geometric features as described in block 1640 of FIG. 16, the data processing system extracts hand/facial landmark positions or hand/geometric features to create the data training set.

In an example, necklace device 1210 may be positioned on a user to acquire images of the user's facial area, as previously described herein, to also include a user's hand if positioned or in motion near the user's face. Any suitable wearable device may be used to acquire the images of the user's face. To predict the time and location of a hand-face touch, camera images are monitored over a period of time. Camera images are sent to a server, such as data processing system 130, for processing. The data processing system receives the hand/facial images and reconstructs the position of the user's hand relative to the user's face using the data training set and a deep-learning model, such as the models previously described herein with reference to FIGS. 4 and 14. The data processing system monitors the hand-face position over time to predict where and when a user may touch his face. Alternatively, the data processing system may determine that the user is participating in a daily activity and that the user is not in the process of a hand-face touch. In each case, the system outputs a reconstructed image (or other similar information as described herein) depicting the user's facial expression and a representation of the hand-touch activity. The system also can log each hand-touch to the facial area and output notifications of the activity.

In an alternate embodiment, acoustic sensing technology can be used to reconstruct facial expressions using an array of microphones and speakers and deep-learning models. The acoustic technology comprises a wearable device such as headphones, earbuds, necklaces, neckbands, and any other suitable form factors such that the microphones and speakers can be mounted or attached to the wearable device. In an example, the microphones are Micro-Electro-Mechanical System (“MEMS”) microphones that are placed on a printed circuit board (“PCB”). In an example, each microphone/speaker assembly may comprise four microphones and one speaker. Any suitable number of microphones and speakers may be included. The positions of the microphones and speakers may be adjustable to optimize the recording of reflected signals.

The acoustic wearable device actively sends signals from the speakers towards a user's face. In an example, the speakers transmit inaudible acoustic signals within a frequency range of 16 kHz to 24 kHz towards the user's face. Any suitable frequency range may be used. The signals are reflected by the user's face and captured by the microphones on the acoustic wearable device. The signals are reflected differently back towards the microphones based on different facial expressions or movements. A Channel Impulse Response (“CIR”) is calculated based on the acoustic signals received at each microphone.

Each microphone is in communication with a computing device, such as computing device 120, such that the CIR images/data can be transmitted for processing to a server, such as data processing system 130.

The data processing system creates a data training set using frontal view images of a user in a machine learning algorithm, previously described herein with reference to FIGS. 9 and 16. The data processing system receives the CIR images/data and reconstructs the user's facial expression using the data training set and a deep-learning model, such as the models previously described herein with reference to FIGS. 4 and 14. The data processing system outputs the resultant facial expression reconstruction, such as previously described herein with reference to block 870 of FIG. 8.

The wearable devices and systems described herein may be used in applications such as silent speech recognition, emoji input, and real-time avatar facial expressions. Silent speech recognition is a method to recognize speech when vocalization is inappropriate, background noise is excessive, or vocalizing speech is challenging due to a disability. The data training set for silent speech recognition comprises a set of frontal view facial images directed to the utterance of a word or phrase. To recognize silent speech, the wearable device, such as necklace device 1210 or neckband device 1220, captures a series of facial movements from underneath the chin of a user while the user silently utters words or commands and transfers the series of digital facial images to the data processing system 130 for facial expression reconstruction. The results of the facial expression reconstruction, previously described herein with reference to block 456 or block 1460, are used as inputs to the classifier process 500, previously described herein with reference to FIG. 5. Using the series of facial expression reconstruction images, the classifier process 500 detects the start time and end time of an utterance and selects the frames from the series of facial expression reconstruction images associated with the utterance. A vector representation of the utterance is created and input into a probability distribution to predict a word or phrase. In some embodiments for applications, such as in a testing process after the training, or using a trained system, a front view of a user is not needed. In some embodiments for speech recognition, one or more imaging sensor(s), such as camera(s) in a necklace and/or a wearable device worn in or on car(s) of a user, capture a series of images for speaking a syllable, word, or phrase with or without audio (for example, at least two images of a syllable, a word, or a phrase), wherein each image comprises only a portion of a full face. In some embodiments, one image used in the application only captures less than 50%, less than 40%, less than 30%, less than 25%, less than 20%, or less than 15% of a full face. In some embodiments, the one or more imaging sensor(s) used in the application do not capture direct visual information for eyes, nose, and/or mouth. In some embodiments, the one or more image(s) and the combination thereof used in the application capture incomplete visual information for eyes, nose, and/or mouth. In some embodiments, the system and method are configured to recognize or predict speech, and/or other facial expression(s) at a high accuracy, wherein the accuracy is at least 75%, at least 80%, at least 85%, at least 90%, at least 95%, or at least 98% for one or multiple words, phrases, or facial expressions on average. In some embodiments, the application is a speech recognition based on images/videos captured by the system. In other embodiments, the image-based or video-based speech recognition may be combined with an audio-based speech recognition to improve the accuracy of speech recognition. In some embodiments, the image-based or video-based speech recognition may be used to validate a result of an audio-based speech recognition.

### Alternate Embodiment

### Alternate Embodiment Example System Architecture

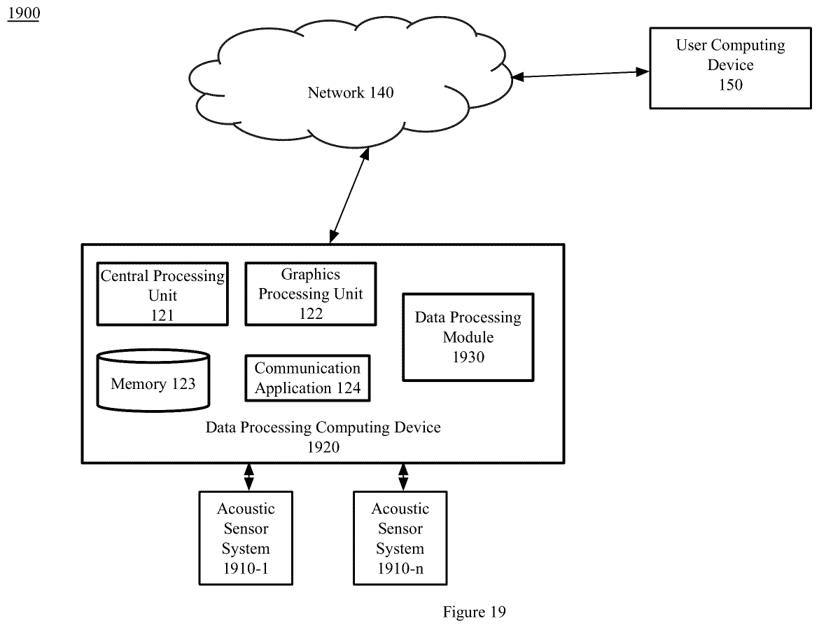

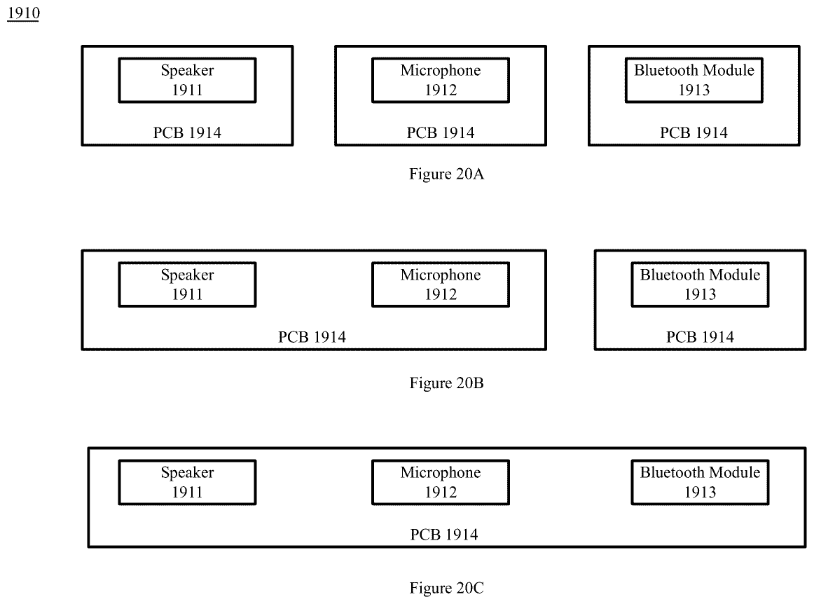

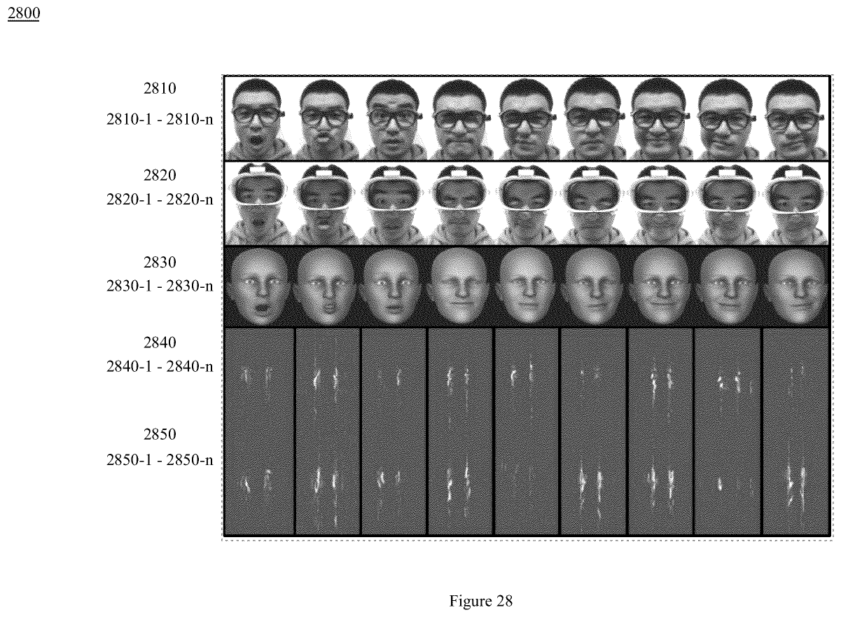

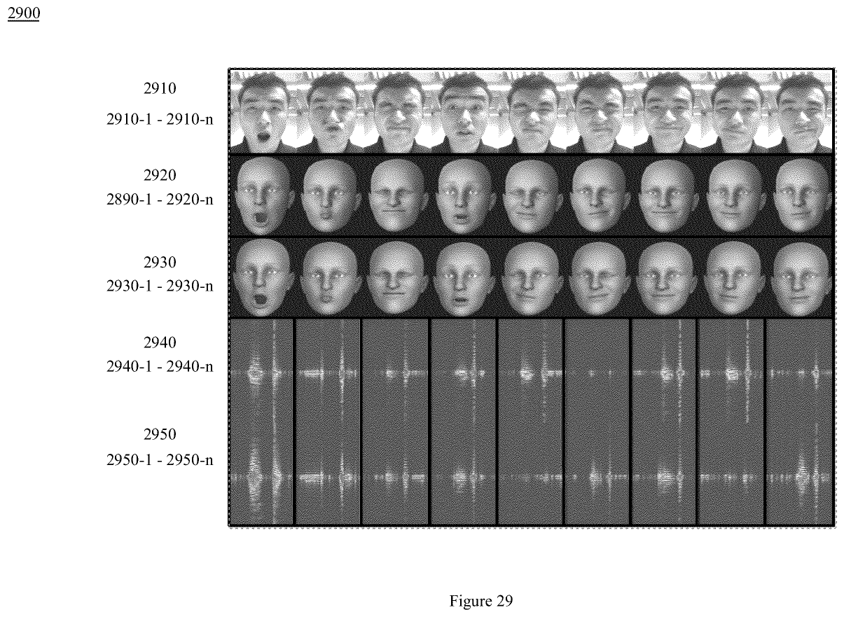

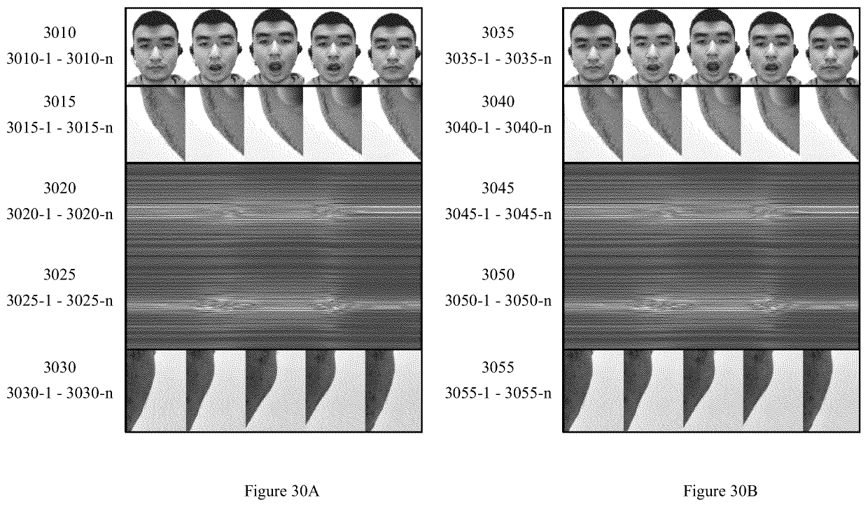

FIG. 19 is a block diagram depicting an acoustic sensor system based facial expression reconstruction system 1900, in accordance with certain examples. As depicted in FIG. 19, acoustic sensor system based facial expression reconstruction system 1900 comprises user computing device 150, acoustic sensor systems 1910-1 through 1910-n, and data processing computing device 1920. User computing device 150 and data processing computing device 1920 are configured to communicate via network 140. Network 140 and user computing device 150 were previously described herein with reference to FIG. 1. User computing device 150 may be configured to receive and display a facial output, such as a predicted facial expression with three-dimensional visualization with examples depicted at 2830 of FIG. 28 and 2930 of FIG. 29. Acoustic sensor systems 1910 are described in greater detail herein with reference to FIGS. 20A, 20B, and 20C.

FIG. 20A is a block diagram depicting a first embodiment of an acoustic sensor system 1910 in accordance with certain examples. Acoustic sensor system 1910 comprises speaker 1911, microphone 1912, Bluetooth module 1913, and printed circuit boards (“PCB”) 1914. Speaker 1911 is a small form factor speaker. In an example, speaker 1911 is a speaker configurable to transmit signals in an inaudible frequency range. For example, speaker 1911 may be configured to transmit signals in a frequency range of 16-24 kHz. Any suitable frequency range may be used. In an example, speaker 1911 transmits signals that are frequency modulation continuous wave (“FMCW”) transmissions, Channel Impulse Response (“CIR”) transmissions, or any other suitable type of acoustic signal. In an example, the speakers transmit inaudible acoustic signals within the frequency range of 16 kHz to 24 kHz towards a user's face. As depicted in FIG. 20A, speaker 1911 is affixed to a PCB 1914.

Microphone 1912 is a small form factor microphone. In an example, microphone 1912 is a Micro-Electro-Mechanical System (“MEMS”) microphone. Microphone 1912 may be a microphone chip, a silicon microphone, or any other suitable microphone. In an example, microphone 1912 is configured to receive reflected signals transmitted by speaker 1911. As depicted in FIG. 20A, microphone 1912 is affixed to a PCB 1914.

Bluetooth module 1913 may be a Bluetooth low energy (“BLE”) module. Bluetooth module 1913 may be a System-on-Chip (“SoC”) module. In an example, Bluetooth module 1913 may comprise a microcontroller unit (“MCU”) with memory. In an example, the memory may be an on-board SanDisk (“SD”) card. The SD card may function to save acoustic data on the MCU. Bluetooth module 1913 may be configured to control a battery (not depicted) to provide power to the acoustic sensor system 1910. In an example, the battery may be a lithium polymer (“LiPo”) battery. Bluetooth module 1913 may be configured to power and control speaker 1911 transmissions, microphone 1912 signal receptions, and data transmissions external to a wearable device, for example transmissions to computing device 1920. As depicted in FIG. 20A, Bluetooth module 1913 is affixed to a PCB 1914.

FIG. 20B is a block diagram depicting a second embodiment of an acoustic sensor system 1910, in accordance with certain examples. FIG. 20B depicts speaker 1911 and microphone 1912 affixed to a common PCB 1914 with Bluetooth module 1913 affixed to a separate PCB 1914.

FIG. 20C is a block diagram depicting a third embodiment of an acoustic sensor system 1910, in accordance with certain examples. FIG. 20C depicts speaker 1911, microphone 1912, and Bluetooth module 1913 affixed to a common PCB 1914. Any suitable configuration of speaker 1911, microphone 1912, Bluetooth module 1913 and PCBs 1914 may be used in addition to the configurations depicted in FIGS. 20A, 20B, and 20C.

In an example, a wearable device system may comprise one or more speaker(s) 1911 and one or more microphone(s) 1912, with a pair of a speaker 1911 and a microphone 1912 affixed on a PCB 1914. Any suitable number of speakers 1911 and microphones 1912 may be included on a particular wearable device system. The positions and/or orientations of the speakers 1911 and microphones 1912 may be adjustable to optimize the recording of reflected signals.

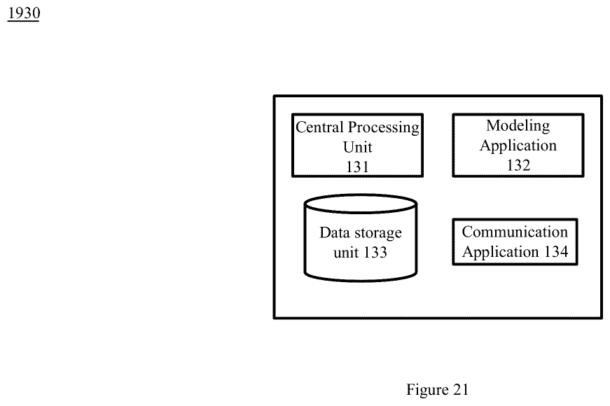

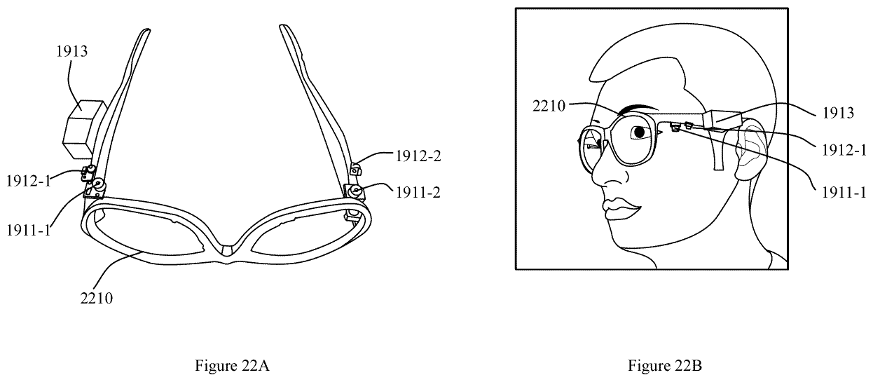

Returning to FIG. 19, acoustic sensor system based facial expression reconstruction system 1900 comprises data processing computing device 1920. Data processing computing device 1920 functions to receive data from Bluetooth module 1913 to construct a facial output. The facial output may comprise one of a facial movement, an avatar movement associated with the facial movement, a speech recognition, text associated with the speech recognition, a physical activity, an emotional status, a two-dimensional visualization of a facial expression, a three-dimensional visualization of a facial expression, an emoji associated with a facial expression, or an avatar image associated with a facial expression. Data processing computing device 1920 may be a smart phone, a mobile device, or any type of computing device described herein with reference to FIG. 31. Data processing computing device 1920 comprises central processing unit 121, graphics processing unit 122, memory 123, communication application 124, and data processing module 1930. Central processing unit 121, graphics processing unit 122, memory 123, and communication application 124 were previously described herein with reference to FIG. 1. Data processing module 1930 is described in greater detail herein with reference to FIG. 21.

FIG. 21 is a block diagram depicting a data processing module 1930, in accordance with certain examples. Data processing module 1930 comprises central processing unit 131, modeling application 132, data storage unit 133, and communication application 134. Central processing unit 131, modeling application 132, data storage unit 133, and communication application 134 were previously described herein with reference to FIG. 1.

FIG. 22A depicts a first embodiment of a head-mounted acoustic sensor system wearable device 2210. As illustrated in FIG. 22A, the head-mounted acoustic sensor system wearable device 2210 is more particularly implemented as a glasses style wearable device 2210 (also referred to herein as glasses device 2210). Glasses device 2210 comprises two speakers 1911-1 and 1911-2, two microphones 1912-1 and 1912-2, and a Bluetooth module 1913. While two speakers 1911 and two microphones 1912 are depicted, any suitable quantity of speakers 1911 and microphones 1912 may be used.

FIG. 22B is an illustration depicting the first embodiment of the head-mounted acoustic sensor system wearable device 2210 on a user. As illustrated in FIG. 22B, glasses device 2210 may be positioned on a user such that a pair of speaker 1911-1 and microphone 1912-1 are located on the left side of the user's face and a pair of speaker 1911-2 and microphone 1912-2 are located on the right side of the user's face. The disposition of each pair on the left and right side of the user allows data associated with skin deformations to be collected for the left and right contours of the user's face.

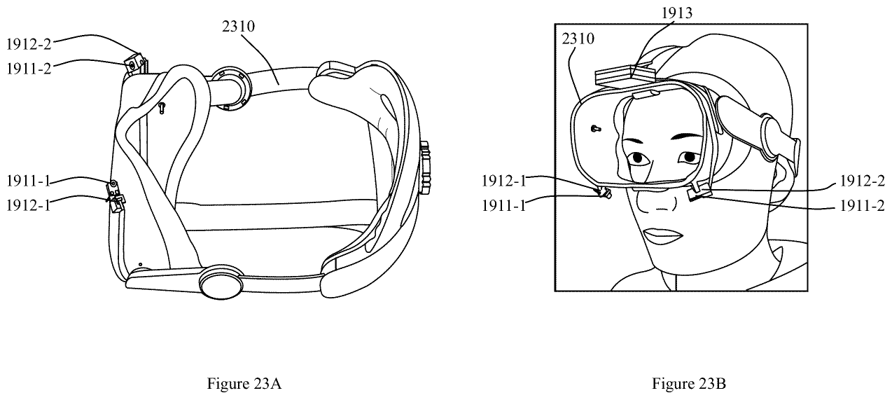

FIG. 23A depicts a second embodiment of a head-mounted acoustic sensor system wearable device 2310. As illustrated in FIG. 23A, the head-mounted acoustic sensor system wearable device 2310 is more particularly implemented as a headset style wearable device 2310 (also referred to herein as headset device 2310). In an example, headset device 2310 may be a virtual reality headset. Headset device 2310 comprises two speakers 1911-1 and 1911-2, two microphones 1912-1 and 1912-2, and a Bluetooth module 1913 (depicted in FIG. 23B). While two speakers 1911 and two microphones 1912 are depicted, any suitable quantity of speakers 1911 and microphones 1912 may be used.

FIG. 23B is an illustration depicting the second embodiment of the head-mounted acoustic sensor system wearable device 2310 on a user. As illustrated in FIG. 23B, headset device 2310 may be positioned on a user such that a pair of speaker 1911-1 and microphone 1912-1 are located on the left side of the user's face and a pair of speaker 1911-2 and microphone 1912-2 are located on the right side of the user's face. The disposition of each pair on the left and right side of the user allows data associated with skin deformations to be collected for the left and right contours of the user's face.

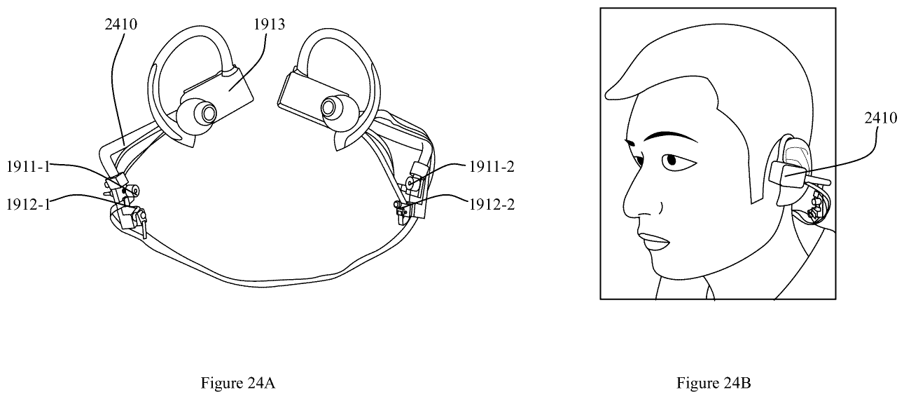

FIG. 24A depicts a third embodiment of a head-mounted acoustic sensor system wearable device 2410. As illustrated in FIG. 24A, the head-mounted acoustic sensor system wearable device 2410 is more particularly implemented as a headphone style wearable device 2410 (also referred to herein as headphone device 2410). In an example, headphone device 2410 may be a headband style headphone, car pods, earphones, ITE headphones, over the ear headphones, or any other headphone type device. Headphone device 2410 comprises two speakers 1911-1 and 1911-2, two microphones 1912-1 and 1912-2, and a Bluetooth module 1913. While two speakers 1911 and two microphones 1912 are depicted, any suitable quantity of speakers 1911 and microphones 1912 may be used.

FIG. 24B is an illustration depicting the third embodiment of the head-mounted acoustic sensor system wearable device 2410 on a user. As illustrated in FIG. 24B, headphone device 2410 may be positioned on a user such that a pair of speaker 1911-1 and microphone 1912-1 are located on the left side of the user's face and a pair of speaker 1911-2 and microphone 1912-2 are located on the right side of the user's face. The disposition of each pair on the left and right side of the user allows data associated with skin deformations to be collected for the left and right contours of the user's face.

As described herein, FIGS. 22A, 23A, and 24A depict example embodiments of a head-mounted acoustic sensor system wearable device. Other example embodiments may include car buds, ear pods, in-the-ear (“ITE”) headphones, over-the-ear headphones, outside-the-ear (“OTE”) headphones, glasses, smart glasses, a visor, a hat, a helmet, headgear, a virtual reality headset, another head-borne device, a necklace, a neckband, a garment-attachable system, or any other type of device or system to which at least one acoustic sensor system 1910 may be affixed.

### Alternate Embodiment Example Processes

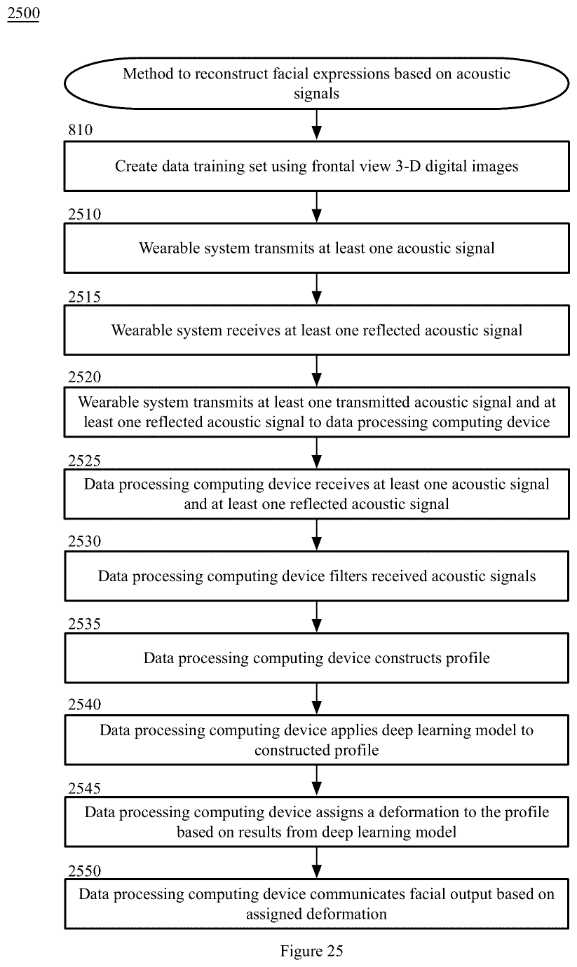

FIG. 25 is a block flow diagram depicting a method 2500 to reconstruct facial expressions based on acoustic signals, in accordance with certain examples. In block 810, a data training set is created using frontal view digital images. Block 810 was previously described herein with reference to method 810 of FIG. 9.

In block 2510, a wearable system transmits at least one acoustic signal. The wearable system may be a system as described herein with reference to glasses device 2210, headset device 2310, headphone device 2410. In an example, the wearable system may include other embodiments such as ear buds, ear pods, ITE headphones, over-the-ear headphones, OTE headphones, glasses, smart glasses, a visor, a hat, a helmet, headgear, a virtual reality headset, another head-borne device, a necklace, a neckband, a garment-attachable system, or any other type of device or system to which at least one acoustic sensor system 1910 may be affixed. In an example, the wearable system is positioned on a wearer such that the distance from the wearable system to the wearer's face is less than 10 cm, 11 cm, 12 cm, 13 cm, 14 cm, 15 cm, or any suitable distance. The at least one acoustic signal is transmitted by a speaker 1911 of at least one acoustic sensor system 1910. Acoustic sensor system 1910 may be configured to transmit signals in a frequency range of 16-24 kHz. Any suitable frequency range may be used. Acoustic sensor system 1910 may transmit signals that are FMCW transmissions, CIR transmissions, or any other suitable type of acoustic signal. In an example, the transmitted signals have an associated sample length. For example, the sample length may be set to 600 corresponding to a sample length of 0.012 seconds. In this example, approximately 83.3 frames may be collected per second. Any suitable sample length may be used. In an example, acoustic sensor system 1910 transmits inaudible acoustic signals within the frequency range of 16 kHz to 24 kHz towards a wearer's face. In an example, acoustic sensor system 1910 may be positioned on the wearable system to transmit acoustic signals towards a first facial feature on a first side of a sagittal plane of a wearer and to transmit acoustic signals towards a second facial feature on a second side of the sagittal plane of a wearer. In an example, acoustic sensor system 1910 may be positioned on the wearable system to transmit acoustic signals towards an underside contour of a chin of a wearer.

In block 2515, the wearable system receives at least one reflected acoustic signal. Subsequent to transmitting the at least one acoustic signal toward a wearer's face as described herein with reference to block 2510, the signal is reflected by the wearer's face. The at least one reflected acoustic signal is received by microphone 1912 of the at least one acoustic sensor system 1910. The at least one transmitted signal is reflected differently to microphone 1912 based on skin deformations associated with different facial movements.

In block 2520, the wearable system transmits the at least one transmitted acoustic signal and the at least one reflected acoustic signal to data processing computing device 1920. In an example, the at least one transmitted acoustic signal and the at least one reflected acoustic signal are transmitted in frames. The at least one transmitted acoustic signal and the at least one reflected acoustic signal are transmitted by the Bluetooth module 1913 of the at least one acoustic sensor system 1910.

In block 2525, data processing computing device 1920 receives the at least one transmitted acoustic signal and the at least one reflected acoustic signal.

In block 2530, data processing computing device 1920 filters the received acoustic signals. In an example, the at least one transmitted acoustic signal and the at least one reflected acoustic signal are filtered to remove noise outside of a target frequency range. In an example, the target frequency range is 15.5 kHz to 20.5 kHz. Any suitable target frequency range may be used. In an example, the at least one transmitted acoustic signal and the at least one reflected acoustic signal are filtered using a Butterworth band-pass filter. Any suitable filter may be used.

In block 2535, data processing computing device 1920 constructs a profile using the filtered acoustic signals. In an example, the profile is an echo profile. The echo profile is determined by calculating a cross-correlation between the filtered at least one transmitted acoustic signal and the filtered at least one reflected acoustic signal. The echo profile depicts deformations of the skin of the wearer's face in temporal and spatial domains. In an example, a differential echo profile may be calculated. A differential echo profile is calculated by subtracting echo profiles between two adjacent echo frames. The differential echo profile removes static objects that may be present in the echo profile. Further, as the wearable system was positioned to be less than 10-15 cm away from a wearer's face, echo profiles comprising distance greater than that range may also be removed. For example, echo profiles with a distance greater than ±16 cm, ±17 cm, ±18 cm, or any other suitable distance may be removed. In an example, the transmitted acoustic signal is an FMCW signal from which the echo profile is constructed. In alternate examples, the transmitted acoustic signal may be a CIR signal with global system for mobiles (“GSM”), characteristic impedance (“ZC”), or Barker sequence encoding; angle of arrival (“AoA”); doppler effect; or phase change detection.

In block 2540, data processing computing device 1920 applies a deep learning model to the constructed profile. The deep-learning model for facial expression reconstruction was previously described herein with reference to the processes and methods of FIG. 4, FIG. 5, and FIG. 14. In an example with reference to acoustic data, a sliding window of one second may be applied to the differential echo profiles to provide 84 frames of differential echo profiles in each window. In an example, each differential echo profile may have approximately 200 data points providing an input vector of size 200×84. The input vector is used in the deep learning model along with the training data to estimate facial expressions.

In block 2545, data processing computing device 1920 assigns a deformation to the constructed profile based on the results of the deep learning model. In an example, the assigned deformation has a predetermined degree of correspondence to a selected one of a plurality of deformations in the deep learning model.

In block 2550, the data processing computing device 1920 communicates a facial output based on the assigned deformation. In an example, the facial output comprises one of a facial movement, an avatar movement associated with the facial movement, a speech recognition, text associated with the speech recognition, a physical activity, an emotional status, a two-dimensional visualization of a facial expression, a three-dimensional visualization of a facial expression, an emoji associated with a facial expression, or an avatar image associated with a facial expression. In an example, the facial output is communicated to user computing device 150. In an example, the facial output is communicated in real time. In an example, the facial output is continuously updated.

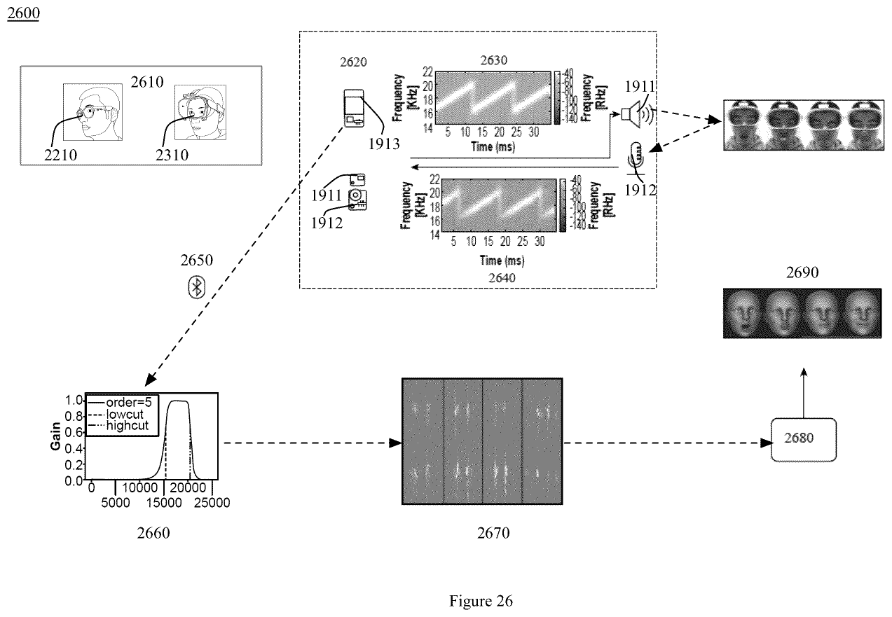

FIG. 26 is a diagram 2600 depicting an acoustic sensor system based facial expression reconstruction process. FIG. 26 is a visual depiction of the method 2500 described herein with reference to FIG. 25. At 2610, a wearer is depicted with glasses device 2210 and headset device 2310. In an example, a wearer may select a wearable device from the various embodiments previously described herein. At 2620, speaker 1911, microphone 1912, and Bluetooth module 1913 of an acoustic sensor system 1910 of the wearable device are illustrated. At 2630, an acoustic signal is depicted as being transmitted by speaker 1911 and directed to the wearer's face. At 2630, the acoustic signal is deflected by the wearer's face and received by microphone 1912 at 2640. At 2650, the transmitted acoustic signal and the deflected acoustic signal are transmitted to data processing computing device 1920 (not depicted) by Bluetooth module 1913. At 2660, the transmitted acoustic signal and the deflected acoustic signal are filtered. At 2670, differential echo profiles are depicted. At 2680, the differential echo profiles are input into a deep learning model. At 2690, predicted facial expressions are depicted.

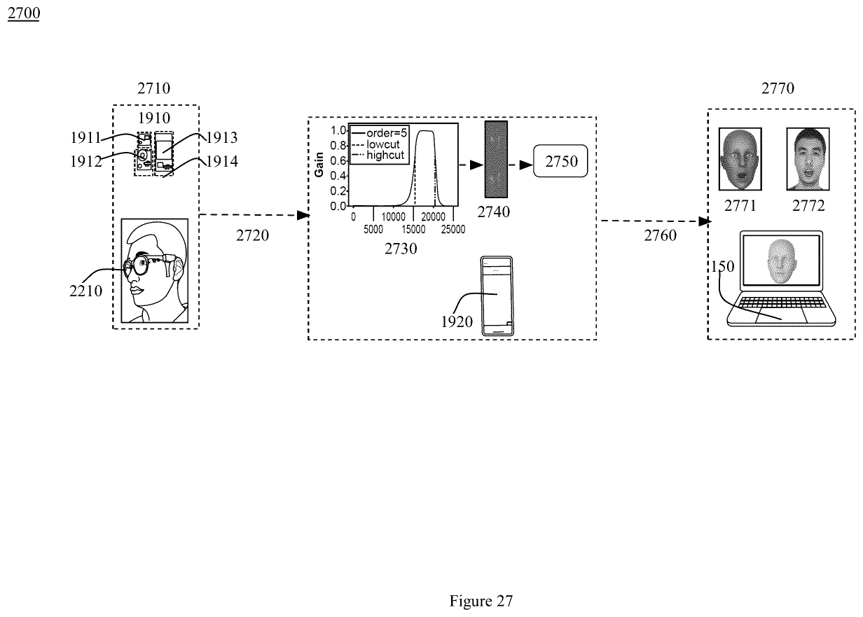

FIG. 27 is a diagram 2700 depicting an acoustic sensor system based facial expression reconstruction output process. FIG. 27 is a second visual depiction of the method 2500 described herein with reference to FIG. 25. At 2710, a wearer is depicted with glasses device 2210 with an acoustic sensor system 1910 comprising speaker 1911, microphone 1912, Bluetooth module 1913, and PCB 1914. At 2720, acoustic data, i.e., transmitted acoustic signal and deflected acoustic signal, are transmitted by acoustic sensor system 1910 to data processing computing device 1920. At 2730, the transmitted acoustic signal and the deflected acoustic signal are filtered. At 2740, differential echo profiles are depicted. At 2750, the differential echo profiles are input into a deep learning model. At 2760, data processing computing device 1920 transmits the output of the deep learning model to user computing device 150. At 2770, example facial outputs are depicted as received by user computing device 150. Example facial outputs may be a 3D avatar, such as depicted at 2771, or a personalized avatar, such as depicted at 2772.

FIG. 28 is a diagram 2800 depicting the correlation between frontal view camera images 2810 and 2820, predicted facial expressions 2830, and left and right differential echo profiles, 2840 and 2850 respectively, also referred to herein as respective rows 2810 through 2850, in accordance with certain examples. Rows 2810 and 2820 illustrate frontal view camera images of a user. To construct a training data set or “ground truth,” frontal view camera images of a user are acquired, via an imaging capturing device, with the user making various different facial expressions as depicted in images 2810-1 through 2810-n and images 2820-1 through 2820-n. The method to create the training data set from the frontal view camera images is described herein in greater detail with reference to method 810 of FIG. 9. Row 2840 depicts left differential echo profiles 2840-1 through 2840-n captured by a head-mounted, wearable device, such as glasses device 2210 or headset device 2310 described herein with reference to FIG. 22 and FIG. 23. Row 2850 depicts right differential echo profiles 2850-1 through 2850-n captured by a head-mounted, wearable device, such as glasses device 2210 or headset device 2310 described herein with reference to FIG. 22 and FIG. 23. Left differential echo profiles 2840 and right differential echo profiles 2850 are input into a deep learning model, as previously described herein, to create the predicted facial expressions depicted at 2830. Predicted facial expressions 2830-1 through 2830-n are illustrated in FIG. 28 beneath the frontal view camera images in rows 2810-1 through 2810-n and 2820-1 through 2820-n to illustrate the accuracy of the predicted facial expressions 2830.

FIG. 29 is a diagram 2900 depicting the correlation between frontal view camera images 2910, training data 2920, predicted facial expressions 2930, and left and right differential echo profiles, 2940 and 2950 respectively, also referred to herein as respective rows 2910 through 2950. Row 2910 illustrates frontal view camera images of a user. To construct a training data set or “ground truth,” frontal view camera images of a user are acquired, via an imaging capturing device, with the user making various different facial expressions as depicted in images 2910-1 through 2910-n. The method to create the training data set from the frontal view camera images is described herein in greater detail with reference to method 810 of FIG. 9. Row 2920 depicts a training data image or ground truth for the frontal view camera images in row 2910. Training data images 2920-1 through 2920-n correspond with frontal view camera images 2910-1 through 2910-n. Row 2940 depicts left differential echo profiles 2940-1 through 2940-n captured by a head-mounted, wearable device. Row 2950 depicts right differential echo profiles 2950-1 through 2950-n captured by a head-mounted, wearable device. Left differential echo profiles 2940 and right differential echo profiles 2950 are input into a deep learning model, as previously described herein, to create the predicted facial expressions depicted at 2930. Predicted facial expressions 2930-1 through 2930-n are illustrated in FIG. 29 beneath the ground truth images 2920-1 through 2920-n to illustrate the accuracy of the predicted facial expressions 2930.

FIG. 30A is a diagram depicting the correlation between frontal view camera images of an open mouth 3010, a left view image 3015, a left and right echo profile, 3020 and 3025 respectively, and a right view image 3030. The skin deformations, depicted in left view images 3015-1 through 3015-n and right view images 3030-1 through 3030-n, created by the various facial expressions 3010-1 through 3010-n result in distinctive patterns changes depicted in left echo profiles 3020-1 through 3020-n and right echo profiles 3025-1 through 3025-n. FIG. 30B is a diagram depicting the correlation between frontal view camera images of a right sneer 3035, a left view image 3040, a left and right echo profile, 3045 and 3050 respectively, and a right view image 3055. The skin deformations, depicted in left view images 3040-1 through 3040-n and right view images 3055-1 through 3055-n, created by the various facial expressions 3035-1 through 3035-n result in distinctive patterns changes depicted in left echo profiles 3045-1 through 3045-n and right echo profiles 3050-1 through 3050-n.

While acoustic sensing technology may be used to determine facial expressions by detecting skin deformations, acoustic sensing technology may be used to directly determine other outputs associated with skin deformation without the need to first determine facial expressions. For example, the acoustic sensing technology may track blinking patterns and eyeball movements of a user. Blinking patterns and eyeball movements can be applied to the diagnosis and treatment processes of eye diseases. The acoustic sensing technology may detect movements of various parts of the face associated with speech, whether silent or voiced. While speaking, different words and/or phrases lead to subtle, yet distinct, skin deformations. The acoustic sensing technology can capture the skin deformation to recognize silent speech or to vocalize sound. By tracking subtle skin deformations, the acoustic sensing technology can be used to synthesize voice. The acoustic sensing technology may also be used to recognize and track physical activities. For example, while eating, a user opens the mouth, chews, and swallows. During each of those movements, the user's skin deforms in a certain way such that opening the mouth is distinguishable from chewing and from swallowing. The detected skin deformations may be used to determine the type and quantity of food consumed by a user. Similar to eating, a type and quantity of a consumed drink may be determined by skin deformation. The acoustic sensing technology may also be used to determine an emotional status of a user. An emotional status may be related to skin deformations. By detecting skin deformations, an emotional status can be determined and reported to corresponding applications. In an example, acoustic sensor system based facial expression reconstruction system 1900, described herein with reference to FIG. 19, may be configured to directly determine the other outputs associated with skin deformation without the need to first determine facial expressions, including, but not limited to, facial movements including eyeball movement, speech recognition, physical activities, and emotional status. Acoustic sensor system based facial expression reconstruction system 1900 may be configured to directly determine the other outputs associated with skin deformation using any type of acoustic sensor system 1910 as described herein with reference to FIG. 19.

### Other Examples

FIG. 31 depicts a computing machine 4000 and a module 4050 in accordance with certain examples. The computing machine 4000 may correspond to any of the various computers, servers, mobile devices, embedded systems, or computing systems presented herein. The module 4050 may comprise one or more hardware or software element(s) configured to facilitate the computing machine 4000 in performing the various methods and processing functions presented herein. The computing machine 4000 may include various internal or attached components such as a processor 4010, system bus 4020, system memory 4030, storage media 4040, input/output interface 4060, and a network interface 4070 for communicating with a network 4080.

The computing machine 4000 may be implemented as a conventional computer system, an embedded controller, a laptop, a server, a mobile device, a smartphone, a set-top box, a kiosk, a router or other network node, a vehicular information system, one or more processor(s) associated with a television, a customized machine, any other hardware platform, or any combination or multiplicity thereof. The computing machine 4000 may be a distributed system configured to function using multiple computing machines interconnected via a data network or bus system.

The processor 4010 may be configured to execute code or instructions to perform the operations and functionality described herein, manage request flow and address mappings, and to perform calculations and generate commands. The processor 4010 may be configured to monitor and control the operation of the components in the computing machine 4000. The processor 4010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 4010 may be a single processing unit, multiple processing units, a single processing core, multiple processing cores, special purpose processing cores, co-processors, or any combination thereof. The processor 4010 along with other components of the computing machine 4000 may be a virtualized computing machine executing within one or more other computing machine(s).

The system memory 4030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 4030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 4030. The system memory 4030 may be implemented using a single memory module or multiple memory modules. While the system memory 4030 is depicted as being part of the computing machine 4000, one skilled in the art will recognize that the system memory 4030 may be separate from the computing machine 4000 without departing from the scope of the subject technology. It should also be appreciated that the system memory 4030 may include, or operate in conjunction with, a non-volatile storage device such as the storage media 4040.

The storage media 4040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 4040 may store one or more operating system(s), application programs and program modules such as module 4050, data, or any other information. The storage media 4040 may be part of, or connected to, the computing machine 4000. The storage media 4040 may also be part of one or more other computing machine(s) that are in communication with the computing machine 4000 such as servers, database servers, cloud storage, network attached storage, and so forth.

The module 4050 may comprise one or more hardware or software element(s) configured to facilitate the computing machine 4000 with performing the various methods and processing functions presented herein. The module 4050 may include one or more sequence(s) of instructions stored as software or firmware in association with the system memory 4030, the storage media 4040, or both. The storage media 4040 may therefore represent machine or computer readable media on which instructions or code may be stored for execution by the processor 4010. Machine or computer readable media may generally refer to any medium or media used to provide instructions to the processor 4010. Such machine or computer readable media associated with the module 4050 may comprise a computer software product. It should be appreciated that a computer software product comprising the module 4050 may also be associated with one or more process(es) or method(s) for delivering the module 4050 to the computing machine 4000 via the network 4080, any signal-bearing medium, or any other communication or delivery technology. The module 4050 may also comprise hardware circuits or information for configuring hardware circuits such as microcode or configuration information for an FPGA or other PLD.

The input/output (“I/O”) interface 4060 may be configured to couple to one or more external device(s), to receive data from the one or more external device(s), and to send data to the one or more external device(s). Such external devices along with the various internal devices may also be known as peripheral devices. The I/O interface 4060 may include both electrical and physical connections for operably coupling the various peripheral devices to the computing machine 4000 or the processor 4010. The I/O interface 4060 may be configured to communicate data, addresses, and control signals between the peripheral devices, the computing machine 4000, or the processor 4010. The I/O interface 4060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 4060 may be configured to implement only one interface or bus technology. Alternatively, the I/O interface 4060 may be configured to implement multiple interfaces or bus technologies. The I/O interface 4060 may be configured as part of, all of, or to operate in conjunction with, the system bus 4020. The I/O interface 4060 may include one or more buffer(s) for buffering transmissions between one or more external device(s), internal device(s), the computing machine 4000, or the processor 4010.

The I/O interface 4060 may couple the computing machine 4000 to various input devices including mice, touch-screens, scanners, electronic digitizers, sensors, receivers, touchpads, trackballs, cameras, microphones, keyboards, any other pointing devices, or any combinations thereof. The I/O interface 4060 may couple the computing machine 4000 to various output devices including video displays, speakers, printers, projectors, tactile feedback devices, automation control, robotic components, actuators, motors, fans, solenoids, valves, pumps, transmitters, signal emitters, lights, and so forth.

The computing machine 4000 may operate in a networked environment using logical connections through the network interface 4070 to one or more other system(s) or computing machines across the network 4080. The network 4080 may include WANs, LANs, intranets, the Internet, wireless access networks, wired networks, mobile networks, telephone networks, optical networks, or combinations thereof. The network 4080 may be packet switched, circuit switched, of any topology, and may use any communication protocol. Communication links within the network 4080 may involve various digital or an analog communication media such as fiber optic cables, free-space optics, waveguides, electrical conductors, wireless links, antennas, radio-frequency communications, and so forth.

The processor 4010 may be connected to the other elements of the computing machine 4000 or the various peripherals discussed herein through the system bus 4020. It should be appreciated that the system bus 4020 may be within the processor 4010, outside the processor 4010, or both. Any of the processor 4010, the other elements of the computing machine 4000, or the various peripherals discussed herein may be integrated into a single device such as a system on chip (“SOC”), system on package (“SOP”), or ASIC device.

Examples may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing examples in computer programming, and the examples should not be construed as limited to any one set of computer program instructions. Further, a skilled programmer would be able to write such a computer program to implement an example of the disclosed examples based on the appended flow charts and associated description in the application text. Therefore, disclosure of a particular set of program code instructions is not considered necessary for an adequate understanding of how to make and use examples. Further, those skilled in the art will appreciate that one or more aspect(s) of examples described herein may be performed by hardware, software, or a combination thereof, as may be embodied in one or more computing system(s). Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. Computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The systems, methods, and acts described in the examples presented previously are illustrative, and, alternatively, certain acts can be performed in a different order, in parallel with one another, omitted entirely, and/or combined between different examples, and/or certain additional acts can be performed, without departing from the scope and spirit of various examples. Accordingly, such alternative examples are included in the scope of the following claims, which are to be accorded the broadest interpretation so as to encompass such alternate examples.

Although specific examples have been described above in detail, the description is merely for purposes of illustration. It should be appreciated, therefore, that many aspects described above are not intended as essential elements unless explicitly stated otherwise. Modifications of, and equivalent components or acts corresponding to, the disclosed aspects of the examples, in addition to those described above, can be made by a person of ordinary skill in the art, having the benefit of the present disclosure, without departing from the spirit and scope of examples defined in the following claims, the scope of which is to be accorded the broadest interpretation so as to encompass such modifications and equivalent structures.

Various embodiments are described herein. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment,” “an embodiment,” “an example embodiment,” or other similar language means that a particular feature, structure, or characteristic described in connection with the embodiment is included in at least one embodiment of the invention described herein. Thus, appearances of the phrases “in one embodiment,” “in an embodiment,” “an example embodiment,” or other similar language in various places throughout this specification are not necessarily all referring to the same embodiment. Furthermore, the particular features, structures, or characteristics may be combined in any suitable manner in one or more embodiment(s), as would be apparent to a person having ordinary skill in the art and the benefit of this disclosure. Furthermore, while some embodiments described herein include some, but not other, features included in other embodiments, combinations of features of different embodiments are meant to be within the scope of the invention. For example, in the appended claims, any of the claimed embodiments can be used in any combination.

The following examples are presented to illustrate the present disclosure. The examples are not intended to be limiting in any manner.

Example 1 is a wearable system, comprising: at least one acoustic sensor system configured to transmit at least one acoustic signal, to receive at least one reflected acoustic signal, and to output the at least one transmitted acoustic signal and the at least one received reflected acoustic signal; a processor that receives the at least one transmitted acoustic signal and the at least one received reflected acoustic signal from each of the at least one acoustic sensor system; and a physical memory, the physical memory comprising instructions that when executed by the processor cause the processor to: calculate a profile associated with the at least one transmitted acoustic signal and the at least one received reflected acoustic signal; assign a deformation to the profile, the assigned deformation having a predetermined degree of correspondence to a selected one of a plurality of deformations in a model when compared to the profile; and communicate a facial output based on the assigned deformation.

Example 2 includes the subject matter of Example 1, wherein the at least one acoustic sensor system comprises at least one speaker and at least one microphone.

Example 3 includes the subject matter of Examples 1 and 2, wherein the at least one acoustic sensor system comprises a Bluetooth low energy (“BLE”) module to output the at least one transmitted acoustic signal and the at least one received reflected acoustic signal.

Example 4 includes the subject matter of any of Examples 1-3, wherein the at least one transmitted acoustic signal is a frequency modulation continuous wave (“FMCW”) signal.

Example 5 includes the subject matter of any of Examples 1-4, wherein the profile is a differential echo profile.

Example 6 includes the subject matter of any of Examples 1-5, wherein the deformation is a skin deformation.

Example 7 includes the subject matter of any of Examples 1-6, wherein the communicated facial output comprises one of a facial movement, an avatar movement associated with the facial movement, a speech recognition, text associated with the speech recognition, a physical activity, an emotional status, a two-dimensional visualization of a facial expression, a three-dimensional visualization of a facial expression, an emoji associated with a facial expression, or an avatar image associated with a facial expression.

Example 8 includes the subject matter of any of Examples 1-7, the at least one acoustic sensor system positioned on the wearable system to transmit acoustic signals towards a first facial feature on a first side of a sagittal plane of a wearer and to transmit acoustic signals towards a second facial feature on a second side of the sagittal plane of a wearer.

Example 9 includes the subject matter of any of Examples 1-8, the at least one acoustic sensor system positioned on the wearable system to transmit acoustic signals towards an underside contour of a chin of a wearer.

Example 10 includes the subject matter of any of Examples 1-9, the wearable system comprising ear buds, ear pods, in-the-ear (ITE) headphones, over-the-ear headphones, or outside-the-ear (OTE) headphones to which the at least one acoustic sensor system is attached.

Example 11 includes the subject matter of any of Examples 1-10, the wearable system comprising glasses, smart glasses, a visor, a hat, a helmet, headgear, a virtual reality headset, or another head-borne device to which the at least one acoustic sensor system is attached.

Example 12 includes the subject matter of any of Examples 1-11, the wearable system comprising a necklace, a neckband, or a garment-attachable system to which the at least one acoustic sensor system is attached.

Example 13 includes the subject matter of any of Examples 1-12, further comprising a computing device that receives and displays the communicated facial output.

Example 14 includes the subject matter of any of Examples 1-13, wherein the model is trained using machine learning.

Example 15 includes the subject matter of any of Examples 1-14, wherein the training comprises: receiving one or more frontal view facial image(s) of a subject, each of the frontal view facial images corresponding to a deformation of a plurality of deformations of the subject; receiving one or more transmitted acoustic signal(s) and one or more corresponding reflected acoustic signal(s) associated with the subject, each of the one or more transmitted acoustic signal(s) and the one or more corresponding reflected acoustic signal(s) from the at least one acoustic sensor system also corresponding to a deformation of the plurality of deformations of the subject; and correlating, for each of the deformations, the one or more transmitted acoustic signal(s) and the one or more corresponding reflected acoustic signal(s) from the at least one acoustic sensor system corresponding to a particular deformation to the one or more frontal view facial image(s) corresponding to the particular deformation.

Further examples are described below.

In some embodiments, a wearable system comprises at least one imaging sensor configured to capture one or more image(s) of a facial feature of a wearer of the wearable system and to output image data corresponding to the one or more image(s); a processor that receives the image data from each of the at least one imaging sensor; and a physical memory, the physical memory comprising instructions that when executed by the processor cause the processor to: generate a profile based on the image data from each of the at least one imaging sensor; compare the profile to a model; assign a deformation to the profile, the assigned deformation having a predetermined degree of correspondence to a selected one of a plurality of deformations in the model when compared to the profile; and communicate a facial output based on the assigned deformation.

The at least one imaging sensor in some embodiments comprises an acoustic camera or an acoustic sensor configured to: transmit at least one acoustic signal towards the wearer's face, wherein the at least one acoustic signal is a frequency modulated continuous-wave acoustic signal with a frequency above 18 kHz and within a range of 18 kHz to 24.5 kHz, including all 0.1 kHz values and ranges therebetween; and detect at least one reflected acoustic signal from the wearer's face, wherein the at least one transmitted signal is reflected differently based on a change in eyeball shape and/or skin deformation associated with ocular movement.

In various examples, the at least one imaging sensor comprises a first imaging sensor and a second imaging sensor. In an example, the first imaging sensor and the second imaging sensor are configured to transmit acoustic signals within different frequency ranges, e.g., the first imaging sensor is configured to transmit acoustic signals in a frequency range of 18-21 kHz (including all 0.1 kHz values and ranges therebetween) and the second imaging sensor is configured to transmit acoustic signals in a frequency range of 21.5-24.5 kHz (including all 0.1 kHz values and ranges therebetween). In an example, the first imaging sensor and the second imaging sensor are configured in a symmetrical orientation on the wearable system relative to a sagittal plane of the wearer.

In some embodiments, the acoustic camera or the acoustic sensor comprise one or more speaker(s) and one or more microphone(s), each of the one or more speaker(s) configured to transmit the at least one signal towards the wearer's face and each of the one of more microphone(s) configured to receive the at least one reflected signal from the wearer's face.

In some embodiments, the image data comprises the at least one transmitted signal and the at least one reflected signal.

In some embodiments, generating the profile comprises: filtering the at least one transmitted signal and the at least one reflected signal; and calculating a cross-correlation between the at least one filtered transmitted signal and the at least one filtered reflected signal.

In some embodiments, filtering the at least one transmitted signal and the at least one reflected signal comprises removing data outside of a target frequency range.

As additional examples, the target frequency range is 17.5 kHz to 25 kHz, including all 0.1 kHz values and ranges therebetween.

In some embodiments, the assigned deformation is associated with a shape of the wearer's eyes and/or a deformation of skin in an orbital region around the wearer's eyes.

In some embodiments, wherein the communicated facial output comprises a gaze position of the wearer.

In some embodiments, the gaze position comprises one or more position coordinate(s) associated with a Cartesian coordinate system, a polar coordinate system, or a spherical coordinate system, or the like.

In some embodiments, the profile is an echo profile.

In some embodiments, comparing the profile to the model comprises: generating a second profile based on the image data; generating a differential profile based on the profile and the second profile; and comparing the differential profile to the model. As additional examples, the profile is an echo profile and the differential profile is a differential echo profile.

In some embodiments, the at least one imaging sensor is positioned on the wearable system to capture image data of a first facial feature on a first side of a sagittal plane of the wearer and to capture image data of a second facial feature on a second side of the sagittal plane of the wearer. As additional examples, the first facial feature and the second facial feature are each associated with an orbital region of the wearer.

In some embodiments, the at least one imaging sensor is positioned on the wearable system to capture image data of an orbital region of the wearer.

In some embodiments, the model is trained using machine learning or the like. As additional examples, the training comprises receiving one or more orbital region image(s) of a subject, each of the orbital region images corresponding to a gaze position of a plurality of gaze positions of the subject; receiving one or more image(s) of the subject from the at least one imaging sensor, each of the images from the at least one imaging sensor also corresponding to a gaze position of the plurality of gaze positions of the subject; and correlating, for each of the gaze positions, the one or more image(s) from the at least one imaging sensor corresponding to a particular gaze position to the one or more orbital region image(s) corresponding to the particular gaze position.

In some embodiments, the at least one imaging sensor comprises a first imaging sensor and a second imaging sensor, with the first imaging sensor positioned on the wearable system to capture first image data of a first facial feature of the wearer, and the second imaging sensor positioned on the wearable system to capture second image data of a second facial feature of the wearer, wherein comparing the profile to the model comprises comparing a first profile associated with the first image data of the first facial feature of the wearer to the model and comparing a second profile associated with the second image data of the second facial feature of the wearer to the model, wherein assigning a deformation to the profile comprises assigning a first deformation to the first profile and a second deformation to the second profile, and wherein the facial output is based on the assigned first deformation and the assigned second deformation. In some embodiments, the first imaging sensor and the second imaging sensor are configured to transmit acoustic signals within different frequency ranges.

In some embodiments, the first imaging sensor is configured to transmit acoustic signals in a frequency range of 18-21 kHz and the second imaging sensor is configured to transmit acoustic signals in a frequency range of 21.5-24.5 kHz.

In some embodiments, the first imaging sensor and the second imaging sensor are configured in a symmetrical orientation on the wearable system relative to a sagittal plane of the wearer.

In some embodiments, the first imaging sensor is positioned on the wearable system to capture image data of the first facial feature on a first side of a sagittal plane of the wearer, and the second imaging sensor is positioned on the wearable system to capture an image of the second facial feature on a second side of the sagittal plane of the wearer.

In some embodiments, the first facial feature comprises a left side of an orbital region of the wearer, and the second facial feature comprises a right side of the face of the orbital region of the wearer.

In some embodiments, the wearable system comprising glasses, smart glasses, goggles, spectacles, or another head-borne device to which the at least one imaging sensor is attached.

In some embodiments, the physical memory comprises further instructions that when executed by the processor cause the processor to: compare the assigned deformation to a second model; and assign the facial output based on the assigned deformation, the assigned facial output having a predetermined degree of correspondence to a selected one of a plurality of deformations in the second model when compared to the assigned deformation.

In some embodiments, the second model is trained using machine learning or the like. As additional examples, the training comprises receiving one or more orbital region image(s) of a subject, each of the orbital region images corresponding to a gaze position of a plurality of gaze positions of the subject; receiving one or more image(s) of the subject from the at least one imaging sensor, each of the images from the at least one imaging sensor also corresponding to a gaze position of the plurality of gaze positions of the subject; and correlating, for each of the gaze positions, the one or more image(s) from the at least one imaging sensor corresponding to a particular gaze position to the one or more orbital region image(s) corresponding to the particular gaze position.

In some embodiments, the wearable system further comprises a computing device that receives and displays the communicated facial output.

In some embodiments, the physical memory comprises further instructions that when executed by the processor cause the processor to: receive a second set of image data from each of the at least one imaging sensor; generate a second profile based on the second set of image data from each of the at least one imaging sensor; compare the second profile to the model; assign a second deformation to the second profile, the assigned second deformation having a predetermined degree of correspondence to a selected one of the plurality of deformations in the model when compared to the second profile; and communicate a second facial output based on the assigned second deformation.

In some embodiments, the wearable system further comprises a computing device that receives and displays the communicated facial output and the communicated second facial output, wherein the communicated facial output and the communicated second facial output are gaze positions of the wearer, the communicated second facial output being displayed subsequent to the communicated facial output to illustrate a motion of gaze positions.

Another illustrative embodiment provides a method to determine a facial output using a wearable system, comprising: positioning a first imaging sensor of a wearable system to image a first facial feature of a wearer; imaging the first facial feature of the wearer using the first imaging sensor; comparing, via a processor, the imaged first facial feature to a first model; and assigning, via the processor, a facial output corresponding to the imaged first facial feature selected from one of a plurality of facial outputs in the first model.

In some embodiments, the act of positioning the first imaging sensor of the wearable system comprises positioning the first imaging sensor in a vicinity of eyes of the wearer facing inward to include within a field of view an orbital region of one side of the wearer's face.

Another illustrative embodiment provides a method to determine a facial output using a wearable system, comprising: positioning a first imaging sensor of a wearable system to image a first facial feature of a wearer; positioning a second imaging sensor of the wearable system to image a second facial feature of the wearer; imaging the first facial feature of the wearer using the first imaging sensor; imaging the second facial feature of the wearer using the second imaging sensor; comparing, via a processor, the imaged first facial feature and the imaged second facial feature to a model; and assigning, via the processor, a facial output selected from one of a plurality of facial outputs in the model corresponding to the imaged first facial feature and the imaged second facial feature.

In additional embodiments, a wearable system comprises at least one imaging sensor configured to capture one or more image(s) of a facial feature of a wearer of the wearable system and to output image data corresponding to the one or more image(s); a processor that receives the image data from each of the at least one imaging sensor; and a physical memory, the physical memory comprising instructions that when executed by the processor cause the processor to: generate a profile based on the image data from each of the at least one imaging sensor; compare the profile to a model; assign a deformation to the profile, the assigned deformation having a predetermined degree of correspondence to a selected one of a plurality of deformations in the model when compared to the profile; and communicate a text output based on the assigned deformation.

In some embodiments, the at least one imaging sensor comprises an acoustic camera or an acoustic sensor configured to: transmit at least one acoustic signal towards the wearer's face, wherein the at least one acoustic signal is a frequency modulated continuous-wave acoustic signal with a frequency above 18 kHz and within a range of 18 kHz to 24.5 kHz, including all 0.1 kHz values and ranges therebetween; and detect at least one reflected acoustic signal from the wearer's face, wherein the at least one transmitted signal is reflected differently based on different facial expressions or movements of the wearer associated with speech.

In various examples, the at least one imaging sensor comprises a first imaging sensor and a second imaging sensor. In an example, the first imaging sensor and the second imaging sensor are configured to transmit acoustic signals within different frequency ranges, e.g., the first imaging sensor is configured to transmit acoustic signals in a frequency range of 18-21 kHz (including all 0.1 kHz values and ranges therebetween) and the second imaging sensor is configured to transmit acoustic signals in a frequency range of 21.5-24.5 kHz (including all 0.1 kHz values and ranges therebetween). In an example, the first imaging sensor and the second imaging sensor are configured in a symmetrical orientation on the wearable system relative to a sagittal plane of the wearer.

In some embodiments, the acoustic camera or the acoustic sensor comprise one or more speaker(s) and one or more microphone(s), each of the one or more speaker(s) configured to transmit the at least one signal towards the wearer's face and each of the one of more microphone(s) configured to receive the at least one reflected signal from the wearer's face.

In some embodiments, the one or more speaker(s) positioned on the wearable system on a first side of a sagittal plane of the wearer and the one or more microphone(s) positioned on a second side of a sagittal plane of the wearer.

In some embodiments, a path is formed between each of the one or more speaker(s) and each of the one or more microphone(s) such that each of the one or more microphone(s) is configured to receive a reflected signal from each of the one or more speaker(s). As an additional example, each formed path traverses one or more of one or more of a buccal region, an infraorbital region, an oral region, or a mental region of the wearer's face.

In some embodiments, the image data comprises the at least one transmitted signal and the at least one reflected signal.

In some embodiments, generating the profile comprises: filtering the at least one transmitted signal and the at least one reflected signal; and calculating a cross-correlation between the at least one filtered transmitted signal and the at least one filtered reflected signal.

In some embodiments, filtering the at least one transmitted signal and the at least one reflected signal comprises removing data outside of a target frequency range. As additional examples, the target frequency range is 17.5 kHz to 25 kHz, including all 0.1 kHz values and ranges therebetween.

In some embodiments, the assigned deformation is associated with a shape of the wearer's mouth and/or a deformation of skin in one or more of a buccal region, an infraorbital region, an oral region, or a mental region of the wearer's face.

In some embodiments, the communicated text output comprises a text representation of silent utterances of the wearer.

In some embodiments, the profile is an echo profile.

In some embodiments, comparing the profile to the model comprises: generating a second profile based on the image data; generating a differential profile based on the profile and the second profile; and comparing the differential profile to the model. As additional examples, the profile is an echo profile and the differential profile is a differential echo profile.

In some embodiments, the at least one imaging sensor is positioned on the wearable system to capture image data of a shape of the wearer's mouth and/or a deformation of skin in one or more of a buccal region, an infraorbital region, an oral region, or a mental region of the wearer's face.

In some embodiments, the model is trained using machine learning or the like. As an additional example, the training comprises receiving one or more facial image(s) of a subject, each of the facial images corresponding to a silent utterance of a plurality of silent utterances of the subject; receiving one or more image(s) of the subject from the at least one imaging sensor, each of the images from the at least one imaging sensor also corresponding to a silent utterance of the plurality of silent utterances of the subject; and correlating, for each of the silent utterances, the one or more image(s) from the at least one imaging sensor corresponding to a particular silent utterance to the one or more facial image(s) corresponding to the particular silent utterance.

In some embodiments, the one or more facial image(s) are associated with a shape of the wearer's mouth and/or a deformation of skin in one or more of a buccal region, an infraorbital region, an oral region, or a mental region of the wearer's face captured during silent utterances.

In some embodiments, the at least one imaging sensor comprises a first imaging sensor and a second imaging sensor, with the first imaging sensor positioned on the wearable system to capture first image data of a first facial feature of the wearer, and the second imaging sensor positioned on the wearable system to capture second image data of a second facial feature of the wearer, wherein comparing the profile to the model comprises comparing a first profile associated with the first image data of the first facial feature of the wearer to the model and comparing a second profile associated with the second image data of the second facial feature of the wearer to the model, wherein assigning a deformation to the profile comprises assigning a first deformation to the first profile and a second deformation to the second profile, and wherein the text output being based on the assigned first deformation and the assigned second deformation.

In some embodiments, the first imaging sensor and the second imaging sensor are configured to transmit acoustic signals within different frequency ranges. As additional examples, the first imaging sensor is configured to transmit acoustic signals in a frequency range of 18-21 kHz and the second imaging sensor is configured to transmit acoustic signals in a frequency range of 21.5-24.5 kHz.

In some embodiments, the first imaging sensor comprises one or more first speaker(s) and one or more first microphone(s), and the second imaging sensor comprises one or more second speaker(s) and one or more second microphone(s), wherein the one or more first speaker(s) and the one or more second speaker(s) are positioned on the wearable system on a first side of a sagittal plane of the wearer, and the one or more first microphone(s) and the one or more second microphone(s) are positioned on a second side of a sagittal plane of the wearer.

In some embodiments, the wearable system comprises glasses, smart glasses, goggles, spectacles, or another head-borne device to which the at least one imaging sensor is attached.

In some embodiments, the physical memory comprises further instructions that when executed by the processor cause the processor to: compare the assigned deformation to a second model; and assign the text output based on the assigned deformation, the assigned text output having a predetermined degree of correspondence to a selected one of a plurality of deformations in the second model when compared to the assigned deformation.

In some embodiments, the second model is trained using machine learning or the like. As additional examples, the training comprises receiving one or more facial image(s) of a subject, each of the facial images corresponding to a silent utterance of a plurality of silent utterances of the subject; receiving one or more image(s) of the subject from the at least one imaging sensor, each of the images from the at least one imaging sensor also corresponding to a silent utterance of the plurality of silent utterances of the subject; and correlating, for each of the silent utterances, the one or more image(s) from the at least one imaging sensor corresponding to a particular silent utterance to the one or more facial image(s) corresponding to the particular silent utterance.

In some embodiments, the wearable system comprises a computing device that receives and displays and/or vocalizes the communicated text output representing silent utterances of the wearer.

In some embodiments, the physical memory comprises further instructions that when executed by the processor cause the processor to: receive a second set of image data from each of the at least one imaging sensor; generate a second profile based on the second set of image data from each of the at least one imaging sensor; compare the second profile to the model; assign a second deformation to the second profile, the assigned second deformation having a predetermined degree of correspondence to a selected one of the plurality of deformations in the model when compared to the second profile; and communicate a second text output based on the assigned second deformation.

In some embodiments, the wearable system further comprises a computing device that receives and displays and/or vocalizes the communicated text output and the communicated second text output, wherein the communicated text output and the communicated second text output are silent utterances of the wearer, and the communicated second text output is displayed subsequent to the communicated text output to depict continuous utterances of words and/or phrases.

Another illustrative embodiment provides a method to determine a text output using a wearable system, comprising: positioning a first imaging sensor of a wearable system to image a first facial feature of a wearer; imaging the first facial feature of the wearer using the first imaging sensor; comparing, via a processor, the imaged first facial feature to a first model; and assigning, via the processor, a text output corresponding to the imaged first facial feature selected from one of a plurality of text outputs in the first model.

In some embodiments, the act of positioning the first imaging sensor of the wearable system comprises positioning the first imaging sensor facing inward to include a field of view of the wearer's mouth and/or one or more of a buccal region, an infraorbital region, an oral region, or a mental region of the wearer's face.

Another illustrative embodiment provides a method to determine a text output using a wearable system, comprising: positioning a first imaging sensor of a wearable system to image a first facial feature of a wearer; positioning a second imaging sensor of the wearable system to image a second facial feature of the wearer; imaging the first facial feature of the wearer using the first imaging sensor; imaging the second facial feature of the wearer using the second imaging sensor; comparing, via a processor, the imaged first facial feature and the imaged second facial feature to a model; and assigning, via the processor, a text output selected from one of a plurality of text outputs in the model corresponding to the imaged first facial feature and the imaged second facial feature.

### Additional Illustrative Embodiments

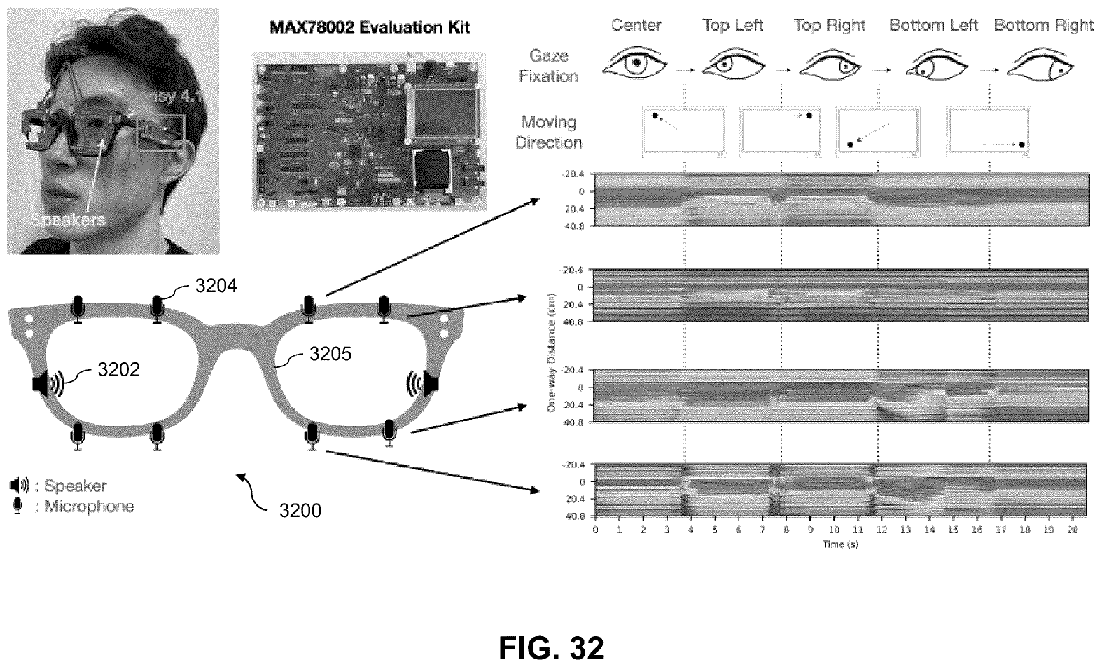

Additional illustrative embodiments will be described below with reference to FIGS. 32 through 41. These include additional embodiments relating to acoustic-based eye tracking, and additional embodiments relating to acoustic-based silent speech recognition.

### Additional Embodiments Relating to Acoustic-Based Eye Tracking

Illustrative embodiments relating to acoustic-based eye tracking will now be described in more detail with reference to FIGS. 32 to 35.

The acoustic-based eye tracking in some embodiments is implemented as an acoustic-based eye tracking system referred to herein as GazeTrak. GazeTrak is an acoustic-based eye tracking system on glasses, illustratively comprising one speaker and four microphones attached to each side of the glasses. These example acoustic sensors capture the formations of the eyeballs and the surrounding areas of a user wearing the glasses by emitting encoded inaudible sound towards the eyeballs and receiving the reflected signals. These reflected signals are further processed to calculate echo profiles, which are fed to a customized deep learning pipeline to continuously infer the gaze position. In a user study with 20 participants, GazeTrak achieves an accuracy of 3.6° within the same remounting session and 4.9° across different sessions with a refreshing rate of 83.3 Hz and a power signature of 287.9 mW. Furthermore, we describe the performance of the Gaze Trak system fully implemented on an MCU with a low-power CNN accelerator, illustratively a MAX78002. In this configuration, the system runs at a frames per second (FPS) rate of up to 83.3 Hz and has a total power signature of 95.4 mW with a 30 Hz FPS.

Some conventional eye tracking technologies utilize cameras to capture gaze points. However, camera-based eye tracking solutions are known to have a relatively high power signature, which may not work well for smart glasses with a relatively small battery capacity. For instance, Tobii Pro Glass 3, which is considered one of the best eye tracking glasses, can only last for 1.75 hours with an extended battery capacity of 3400 mAh. When using the battery of a Google Glass (570 mAh), this eye tracking system can only last 18 minutes. The limited tracking time has hindered its ability to collect gaze point data in everyday life, which can be highly informative for many applications, such as, monitoring users' mental or physical health conditions, gaze-based input, and attention and interest analysis.

Illustrative embodiments disclosed herein overcome these and other drawbacks of conventional systems such as the above-noted Tobii Pro Glass 3. For example, GazeTrak utilizes acoustic sensing to continuously track gaze points using an acoustic sensing system mounted on the frame of a pair of eyeglasses, also referred to herein as a “glass frame,” in a relatively low power, lightweight, and affordable manner. Its sensing principle is based on the fact that eyeballs are not perfectly spherical and rotating them would expose different shapes and stretch the skin around them with unique formations. This can provide highly valuable information for inferring gaze points. As indicated above, GazeTrak uses one speaker and four microphones arranged on each side of the glass frame. The speaker emits frequency-modulated continuous-wave (FMCW) acoustic signals with the frequency above 18 kHz towards the eyeballs. The microphones capture the signals reflected by the eyeballs and their surrounding areas, which are used to process and calculate the echo profiles. These echo profiles are fed to a customized deep learning algorithm based on ResNet-18 to predict the gaze point.

We conducted two rounds of user studies to evaluate the performance of Gaze Trak. During the studies, each participant was asked to look at and follow the instruction points on the screen. In the first round of the study, 12 participants evaluated a first example implementation, in which the microphones and speakers were glued on a glass frame. The average cross-session tracking accuracy was 4.9°. It confirmed the optimal settings of the sensing system. A further example implementation was also developed, and will be described in more detail below.

FIG. 32 shows the further example implementation of the GazeTrak system, and illustrates echo profiles of different microphones when moving gaze to different regions of the screen. This example implementation as illustrated in the figure features a more compact form factor, significantly lowers signal strength, and improves environmental sustainability as it can be attached to different glasses.

As illustrated in FIG. 32, an example wearable 3200 of the GazeTrak system having a compact form factor comprises multiple instances of a speaker 3202 and multiple instances of a microphone 3204, arranged as shown in respective different positions on a glass frame 3205. More particularly, in this example embodiment, a single instance of speaker 3202 and four instances of microphone 3204 are deployed on each of respective right and left sides of the glass frame 3205. Also shown in the figure is an example view of a user wearing an implementation of the GazeTrak system, as well as an example MAX78002 evaluation kit and an illustration of the manner in which different eye fixations and movements are correlated with different patterns in echo profiles in illustrative embodiments.

To ensure consistent performance between the two example implementations, we conducted a second round of study with 10 participants, including some new participants, evaluating the second example implementation. The second example implementation achieved an average tracking accuracy of 4.9° for cross-session scenarios and 3.6° for in-session scenarios with a refreshing rate of 83.3 Hz.

Although the current accuracy of the GazeTrak system is less than that of commercial eye trackers such as Tobii Pro Glasses 3 and Pupil Labs Glasses, it is still comparable to some webcam-based eye tracking systems. Furthermore, due to the low-power feature of acoustic sensors, GazeTrak, including the data collection system, has a relatively low power signature of 287.9 mW. Compared to camera-based wearable eye tracking systems, this example eye tracking system reduces the power consumption by over 95%. If using a battery with the capacity similar to Tobii Pro Glasses 3, the GazeTrak system can extend the usage time from 1.75 hours to 38.5 hours. It can even last 6.4 hours on the battery of normal smart glasses, such as Google Glass. The power signature of the GazeTrak system can be further improved using an example microcontroller with a low-power CNN accelerator, illustratively the MAX78002, which is an example of what is more generally referred to herein as a microcontroller unit or MCU, or a microcontroller module. Hence, we implement the gaze tracking pipeline fully on MAX78002. With the refresh rate set as 30 Hz, the power consumption of the whole system including the data preprocessing and model inference is measured as 95.4 mW. The performance of the system remained robust under different noisy environments and with different styles of glass frames.

Illustrative embodiments also provide significant additional advantages relative to conventional webcam-based eye tracking platforms. For example, the positions of webcams are usually fixed and they have a relatively low resolution. Therefore, their performance can be more easily impacted by factors like lighting conditions, occlusions, camera orientations, etc. Also, frontal camera-based eye tracking systems such as Tobii Pro Fusion are mostly located at fixed positions and do not work well while users move to another position or are walking around. Other approaches utilize cameras on mobile phones or tablets to track eye movements. However, these eye tracking technologies based on mobile devices still require users to hold the mobile devices in front of their face all the time and cannot provide completely hands-free and motion-free experiences for users.

Despite acceptable tracking performance, current solutions to wearable eye tracking systems still have some limitations. For example, many existing eye tracking systems can only recognize discrete gestures, limiting their performance in applications that need continuous tracking of the eyes. Camera-based wearable eye trackers can provide high accuracy in continuous eye tracking, but cameras are usually power-hungry, which makes them relatively impractical while deployed in wearables that need to be worn in everyday settings. Also, changing lighting conditions can still be a problem for these camera-based systems, as the performance typically becomes worse in an outdoor setting. Besides, commercial eye trackers are usually expensive and do not provide open-source software for users, preventing them from being easily accessed and adapted by general users. Other known approaches can be adversely impacted by direct sunlight and glasses movement, e.g., the remounting of the glasses.

The GazeTrak system as disclosed in illustrative embodiments herein addresses these and other drawbacks of conventional approaches by providing a wearable sensing technology based on active acoustic sensing that can track gaze points continuously.

As indicated above, active acoustic sensing in GazeTrak is illustratively based on affordable sensors (e.g., speakers and microphones), the sizes of which are relatively small. Other embodiments disclosed herein have illustrated that acoustic sensing utilizing such components is able to provide enough information to track subtle skin deformations such as facial expressions. Additional details relating to the utilization of acoustic sensing for eye tracking will now be described.

In order to capture the formation around eyeballs, we use FMCW-based acoustic sensing, which has been widely proven effective to estimate distance and movements from complex environments.

While customizing the FMCW signals for the system, three main features are taken into account: 1) Operating frequency range: The device is expected to be worn by users for a long period of time in their everyday lives. As a result, the FMCW signals need to be transmitted in the inaudible frequency range. Besides, to ensure the encoded signals are minimally impacted by the noise in the environment, the operating frequency range we pick should also be uncommon in daily settings; 2) Sampling rate: To achieve a reasonable spatial and temporal resolution of tracking eye movements, the sampling rate of FMCW signals must be high enough; 3) Gain: As power signature increases with the signal gain, the signal gain should be properly determined to balance signal strength and power consumption.

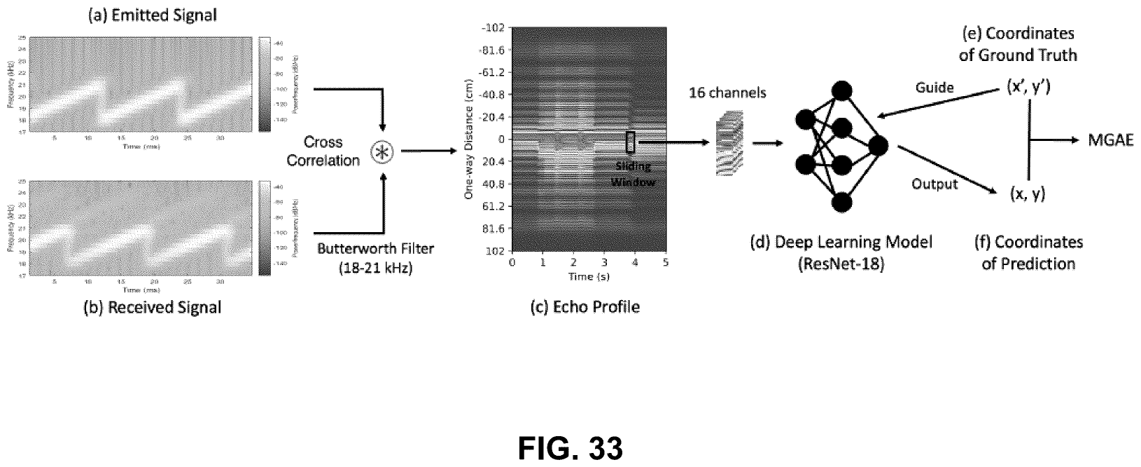

FIG. 33 shows an overview of the operation of the GazeTrak system, using the speaker on the right side (18-21 kHz) for illustration, and includes parts (a) through (f). Part (a) shows the emitted signal, part (b) shows the corresponding received signal, part (c) shows an example echo profile generated by cross-correlation of the emitted and received signals, part (d) shows the deep learning model, which is illustratively based on a ResNet-18 network, part (c) shows coordinates of ground truth, and part (f) shows coordinates of prediction.

Considering the factors described above, we set the operating frequency range of the FMCW signals that are emitted in the GazeTrak system above 18 kHz, because this range is nearinaudible and uncommon in the sounds generated by normal human activities. Because both eyes contain information while moving, we placed one speaker on each side of the glass frame. We set the speaker on the right side to operate at 18-21 kHz while the one on the left side operates at 21.5-24.5 kHz to make sure they do not interfere with each other. To guarantee that the system works reliably in these frequency ranges, we set the ADC sampling rate as 50 kHz with the frame length of FMCW signals as 600 samples. This gives the system a refresh rate of eye tracking at 83.3 Hz (50000 samples/s÷600 samples). We believe a refresh rate of 83.3 Hz is sufficient to provide continuous gaze tracking since the frame rate of most videos are 30 Hz or 60 Hz. Lastly, the gain was experimentally adjusted to make sure that the signal does not saturate the microphones while the power consumption is relatively low.

After receiving the reflected FMCW signals, we first apply a Butterworth band-pass filter with a cut-off frequency range of 18-21 kHz or 21.5-24.5 kHz on the signal to remove the signals in the frequency range that we are not interested in. It also helps protect the privacy of users because we remove the audible range of the signals. Then we further process the filtered signal to obtain unique acoustic patterns. As illustrated in parts (a) to (c) of FIG. 33, an echo profile is obtained by continuously calculating the cross-correlation between the received signals and transmitted signals. As indicated previously, FIG. 32 illustrates that different eye fixations and movements are correlated with different patterns in echo profiles. As described herein, the GazeTrak system utilizing FMCW-based active acoustic sensing to track eye movements continuously with high accuracy.

A professional eye-tracker (e.g., Tobii Pro Fusion) can provide highly accurate ground truth, but it is expensive. If an acoustics-based eye tracking system as disclosed herein were to require a professional eye-tracker to train the system, it would make the eye tracking system less accessible.

Therefore, we developed a new ground truth acquisition and calibration system that only needs a program running on a laptop. The program generates instruction points on the screen as the ground truth. During data collection, the users only need to look at and follow the movements of the instruction points. These ground truth data along with the echo profiles are fed into the machine learning model for training. This method is generally applicable on any device with a screen. Additional details regarding how the instruction points are generated can be found elsewhere herein. To better compare the system with commercial eye trackers, we also use a Tobii Pro Fusion (120 Hz) to record the eye movements to demonstrate the effectiveness of the training methods disclosed herein.

We developed a customized deep-learning pipeline to learn the echo profiles calculated on the received signals. Because in the echo profiles, the temporal information has been converted to the spatial information on an image, we use ResNet18 as the encoder of the deep learning model because CNN networks are known to be good at extracting features from images. Then a fully-connected network is used as a decoder to predict gaze positions based on the features extracted from the images.

Because of the limited distance between the sensors on the glasses and the eyes, we are typically only interested in a certain range of the echo profiles. As a result, we crop the echo profiles of each channel to get the center 70 pixels (23.8 cm) vertically. Then we randomly select 60 consecutive pixels (20.4 cm) out of these 70 pixels for data augmentation purposes to make sure the system will not be severely impacted by the vertical shifting caused by remounting the device. To continuously track the gaze positions, we apply a sliding window of 0.3 seconds on the echo profiles. As a result, the dimension of the echo profile that we input into the deep learning model for one channel is 26 (0.3 s×50000 Hz÷600 samples+1)×60 (pixels). Because we use 2 speakers and 8 microphones in the system, we crop out the same dimension of echo profiles for all 2×8=16 channels, making the dimension of the input vector to the deep learning model as 26×60×16.

We use the instruction points as the labels and the mean squared error (MSE) as the loss function. We utilize an Adam optimizer and set the learning rate as 0.01. The model is trained for 30 epochs to get the estimation of the two gaze coordinates (x, y).

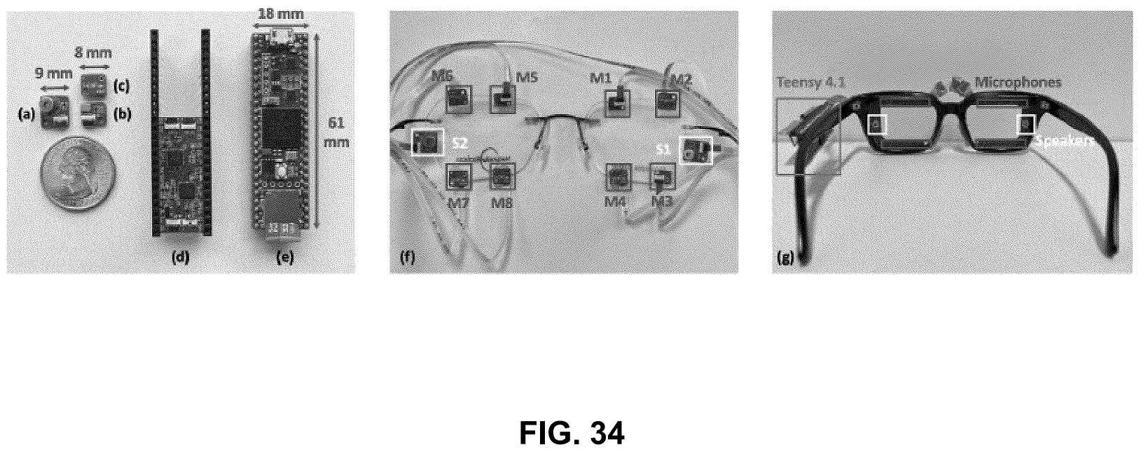

FIG. 34 shows example hardware and form factors for GazeTrak, and includes parts (a) through (g). Part (a) shows the speaker board, part (b) shows the microphone board (front view), part (c) shows the microphone board (back view), part (d) shows the customized PCB board for the audio chip NXP SGTL5000, part (e) shows the Teensy 4.1 microcontroller module, part (f) shows an example glasses form factor with speakers and microphones attached (M1-8: microphones, S1-2: speakers), and part (g) shows the attachable and more compact example implementation.

The prediction of this example system is the coordinate (x, y) of the estimated gaze position on the screen in pixels. To evaluate the accuracy of GazeTrak, we adopted the accuracy defined in COGAIN eye tracker accuracy terms and definitions. The evaluation metric we use in the GazeTrak system is the mean gaze angular error (MGAE) between the coordinate of the prediction (x, y) and that of the ground truth (x′, y′). To calculate MGAE in degrees from the coordinates, we first obtain the angular error θ between the prediction and the ground truth of each data point, where θ can be calculated using the law of cosines in a triangle as follows:

$$θ = arccos ( \frac{{d}_{eg}^{2} + {d}_{ep}^{2} - {d}_{gp}^{2}}{2 \times {d}_{eg} \times {d}_{ep}} ) \times 180 \div π \qquad ( 1 )$$

and where d_{eg}, dₑₚ and d_{gp} are the distance between user's eyes and ground truth, the distance between user's eyes and prediction, and the distance between ground truth and prediction, respectively. MGAE is obtained by averaging 0 over all the data points in the testing dataset.

In order to implement the FMCW-based active acoustic sensing technique described above, we utilize Teensy 4.1 as the microcontroller to provide reliable FMCW signal generation and receiving in multiple channels. We designed a PCB board to support two SGTL5000 chips which are the same as the one on the Teensy audio shield. With this customized PCB board plugged onto Teensy, it can support as many as 8 microphones and 2 speakers. The speaker is implemented as Part No. OWR-05049T-38D and the MEMS microphone is implemented as Part No. ICS-43434, to support signal transmission and reception. We also built customized PCB boards for the speaker and the microphone to make them as small as possible. We used the Inter-IC Sound (I2S) buses on the Teensy 4.1 to transmit data between the Teensy 4.1 and the SGTL5000 chips, speakers and microphones. The collected data is stored in the SD card on Teensy 4.1.

We designed the first form factor using a commodity glass frame. We glued 1 speaker and 4 microphones to each inner side of a pair of light-weight glasses. The speakers and microphones are symmetrically placed on the glasses, as shown in part (f) of FIG. 34.

A number of key factors were taken into consideration while designing the final form factor of GazeTrak, including: 1) Type of glass frame: We started designing the form factor with a large glass frame because we believe it has more room for us to place sensors. However, the larger the glass frame is, the easier it will be for the frame to touch the skin, blocking the signal transmission and reception. As a result, we finally picked a relatively small glass frame with a nose pad that can support the glass frame to a higher position. Besides, the light-weight glasses minimize the pressure on the user's nose, making it more comfortable to wear; 2) Sensor position: The speakers and microphones on two sides are symmetric because we believe the movements of two eyes are usually synchronized. On each side, we place the speaker on the frame of the glasses next to the outer canthi because it is easier for the speakers to touch the skin if they are placed above the cheekbones or next to the eyebrows, considering their height. The microphones are arranged on the frame as far away from each other as possible to capture more information by receiving signals travelling in different paths. The sensors are attached as far away from the center of the lenses as possible in order to avoid blocking the view of the user; 3) Stability: We found that the stability of the device severely impacts the performance of the system especially when users need to remount the device frequently. The anti-slip nose pad prevents the glasses from sliding down the user's nose. Furthermore, we added two car loops at the end of the legs of the glass frame. They greatly help to fix the glasses position from behind the ears and improve the performance of the system. The final example form factor is shown in part (f) of FIG. 34.

This example form factor provides a more compact and less obtrusive form factor that is suitable for everyday use by users. To achieve this, we have designed two PCB boards, each containing one speaker and four microphones onboard, which can be attached to one side of the glasses. We have also deployed the Teensy 4.1 and the PCB board with SGTL5000 chips directly onto one leg of the glasses. To connect the microcontroller and the customized PCB boards, we have used flexible printed circuit (FPC) cables. The system has an interface that allows it to be powered by a Li—Po battery. As indicated previously, the compact form factor is shown in FIG. 34 (g), and FIG. 32 shows a user wearing the glasses. This compact form factor can be easily adapted and attached to different types of glasses.

The example form factor has a total weight of 44.2 grams, including the glasses, Teensy 4.1, PCB boards, and the Li—Po battery. Compared to camera-based eye tracking glasses, Gaze Trak device is much lighter. For example, Tobii Pro Glasses 3 weigh 76.5 grams for the glasses and 312 grams for the recording unit. The GazeTrak system therefore has a significant advantage over camera-based eye tracking glasses in terms of weight.

A user study was conducted to validate the performance of GazeTrak on continuously tracking gaze points. As part of this user study, we carefully designed the instruction video for participants' gaze to follow. Basically, on the white screen, there would be one red dot moving around and we asked participants to stare at the point and follow it with their eyes. We divided the screen into 100 regions. For each data point, the instruction point appeared at a random position within one random region. The instruction point would move quickly to that random position and stay static at that position for a certain period of time because we mainly would like to test how GazeTrak performs to track the fixation of participants.

We recruited 20 participants (10 females and 10 males, 22 years old on average). Note that some participants participated in the study multiple times to test different settings. The study was conducted in an experiment room on a university campus. During the study, each of the participants sat on a chair and put on the glasses form factor with the GazeTrak system. For each participant, we produced 12 sessions of instruction points. During the interval between sessions, participants were instructed to remove the device, place it on the table, and then put it back on. This step was taken to demonstrate that the system continued to function correctly even after the device was remounted. In each session, the instruction point moved to all the 100 pre-defined regions in a random order. The duration for which the instruction point remained at each position varied from 0.5 to 3.5 seconds, with an average of 2 seconds. As a result, the average length of each instruction session was 200 seconds. Before each session, there was a 15-second calibration process with the instruction point moving to the four corners of the screen and the center of the screen.

The full study took no more than 1.5 hours for each participant, during which we collected approximately 40 minutes of data (200 seconds×12 sessions). Upon completing the study tasks, the participant was asked to complete a questionnaire to collect their demographic information and their feedback using this system.

We first evaluated the performance of GazeTrak with the above-noted first example implementation, corresponding to the form factor shown in part (f) of FIG. 34, comparing different ground truth acquisition methods, sensor configurations and amounts of training data. Then we tested the system under noisy environments and on glasses of various frame styles. Finally, we optimized the system for the second example implementation, corresponding to the more compact form factor shown in part (g) of FIG. 34, and evaluated it with a further study in which power consumption was also measured.

The first example implementation of part (f) of FIG. 34 was first tested with 12 participants. A user-dependent model was applied to train a separate model for each participant. Among 12 sessions we collected for each participant, we conducted a 6-fold cross validation to test the tracking performance of the system by using 10 sessions (33.3 minutes) of data for training and 2 sessions (6.7 minutes) of data for testing. Using the evaluation metrics defined above, we calculated the MGAE in degrees for all participants, and the result we obtained was 5.9°. To further improve the performance, we adopted the 15-second calibration data before each session to fine-tune the model, which resulted in an improved performance of 4.9°. It is worth mentioning that a similar calibration process is also required for commodity eye trackers (e.g., Tobii Pro). The distance between the participants' eyes and the screen center is measured to be around 60 cm so we have a field of view of 60° (the largest possible angular error) in this study.

Next, we aimed to compare the impact on gaze tracking performance of using different ground truth acquisition methods: a commodity eye tracker (Tobii Pro Fusion) versus the method disclosed herein (e.g., using instruction points on the screen). We used the eye tracking data recorded by Tobii Pro Fusion as the ground truth to train the model, and the MGAE after finetuning was 4.9°. We conducted a repeated measures t-test between the results using Tobii data as the ground truth and those using instruction points as the ground truth for all 12 participants, and did not find a statistically significant difference (p=0.92>0.05). This suggests that using instruction points on a screen monitor as the ground truth can be as effective as using Tobii data.

Apart from that, we also recorded the eye tracking accuracy of Tobii Pro Fusion itself which was reported after the calibration process of the Tobii platform. The results showed that Tobii Pro Fusion can track the gaze points with an average accuracy of 1.9° during the calibration process for all participants.

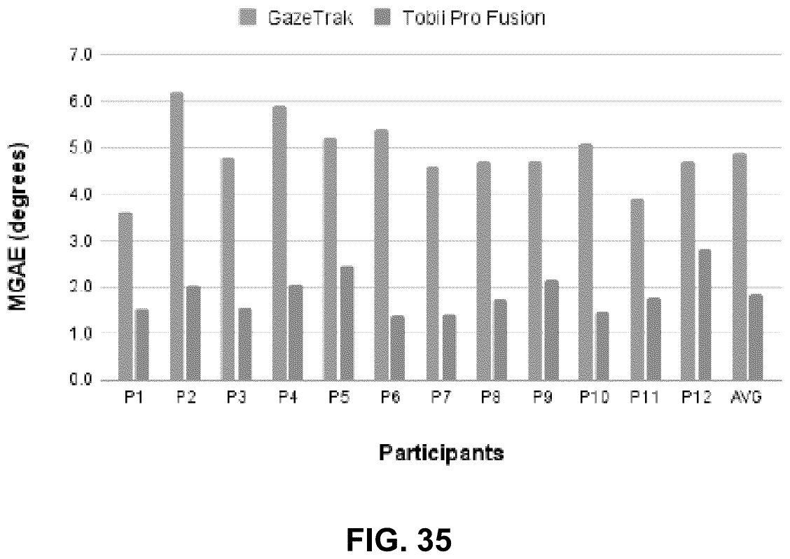

FIG. 35 shows the resulting tracking performance of both GazeTrak and Tobii for all participants.

As will now be described, we evaluated the impact of the number and placement of microphones on tracking performance to determine the optimal sensor position for the best results. We assessed four different settings: 1) one microphone on each side (left and right); 2) two microphones on each side; 3) three microphones on each side and 4) all four microphones on each side. In the first setting, we compared the performance using data from four sets of microphone settings (M1+M5, M2+M6, M3+M7, and M4+M8 in FIG. 34 (f)), which is presented in Table 1.

TABLE 1
Study Results for Different Mic Configurations.

| | Mic Config. | | | | | | |
|---|---|---|---|---|---|---|---|
| | | | | | Best 4 Mics | Best 6 Mics | All 8 |
| | M1 + M5 | M2 + M6 | M3 + M7 | M4 + M8 | (M2, 4, 6, 8) | (M1, 2, 4, 5, 6, 8) | Mics |
| MGAE | 7.7° | 7.2° | 8.5° | 6.9° | 5.9° | 5.5° | 4.9° |

The findings demonstrate that the M4+M8 pair of microphones provides the best tracking performance among the four pairs tested. We conducted a one-way repeated measures ANOVA test on the results of the four settings and identified a statistically significant difference (F(3,44)=6.74, p=0.001<0.05). These results indicate that microphone placement can affect gaze tracking performance, possibly due to differences in signal reflection before arriving at different microphones.

We conducted further experiments to evaluate performance using different combinations of microphones under settings 2 and 3. The results showed that the best performance was 5.9 degrees and 5.5 degrees, respectively. We also ran a one-way repeated measures ANOVA test among the results of these four settings using data from 12 participants. The results showed a statistically significant difference (F(3,44)=51.61, p=0.00001<0.05). These findings suggest that the example system with four microphones on each side (eight microphones in total) achieves the best performance.

Blinking can introduce noise in the highly-sensitive acoustic sensing system as it can lead to relatively large movements around the eye. We conducted an evaluation to determine whether blinking affects the tracking performance of the GazeTrak system. For this evaluation, we selected data from three participants with the best, worst, and average tracking performance (P1, P2, P10). We removed the data where the participant blinks (about 10% of total data) based on the ground truth data obtained from Tobii Eye Tracker. We then used the processed data to retrain the user-dependent model for each participant. The results showed that the performance did not improve after removing the blinking data. One possible reason for this is that the blinking patterns are consistent and can be learned by the machine learning model. Therefore, the findings suggest that blinking does not significantly impact the performance of the GazeTrak system.

To reduce the amount of training data for a new user, we employed a three-step process to train a user-adaptive model. First, we trained a large base model using data from all participants except the one being tested. Second, we fine-tuned the model using the training data collected from the current participant. Notably, the user only needs to provide training data once during the initial system use. Finally, at the beginning of each session, we further fine-tuned the model using calibration data collected from the participant before testing or using the system. To determine the amount of data required to achieve competitive tracking performance, we reserved two sessions of data for testing and used varying amounts of training data from the participant to fine-tune the large model.

The results show that a new user only needs to provide six sessions of training data (approximately 20 minutes) to achieve good performance. Collecting more data does not necessarily result in better performance. Additionally, with only two or three sessions of data (approximately 6 minutes), the system can achieve a performance of 6.7° and 6.1°, respectively. If no user data is collected, the performance is 11.3°. This is likely because different people have unique head, face, and eye shapes. Therefore, to further reduce the amount of training data required from each new user, we may need to collect a significantly larger amount of training data from a more diverse set of participants.

To ensure that the acoustic sensing system is resistant to different types of environmental noise, we conducted two experiments as described below.

In the first experiment, we recorded noises in different environments using the microphones on the glass frame. We then overlaid the noise onto the data collected in the user study to simulate different noisy environments. We recorded the noise in four different environments and measured the average noise levels using a sound level meter app called NIOSH provided by CDC: 1) street noise (70.8 dB(A)) recorded on the street near a crossroad; 2) music noise (64.5 dB(A)) recorded while playing music on a computer; 3) cafe noise (54.5 dB(A)) recorded in a cafe; driving noise (65.6 dB(A)) recorded while driving a vehicle. After overlaying each of these four noises, the tracking performance remained unchanged for every participant.

In the second experiment, we invited eight participants from the previous user study and recruited two new participants (P13 and P14) to test the GazeTrak device in different real-world noisy environments. Since this study required us to move to different environments, the study design differed slightly from the previously-described study.

In this study, we used an Apple MacBook Pro with a 13.3 inch display to play the instruction videos. We used the instruction points as the ground truth. The MacBook Pro was placed on a movable table, and participants were instructed to sit in front of the table to conduct the study. Additionally, it was found that 6 sessions of training data are sufficient to provide acceptable tracking performance. Therefore, for each participant, we collected a total of 8 sessions of data in a quiet experiment room, with 6 sessions for training and 2 sessions for testing. We then collected additional testing data under two different noisy environments. In the first environment, participants used the system while we played random music for 2 sessions. In the second environment, we collected 2 sessions of testing data at a campus cafe where staff and people were talking during business hours. The noise levels under each environment were measured using the CDC NIOSH app: 1) quiet room (33.8 dB(A)); 2) play music (64.0 dB(A)); 3) in the cafe (56.6 dB(A)). This study design led to a total of 12 sessions of data collection for each participant, which is the same as the previous study.

We trained a personalized model for each participant using 6 sessions of data collected in the quiet room. Then, the 2 testing sessions collected in each scenario were used to test the performance of the system in different environments. The average gaze tracking performance of the system across 10 participants remained satisfactory at 3.8° and 4.8° under two noisy environments, playing music and in the cafe, while the performance in the quiet room was 4.6°. Overall, the average accuracy of gaze tracking did not change significantly with the presence of noise in the environment. We conducted a one-way repeated measures ANOVA test among the results of these three scenarios for all 10 participants and did not find a statistically significant difference (F(2,27)=2.46, p=0.11>0.05). This again validates that the GazeTrak system is not easily affected by environmental noise.

In the initial user study, we tested the system on a particular glass frame, denoted F1, with a configuration as shown in part (f) of FIG. 34. However, the GazeTrak system can be easily applied to glasses with different frame styles. In order to validate this, we deployed the system on two other pairs of glasses. The original glass frame (F1) is frameless and relatively lightweight. In this study, we applied the system on two new glasses with different styles, size and weight. The first new glass frame (small glasses, F2) is of a smaller size than F1 but with a larger weight due to the frame around the lens. The second new glass frame (large glasses, F3) with a frame around lens has a much larger size and weight compared to F1 and F2. To evaluate the system on these new glass frames, three participants from the original study (P1, P5 and P7) agreed to participate in this additional study. The study setups and procedures were exactly the same as the previous study described above.

We collected 12 sessions of data for each participant testing each glass frame. Since, as indicated previously, 6 sessions of training data were found to be sufficient, we discarded the first 4 sessions for each glass frame and used the last 8 sessions to run a 4-fold cross validation in order to test the tracking performance of the system on different glasses. In this case, we can make sure that participants are familiar with the wearing of all the glass frames and eliminate the impact of some random factors. The evaluation result shows that the small glasses (F2) yielded a similar average performance to the original glasses (F1) (both at 5.3°), while the large glasses (F3) resulted in a relatively poorer average performance (at 6.1°), with a drop in performance of 15%. One possible reason for the performance difference is that the sensors on the larger glasses were much closer to the skin. Sometimes, the sensors may directly touch the skin, which could block the transmission and reception of signals, as indicated previously.

In the previous user studies, we evaluated GazeTrak with various configurations under different scenarios, using the first example implementation as illustrated in part (f) of FIG. 34. The results of these studies helped us confirm the various settings and configuration and to develop the second example implementation, which features the more compact form factor as shown in part (g) of FIG. 34. A further study was conducted to assess the performance and power consumption of this second example implementation.

In evaluate the second example implementation, we recruited 10 participants (four of whom participated in the previous study). The study design was similar to the previous study, except that we only used instruction points as the ground truth acquisition method. Each participant collected eight sessions of data (six sessions for training and two for testing). We reduced the signal strength from the speaker to 20% of the original setup, as we found that even with 2% of the original strength, the performance was similar in the previous study. Hence, the second example implementation has significantly lower signal strength and improved environmental sustainability. Additionally, we set the central processing unit (CPU) speed of the Teensy 4.1 to 150 MHz in this study (standard speed: 600 MHz) to lower power consumption. With this setting, the system experienced a data loss rate of 0.002%, and the performance of the system was not affected by this loss, as shown in Table 2. Apart from the cross-session performance, we also conducted a test of the in-session tracking accuracy in which the training data and testing data were split from the same sessions without remounting the device to show the optimal performance of the GazeTrak system.

TABLE 2
Gaze Tracking Performance in MGAE with the Final Prototype.

| Settings | P1 | P2 | P7 | P10 | P15 | P16 | P17 | P18 | P19 | P20 | Avg |
|---|---|---|---|---|---|---|---|---|---|---|---|
| Cross- | 4.4° | 4.9° | 5.9° | 8.0° | 3.6° | 3.6° | 3.9° | 4.8° | 4.7° | 5.7° | 4.9° |
| session | | | | | | | | | | | |
| In- | 3.9° | 3.6° | 4.9° | 5.3° | 1.8° | 2.6° | 2.6° | 3.6° | 3.1° | 4.9° | 3.6° |
| session | | | | | | | | | | | |

As shown in Table 2, the MGAE is 4.9° for the cross-session evaluation, which is similar to the previous study. When evaluating the performance of GazeTrak within the same sessions, the accuracy improves to 3.6°. We did not add ear loops to this second example implementation because the legs of the glasses were wider than the ear loops we had. For most participants, the glasses fit well on their ears, but one participant (P10) reported that the glasses kept sliding down during the study, which may have affected their performance. Based on the questionnaires, no participant reported being able to hear the signal emitted from the system. We also measured the signal level from the system using the NIOSH app. We placed the phone running the app close enough to the speakers in the system and the app gave us an average signal level of 43.1 dB(A). This is below the maximum allowable daily noise recommended by CDC, which is 85 dB(A) over eight hours in the workspace.

We measured the power consumption of the system with a current ranger. The average current flowing through the system was measured as 88.3 mA@3.26 V, which gives us a power consumption of 287.9 mW. This value was tested with all 8 microphones and 2 speakers working, and with the data being written into the SD card. The GazeTrak system can last up to 38.5 hours with a battery of similar capacity to Tobii Pro Glasses 3 (3400 mAh), while the working time of Tobii Pro Glasses 3 is only 1.75 hours. If applied to non-eye-tracking glasses, like Google Glass, the system can run for 6.4 hours. It is worth noting that these estimates do not include the power consumption of data preprocessing and deep learning inference running on a local server. Table 3 shows the measured power consumption of different components in the system. Teensy 4.1 has a high base power consumption, while the sensors (speakers and microphones) consume much less power.

TABLE 3
Power Consumption of Different Components on Teensy 4.1. Power of
data preprocessing and deep learning inference is NOT included.

| Total | Speakers & Mics | SD card writing | Other operations |
|---|---|---|---|
| 287.9 mW | 16.4 mW | 72.7 mW | 198.8 mW |

After the user study, we distributed a questionnaire to every participant to ask for feedback on the second example implementation. First, the participants evaluated the overall comfort and the weight of this compact form factor with a rating from 0 to 5. Across all 10 participants, the average scores they gave to these two aspects are 4.5 (std=0.7) and 4.2 (std=0.8), indicating that the compact form factor of GazeTrak is overall comfortable to wear and easy to use. Furthermore, all 10 participants answered “No” to the question “Can you hear the sound emitted from our system?” This verified the inaudibility of the acoustic signals emitted from the GazeTrak system.

In the previous evaluation, we recorded audio data with Teensy 4.1 first and then ran the signal processing and deep learning pipeline on a local server offline. However, to enable predictions of gaze positions in real-time on an MCU, we implemented the entire pipeline on a microcontroller with an ultra-low power CNN accelerator (e.g., MAX78002).

To achieve this, the deep learning models were trained and synthesized in advance, using ai8x libraries. We implemented two models with ai8x, which were ResNet-18 (used in the previous study) and MobileNet for comparison. Due to the hardware limit of MAX78002, we modified the models to be compatible with the chip. Specifically, for a Conv2d layer, the kernel size could only be set to 1×1 or 3×3 and the stride is fixed to [1,1]. In addition, some convolution layers of ResNet-18 were substituted with depth-wise separable convolution layers to avoid exceeding the limit of the number of parameters in the model. Furthermore, we quantized the input and the weights of the models with ai8x, which converted them all into 8-bit data format to save memory for storage and increase the speed of inference.

Before applying the deep learning model, we apply a band-pass filter on the received signals and perform cross-correlation between received signals and transmitted signals to obtain echo profiles as described previously. However, in the implementation using the MAX78002, to reduce processing time, we removed the band-pass filter since all the computations are done on the MCU and transmitting private data is no longer a concern.

Then we experimented with two different methods to realize the cross-correlation: (1) brute force to calculate echo profiles point by point; and (2) the dot product function in the CMSIS-DSP library. Results of standard tests revealed that it took the system 178.3 ms and 45.4 ms to compute one echo frame and make one inference utilizing these two methods, respectively. Considering that one frame of the audio data comes every 12 ms in the system (600 samples÷50000 samples/s), the processing time is too long to keep the system running in real-time with an FPS rate of 83.3 Hz. Finally, we explored method (3) a Conv2d layer (kernel size 1×1) with transmitted signals as the untrained weights and received signals placed along the channel axis of the input. This can increase the speed of echo profile calculation because it uses the CNN accelerator on MAX78002. We compressed the samples used for cross-correlation from 600×600 to 34×34 and the pixels of interest from 60 pixels (20.4 cm) to 30 pixels (10.2 cm) in this case to further decrease the processing time.

With this Conv2d layer added on top of the deep learning model, the model directly takes the raw audio data as input in instances with the size of 64 (34+30 samples)×26 (frames)×8 (microphones). This method allows the system to make one inference within 10.3 ms, which is enough for the real-time pipeline with a double-buffer method applied, in which direct memory access (DMA) moves the current frame in one buffer while the CPU processes the previous frame in another buffer.

To validate these modifications and compression, we evaluated the in-session performance of different models with different settings using data collected with the second example implementation. The results are shown in Table 4.

TABLE 4
Average In-session Performance for 10 Participants
with Different Models and Settings.

| Models | ML Libraries | Compressed? | Quantized? | MGAE |
|---|---|---|---|---|
| ResNet-18 | pytorch | X | X | 3.6° |
| | ai8x | X | X | 4.0° |
| | ai8x | ✓ | X | 4.0° |
| | ai8x | ✓ | ✓ | 4.2° |
| MobileNet | ai8x | ✓ | X | 4.2° |
| | ai8x | ✓ | ✓ | 4.3° |

As shown in Table 4, the same model trained with ai8x is slightly worse than that trained with PyTorch given the constraints of the convolution layers discussed above. Compressing the size of input data does not affect the accuracy. While MobileNet yields comparable accuracy to ResNet-18, both models suffer a slight performance drop after quantization since the precision of data is decreased.

Given the limitation of the I2S interfaces on MAX78002, to test the system in a more realistic condition, we still use Teensy 4.1 to control the speakers and microphones and transfer the received audio data to MAX78002 via the serial port. To accelerate the transmission speed, only the samples that are used for processing on the MAX78002 are transferred. This generates a steady stream of audio data to MAX78002. In future, we will explore connecting microphones directly to MAX78002 using multi-channel audio protocols such as Time-division Multiplexing (TDM). Evaluation results showed that for ResNet-18 and MobileNet, MAX78002 spent 124.1 ms and 41.6 ms, respectively, loading the weights of the model. This is a one-time effort and can be done before running the real-time pipeline so it did not impact the refresh rate. Then it took 12 ms to load one instance and make an inference based on it in real-time for both ResNet-18 and MobileNet, giving a refresh rate of 83.3 Hz.

We measured the power consumption of the MAX78002 evaluation kit while it made inferences. Table 5 shows that MAX78002 consumes 96.9 mW and 86.0 mW respectively when making inferences with ResNet-18 and MobileNet at 83.3 Hz. The refresh rate can be reduced to 30 Hz to save power, which is enough for many applications. In this case, the power becomes 79.0 mW and 75.7 mW respectively.

In an embodiment configured to use MAX78002 to directly control speakers and microphones, the power efficiency can be further optimized and the overall power consumption of the corresponding real-time system kept to around 95.4 mW, i.e., 79.0 mW (MAX78002 with ResNet-18 running at 30 HZ)+16.4 mW (2 speakers and 8 microphones). One should keep in mind that this is just an estimate of the power of this real-time system and the power consumption of MAX78002 might increase if it does need to control the sensors. However, we do not expect it to be very high because the current power of MAX78002 already includes that of the CPU and the CNN accelerator running at full speed.

TABLE 5
Power Consumption of MAX78002
with Different Models Running.

| | | |
|---|---|---|
| Models | ResNet-18 | MobileNet |

| | | | | |
|---|---|---|---|---|
| FPS (Hz) | 83.3 | 30 | 83.3 | 30 |
| Power (mW) | 96.9 | 79.0 | 86.0 | 75.7 |

We also evaluated simpler regression models. More particularly, we utilized two traditional regression models, which are linear regression (LR) and gradient boosted regression trees (GBRT), to predict gaze positions using the data collected in the manner described previously, and the results showed that the average in-session tracking accuracy for these two models across 10 participants is 11.6° and 6.8° respectively. Compared to the results in Table 2, the traditional regression models output much worse accuracies than ResNet-18 (3.6°). We conducted an analysis of the impurity-based feature importance with GBRT, comparing the features in different channels of microphones in Table 6. It turns out that the channels receiving signals from 18-21 kHz (S1) are generally more important than channels receiving signals from 21.5-24.5 kHz (S2). Furthermore, the microphones that are closer to the inner corners of the eyes (M1, M4, M5 M8) are more important than those closer to the tails of the eyes (M2, M3, M6, M7).

TABLE 6
Feature Importance Analysis for Different
Microphones using GBRT (Scaled to 0-100).

| Microphones | M1 | M2 | M3 | M4 | M5 | M6 | M7 | M8 |
|---|---|---|---|---|---|---|---|---|
| Importance | 100/ | 57/ | 33/ | 96/ | 66/ | 42/ | 28/ | 85/ |
| (S1/S2) | 27 | 23 | 12 | 29 | 81 | 17 | 15 | 79 |

The impact of various real-world factors was also examined, as follows. With regard to head movements, in the user study, we did not use a chin rest to fix the participants' head, so they could turn their head freely. However, head movements could affect the system performance, and therefore could be evaluated in more detail. Also, with regard to the degree of near- and far-sightedness of the participants in the user study, we collected participants' degrees of myopia in the questionnaires, and found that myopia showed no connection to the gaze tracking performance. In addition, with regard to user speaking, one researcher evaluated the system when keeping silent and when talking to himself. The gaze tracking performance of the silent sessions and the talking sessions were found to be the same, at 3.9°.

Illustrative embodiments herein demonstrate the feasibility of the disclosed acoustic-based gaze tracking system on glasses. While the eye tracking accuracy of 4.9° is comparable to some webcam-based methods, it is lower than commercial eye trackers (1.9° in the study). Therefore, the system may not be immediately applicable to some applications requiring highly precise eye tracking. However, the system can still be used in many applications, such as interaction with interface elements like buttons in AR or VR, that generally do not require very high accuracy eye trackers.

The GazeTrak system can also be used in tracking irregular eye movements, enabling healthcare applications for monitoring users' health conditions in everyday life. This requires monitoring the gaze movements throughout the day for analysis in everyday life, instead of just tracking their accurate gaze positions for a few hours in a controlled settings. The low-power and lightweight features of the GazeTrak system make it a good candidate solution to enabling a variety of applications that camera-based eye trackers cannot realize, by continuously understanding user gaze movements in the wild for extended periods. Furthermore, the system can alleviate the privacy concern from users as compared to camera-based methods.

In other embodiments, we can apply a calibration process on the output of the system to further enhance performance. For example, affine transformation and projective transformation can be used to transform the output, although the effectiveness of such techniques is limited as the error distribution of the eye tracking results in some embodiments is not linear. Accordingly, it is expected that use of non-linear transformation techniques may be utilized to further improve the performance.

The system currently utilizes a 15-second calibration process before each session to fine-tune the model, which may be inconvenient for users. However, the tracking accuracy without fine-tuning is still acceptable, at 5.9°, compared to the accuracy achieved with fine-tuning (4.9º).

It was noted above that GazeTrak achieves satisfactory performance on new users with approximately 20 minutes of training data using the user-adaptive model. This training effort can be further reduced by constructing a larger and more diverse dataset from many more participants to train the based model. Moreover, data augmentation methods, such as including simulation data to train the model, can be used as well.

In some embodiments, a Teensy 4.1 is used to control the speakers and microphones, and transfer audio data to the MCU MAX78002. In other embodiments, custom PCBs can be implemented for MAX78002 to allow it to directly control speakers and microphones. We believe that the power consumption of this example real-time system can be further reduced in this case because Teensy 4.1 with a high base power can be removed. Furthermore, we do not expect that the power consumption of MAX78002 will be significantly increased since the on-board CPU and CNN accelerator of MAX78002 were already operating at maximum speed in the current evaluation. Accordingly, such an arrangement can be utilized to provide a more integrated system in some embodiments.

As described above, some embodiments herein provide acoustic-based eye tracking glasses capable of continuous gaze tracking. A study involving 20 participants confirms that the system can accurately track gaze points continuously, achieving an accuracy of 3.6° within the same session and 4.9° across different sessions. When compared to commercial camera-based eye tracking glasses such as Tobii Pro Glasses 3, the system reduces power consumption by 95%. A real-time pipeline is implemented on MAX78002 to make inferences with a power signature of 95.4 mW at 30 Hz.

### Additional Embodiments Relating to Acoustic-Based Silent Speech Recognition

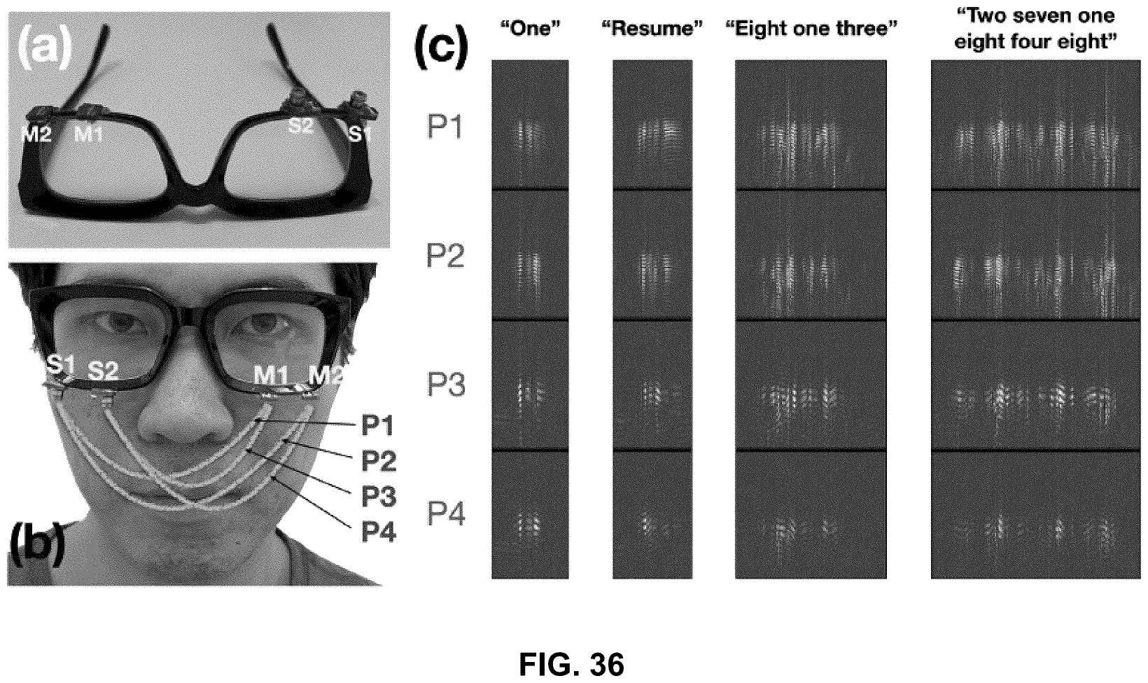

Illustrative embodiments relating to acoustic-based silent speech recognition will now be described in more detail with reference to FIGS. 36 to 40.

The acoustic-based silent speech recognition in some embodiments is implemented as an acoustic-based silent speech recognition system referred to herein as EchoSpeech. EchoSpeech is a minimally-obtrusive silent speech interface (SSI) powered by low-power active acoustic sensing. EchoSpeech uses speakers and microphones mounted on a glass frame and emits inaudible sound waves towards the skin. By analyzing echoes from multiple paths, EchoSpeech captures subtle skin deformations caused by silent utterances and uses them to infer silent speech. With a user study of 12 participants, we demonstrate that EchoSpeech can recognize 31 isolated commands and 3-6 figure connected digits with 4.5% (std 3.5%) and 6.1% (std 4.2%) Word Error Rate (WER), respectively. We further evaluated EchoSpeech under scenarios including walking and noise injection to test its robustness. We then demonstrated using EchoSpeech in example applications in real-time operating at 73.3 mW, where the real-time pipeline was implemented on a smartphone with only 1-6 minutes of training data. We believe that EchoSpeech takes a solid step towards minimally-obtrusive wearable SSI for real-life deployment.

SSI has drawn increasing attention lately. Compared with voiced speech, silent speech does not require the users to vocalize sounds, which expands its application scenarios to where voiced speech is limited. For instance, SSI can be used in noisy environments where voiced speech may suffer from severe interference or in quiet places and other scenarios where it is socially inappropriate to speak out loud. A recent study found that SSI is more socially acceptable than voiced speech, and that users are willing to tolerate more errors. Studies also found that social awkwardness and privacy concerns are important factors affecting user's perception of and willingness to use voice assistants. By removing the need to speak out loud, SSI better preserves privacy. These advantages make SSI promising in expanding the use case of voice assistant with a silent voice assistant. In addition, SSI opens up brand new opportunities where voiced speech has not touched. For instance, SSI can be used to input passwords without leaking out sounds to the environment. Collaborators in a shared workspace can use SSI to instruct AI agents without disturbing each other.

Despite these promising benefits, there exists substantial challenges preventing existing SSI technologies from being widely used. The most popular SSIs use cameras to capture lip movements. However, these methods require the presence of a camera without severe occlusion, which limits its availability. The wearable community comes up with various solutions to address this limitation. However, most of them require placing skin-contacting sensors inside the mouth or on the frontal face, which may not be physically or socially comfortable. Recent research tries to place less-obtrusive sensors at less-visible positions such as behind the car or under the chin. However, such positions can only provide limited information thus requiring extra effort such as speaking slowly to ensure performance. Additionally, wearing such devices for an extended period of time may still be uncomfortable. Contact-free SSIs do not need sensors to be tightly coupled with the skin and have drawn recent attention. Promising results are seen on necklace-mounted camera and in-car acoustic sensing based SSIs. However, camera-based methods often suffer from high power consumption and privacy concerns, while in-ear systems may still be uncomfortable for long-term wearing.

To make things worse, lack of a reliable, comfortable and minimally-obtrusive form factor is not the only obstacle faced by wearable SSIs. Performance is another key challenge. The ability to recognize speech with natural speaking speed and style (e.g., continuously speaking out multiple words together without pausing) is key towards a natural and user-friendly SSI. However, most wearable SSIs are only able to recognize a pre-defined set of discrete commands. Some have extra restrictions such as speaking slowly, remaining still, exaggerating speech, or were only evaluated in-session. In addition, the ability to recognize speech at a sentence level is still extremely limited in wearable SSIs. The past year witnessed most of such advancements in works such as MuteIt and EarCommand. However, their abilities to recognize continuous and connected speech are still limited.

To address these and other challenges, illustrative embodiments herein include EchoSpeech, a minimally-obtrusive contact-free SSI that is able to recognize both discrete and continuous speech. EchoSpeech is powered by active acoustic sensing using miniature speakers and microphones mounted on the lower edge of a commercial off-the-shelf (COTS) glass frame to track lip and skin movements from multiple paths. We designed a customized deep learning pipeline with connectionist temporal classification (CTC) loss that enables EchoSpeech to recognize both discrete and continuous speech without segmentation needed. We evaluated EchoSpeech with a study of 12 participants and demonstrate that EchoSpeech achieves a WER of 4.5% (std 3.5%) and 6.1% (std 4.2%) in recognizing 31 isolated commands and 3-6 figure connected digits spoken at a speed of 101 words per minute (wpm). To minimize training effort from new users and improve performance, we designed a two-step (pre-training+fine-tuning) training process. We demonstrate that with only 6-7 minutes of training data, EchoSpeech achieves 9.5% and 14.4% WER on recognizing isolated and connected speech. We further demonstrated EchoSpeech's robustness in scenarios such as walking and noise injection. To demonstrate the use case and effectiveness, we applied EchoSpeech in four real-time demos on a low-power variant operating at 73.3 mW.

Accordingly, illustrative embodiments include EchoSpeech, a minimally-obtrusive, contact-free SSI powered by active acoustic sensing on a glass frame that recognizes both isolated and connected speech with around 5% WER. EchoSpeech provides an SSI on a single glass frame, and utilizes a CNN-based segmentation-free silent speech recognition pipeline for acoustic sensing.

Conventional SSI approaches include contacting and contact-free SSI, depending on whether the sensors need physical contact with the skin.

Contact-free SSIs using cameras cover various granularities ranging from isolated commands and sentences to sound restoration. Despite their performance, the drawbacks are also evident: they require users to be present in front of a camera without severe occlusion, which may not be portable and may raise privacy concerns.

A workaround to the portability issue is deploying the system on mobile devices, illustratively using the built-in camera or speaker and microphone of the smartphone to capture lips movements and infer silent speech from them. However, such systems require holding the smartphone in the hand. For a real hands-free and eyes-free system, fully wearable solutions are needed.

Some Contacting SSI approaches involve directly placing sensors on the articulators in the mouth. For instance, magnetometers have been placed on the tongue and/or lips to directly capture tongue/lip movements. For similar purposes, capacitive sensors were also used inside of the mouth. However, these systems are highly obtrusive and many users might find putting artifacts inside the mouth uncomfortable.

For improved comfort, researchers also explored putting sensors externally to capture signals that reflect internal movements. In this category, ultrasonic imaging uses skin-contacting probes usually tightly under the chin to obtain direct imaging of the internal structures to infer silent speech or even synthesize voices. Another well-explored direction uses electromyography (EMG) to infer silent speech from muscle movements represented by EMG signals. This approach requires attaching multiple electrodes on the skin, mostly on the frontal face and the chin. Similar approaches with different sensing principles include placing RFID tags around the mouth to capture lip and cheek movements, using electrodes around the head to capture electroencephalography (EEG) signals and analyzing vocal tract shape using MRI signals.

However, wearing multiple sensors on the frontal face may not be physically or socially comfortable. Other approaches try to mitigate this issue by exploring less obtrusive sensor locations such as motion sensors behind the car or under the chin, but in some cases require users to speak slowly. In addition, these approaches still require users to wear skin-contacting devices which may not be comfortable for long-term deployment (e.g., most users thought that MuteIt was comfortable to wear for less than 2 hours).

Compared with putting sensors contacting the skin, contact-free SSIs are usually more comfortable and user-friendly. However, they face more challenges in obtaining high quality signals because sensors need to be put relatively far away from the articulators. In addition, such often consume large amounts of energy (e.g., a sensing unit in one conventional camera-based approach operates at 2.4 W) and have significant privacy concerns.

Other approaches fall at the boundary of contacting and contact-free systems, where sensors themselves are contact-free but the form factor needs to be tightly attached to the skin. For instance, motion sensors and strain sensors have been deployed on a mask. However, these systems only achieve limited performance, likely due to lack of a reliable representation of articulator movements.

Another approach involves in-ear acoustic sensing. However, such approaches typically experience significant performance drop while tested across sessions. Additionally, compared with fully contact-free systems, these systems still have significant disadvantages during long-term wearing.

In both contacting and contact-free SSIs, continuous recognition ability is still extremely limited.

The EchoSpeech system as disclosed herein overcomes these and other drawbacks of conventional approaches, illustratively by providing a low-power, minimally-obtrusive contact-free SSI powered by active acoustic sensing. EchoSpeech is implemented in some embodiments as a contact-free SSI deployed on a single glass frame. It deploys miniature speakers and microphones on the lower edge of a COTS glass frame and achieves around 5% cross-session WER in recognizing 31 isolated commands and 3-6 figure connected digits that are spoken at 101 wpm.

The design rationale and basic operating principles of EchoSpeech will initially be described.

When people speak, whether with or without vocalizing voices, muscles on the face drive different parts of the face to move. Among these parts, lip movements are especially useful in inferring speech. EchoSpeech utilizes an active acoustic sensing approach to track subtle skin deformation as a user is speaking.

FIG. 36 shows an example configuration and corresponding echo profiles for the EchoSpeech system. Parts (a) and (b) of the figure show the wearable device and its corresponding signal paths. In this embodiment, the wearable device comprises speakers S1 and S2 and microphones M1 and M2, arranged on a glass frame as shown, providing signal paths denoted P1, P2, P3 and P4. Note that each path illustratively includes multiple path reflection and diffraction components that originate from the source speaker and ends at the target microphone. The lines shown for the respective paths in the figure only illustrate the sources and targets. Part (c) of the figure shows the echo profiles for different utterances, illustratively include utterances of “One,” “Resume,” Eight one three” and “Two seven one eight four eight.”

In this embodiment, the speakers and microphones are mounted on the glass frame so as to be positioned close to the face when the glasses are worn by a user. The speakers emit encoded sound waves, which are reflected and diffracted by various facial parts including the lips, and captured by the microphones. With the example form factor setup shown in parts (a) and (b) of FIG. 36, the speakers and the microphones are mounted on different sides of the glass frame corresponding to respective different sides of the face. Signals emitted by the speakers travel across the face through different paths and are captured by microphones on the other side of the face. To demonstrate how the system captures facial movements during speech, a few silent utterances (defined as a period of silent speech such as a word, phrase or short sentence separated by pauses) where recorded while a user was wearing the EchoSpeech system, and the corresponding echo profiles are shown in part (c) of FIG. 36. In the echo profiles, different silent utterances appear as strong yet distinct patterns, indicating that EchoSpeech is able to capture the movements caused by silent speech. With a customized machine learning pipeline, such patterns can be used to infer speech, as disclosed herein.

As indicated above, existing SSI systems exhibit a number of significant drawbacks, including lack of a reliable, and physically and socially comfortable form factor, and lack of an ability to recognize speech in a natural and continuous way. The EchoSpeech system disclosed herein addresses these and other drawbacks of conventional practice, through a design approach that emphasizes utilization of a form factor that is minimally-obtrusive and comfortable to wear, that is evaluated in a way that is as natural as possible, and that is low-power, privacy aware and requires as little training effort as possible.

With regard to form factor, EchoSpeech utilizes a contact-free acoustic sensing approach that can be easily deployed on wearables. Compared with other contact-free sensing methods such as cameras, acoustic sensing is much more power-efficient and privacy-aware. Compared with methods such as capacitive or distance sensing, acoustic sensing provides better sensing range and resolution. In addition, acoustic sensors are cheap and widely available on wearable devices. To minimize privacy concerns as well as avoiding annoying users with noises, some embodiments only use audio signals over 18 kHz and apply band-pass filtering to remove low frequency components where most sensitive sounds are distributed.

With acoustic sensing, EchoSpeech uses reflected and diffracted sound signals to recover the pattern of movements of the articulators and their connecting tissues which naturally occurs while speaking. It uses a COTS form factor, illustratively a glass frame, which was found to provide advantages over other form factors, such as in-car and behind-the-car form factors, that may be uncomfortable to wear, capture limited information, and can lead to unstable performance on participants with different head shapes. Other form factors such as necklaces also exhibit challenges, particularly when users are walking.

The glass frame form factor has several benefits that other form factors do not have. For example, it is comfortable for long-term wearing as many people wear it all day long. It is also stably mounted on the head, which allows users to be able to speak naturally without need to keep still. In addition, glass frame expands from behind the car to above the nose in the front, which provides more flexibility in placing sensors at different locations without significant hardware modifications. Many of these locations are close to skin and muscles that have significant deformation during speech, resulting in better performance.

In order to find an optimal form factor setup that best balances the above-noted design objectives, we conducted experiments on various sensor positions, orientations, and quantities. To quickly quantify these explorations, we compared different setups with a small-scale standard test to compare their performances. In the test, one researcher wore the glasses and used a 10-word command set (10 digits, zero to nine) and collected 40 repetitions for each word. We used a simple CNN model to classify these 10 words. It should be noted that the simple CNN was utilized to quickly obtain horizontal comparison between different configurations, rather than to achieve the best possible performance in this step.

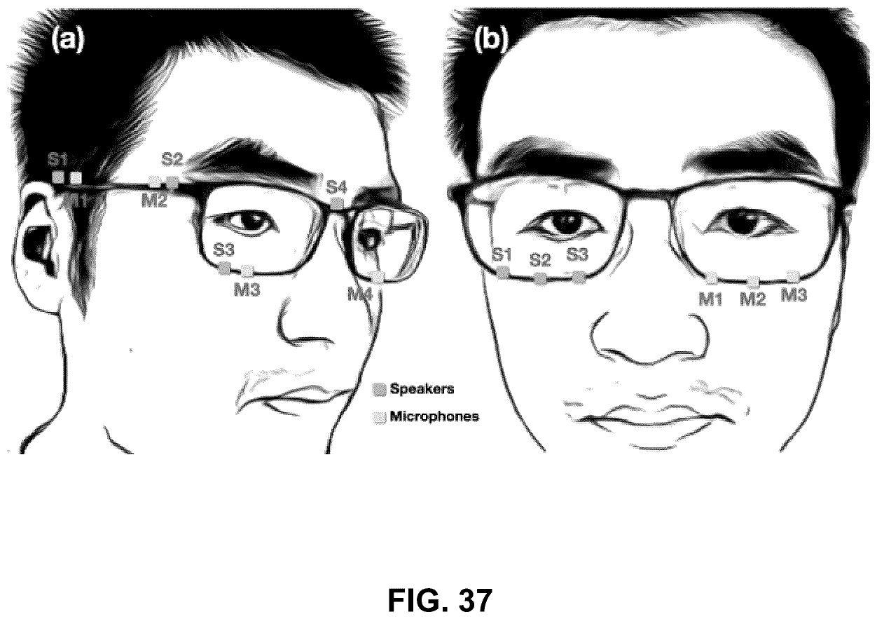

FIG. 37 illustrates example iterations that were performed on sensor and microphone positions in illustrative embodiments. Parts (a) and (b) of the figure more particularly show different sensor and microphone positioning arrangements.

In these experiments, we started with the most unobtrusive setup by placing the sensors on the leg of the glass frame. We experimented with S1+M1/M2, S2+M1/M2 as illustrated in part (a) of FIG. 37. This example setup did not put any sensor in the front. Instead, it captures skin deformations on the side of the cheeks. However, such deformations are very weak and not informative enough for inferring activities as subtle as silent speech. Accuracy for this example configuration on the above-noted standard test was under 50%.

We then moved the sensor to the front side, placing a speaker near the nose bridge while two microphones were placed on either side of the frame to get a symmetric setup utilizing S4+M3+M4 as illustrated in part (a) of FIG. 37. With this example setup, the system was able to capture quite strong patterns during speaking. However, such patterns are not distinguishable enough to tell over 10 different commands apart, achieving around 50% accuracy on the standard test. We believe that this is because the paths that signals travel only cover areas that have limited freedom in deformation, mostly around the eyes and the nose bridge. We then moved both the speaker and the microphones to the lower edges of the frame, using S3+M3 as illustrated in part (a) of FIG. 37, hoping to observe the frontal face from a closer-up position. This setup delivered a much better performance than previous trials, around 90% on the standard test. However, when we scaled up the command set size, performance decreased.

In the example setup using S3+M3, the signal travels from the speaker and reaches mostly the face and partly the lips before reaching back to the microphone. We hypothesized that having the signal paths over the lips could improve performance by capturing movements of the lip. Therefore, we updated the design and placed the speaker and microphone on different sides of the frame, utilizing S3+M4 as shown in part (a) of FIG. 37. With this updated example setup, we achieved a significant performance boost on the standard test from 90% to 98%. More importantly, this performance persisted after scaling up the command set.

We then further optimized this setup. We first experimented on the microphone location. We placed a speaker near the center and three microphones at the left, center and right of the lower frame, utilizing S2+M1+M2+M3 as illustrated in part (b) of FIG. 37. Since all setups of this type achieved over 97% on the standard test, we reduced the amount of training data to magnify the differences between the different setups of this type. Results showed that microphones M2 and M3 achieved the best results (around 90% accuracy with less training data) while microphone M1 which was closest to the nose performed significantly worse than the other positions (47% accuracy). Similarly, we experimented on the 3 speaker positions (S1, S2, S3) shown in part (b) of FIG. 37, and found that the speaker nearest to the nose (S3) had significantly worse performance than the other two.

Based on the preliminary findings, we configured the system to use two speakers (S1+S2) and two microphones (M2+M3) on respective sides of the frame, as illustrated in parts (a) and (b) of FIG. 36. In this way, signals can travel through different paths to capture more information. We verified through additional experimentation that, in illustrative embodiments, this setup indeed yields better performance than using fewer sensors. It is to be appreciated, however, that other embodiments can vary the number and placement of the speakers and microphones relative to these example arrangements, which are provided for purposes of illustration only, and should not be construed as limiting in any way.

Additional details regarding the hardware and software implementation of EchoSpeech will now be provided.

As illustrated in parts (a) and (b) of FIG. 36, we placed two speakers on the left edge (seen from the front) and two microphones on the right edge. We do not anticipate any difference if the sides of the speakers and microphones are reversed. The speakers and microphones are common commercial products, illustratively implemented as Part No. OWR-06049T-38D for the speakers, and Part No. ICS-43434 for the microphones.

The speakers and microphones were connected to a microcontroller module, illustratively a Teensy 4.1 microcontroller module, via FPC cables. We designed a separate add-on board to house the audio amplifier, illustratively an SGTL5000 audio amplifier, and FPC headers. Data were illustratively stored in an on-board micro-SD card on the microcontroller module.

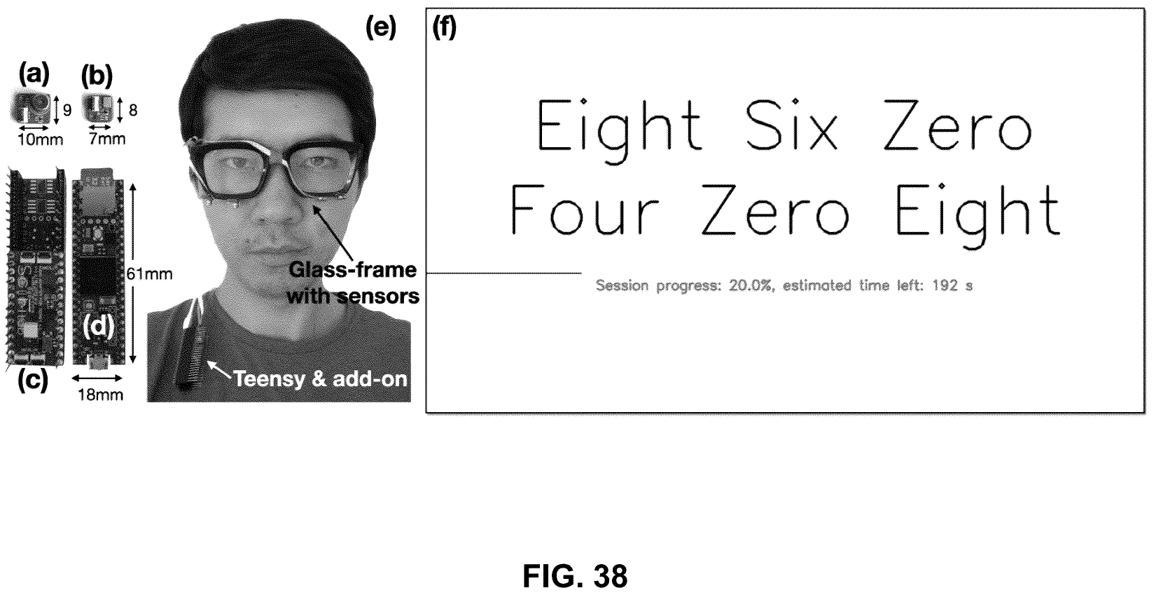

FIG. 38 shows aspects of this example setup, including hardware boards and their respective dimensions. More particularly, part (a) shows the speaker board, part (b) shows the microphone board, part (c) shows the Teensy 4.1 and add-on board (from the add-on board's side), part (d) shows the Teensy 4.1 and the add-on board (from the Teensy 4.1 side), part (c) shows a participant wearing the glass frame with sensors and the Teensy and add-on boards, and part (f) shows a screenshot of an example instruction provided to a user in a study conducted using this example setup, as described below.

As indicated previously, this embodiment uses active acoustic sensing as the sensing approach. More particularly, it utilizes FMCW acoustic signals as the transmitted acoustic sensing signals. To take advantage of two speaker positions, we used different frequency ranges for the two speakers (18-21 kHz for S1, 21.5-24.5 kHz for S2). Both frequency ranges are inaudible to most people. The microcontroller was configured to sample at 50 KHz.

We applied different band-pass filters to separate signals from the two speakers. In this way, four major paths were possible, as illustrated in part (b) of FIG. 36. Each frequency sweep lasted 12 milliseconds (ms), corresponding to an echo frame length of 600 samples. We experimented on different echo frame lengths and found out that 12 ms yielded the best performance in this example setup. After receiving the signals, we calculated echo profiles as the representation of patterns.

With this approach, the vertical axis of the echo profiles represents distance, with each pixel representing

$$\frac{1}{{f}_{s}} \times c ,$$

where fₛ=50 kHz denotes the sampling rate while c=343 m/s denotes the speed of sound. A bright strip on an echo profile represents strong reflection at that certain distance.

In order to remove constant echo reflections from the environment and only focus on the deformations on the skin caused by silent speech, we calculated differential echo profiles by subtracting the previous echo frame from the current one. We stacked the four paths combinations as four channels. The differential echo profiles were used as the representation of facial movement patterns and fed into the deep learning pipeline described below. As previously indicated, examples of such representations of facial movement patterns can be seen in part (c) of FIG. 36, where facial movements during different silent utterances are represented by different patterns in the differential echo profiles.

The EchoSpeech system includes a customized deep learning pipeline configured to decipher speech from facial movement patterns represented by echo profiles, as will now be described.

After echo profile calculation, facial movement patterns are already represented by four-channel images. Given its wide application and success in image processing, we use a CNN to decode silent speech from echo profiles. We experimented with adding temporal recurrent neural network (RNN) layers including long short-term memory (LSTM) and gated recurrent unit (GRU) layers. However, they did not improve performance in the example configuration. However, other types of neural networks can be used in other embodiments.

For the CNN, we use ResNet-18 as the backbone. The convolutional layers are followed by a one-dimensional average pooling in which, instead of performing pooling on both axes, we only perform pooling on the spatial axis. In this way, the temporal information is preserved. After this pooling step, the dimensions of the feature vectors become └T/16┘×512, where T is the original dimension of the time axis before going through the convolutional encoder. It is reduced to └T/16┘ during downsampling steps in the encoder. In this way, every 512-dimensional feature vector corresponds to a 16-frame block in the echo profile.

To adapt to variable sequence lengths, we use CTC loss. To achieve this, for each of the 512-dimensional feature vectors from the encoder, we use a fully-connected decoder network with output dimension of W+1 (W distinct labels plus blank) to predict the label of the corresponding position, where W is the number of distinct words in the command set. Note that W may not be equal to the number of commands since commands like “Hang up” are represented by two labels “hang” and “up.” In the discrete speech recognition task, W=32, while in continuous recognition W=10.

EchoSpeech illustratively utilizes a sliding-window implementation, which avoids the need to segment silent utterances manually. In this way, users can speak at different speeds and paces and speak or pause any time, as they wish. To achieve this, we adopted a sliding-window evaluation pattern. In this manner, the system does not rely on pre-existing segmentation that splits different silent utterances apart. Instead, the system automatically generates a prediction where there is a silent utterance detected and gives a blank prediction when no silent utterance is detected.

During training, sliding-window was not applied to avoid confusing the model with incomplete silent utterances. We used single silent utterance and consecutive utterances that last no more than 800 echo frames (9.6 s) to train the model to increase training samples as well as to improve the model's generalizability to variable utterance lengths.

During testing, a sliding window with a size of 192 echo frames (2.3 s) with a stride of 16 echo frames was applied. We experimented on the window size during evaluation and found that windows with sizes from around 160 echo frames to around 800 echo frames yielded almost the same performance. We utilized 192 echo frames for lighter computational cost. Every window of sample went through the same network as training. A prediction label was given for every 16-frame block in the window. We considered the label to represent the prediction at the corresponding location. Since the stride size 16 was smaller than window size 192, every 16-frame block will be covered by multiple windows. We performed a majority voting and assigned it with the label that appeared the most times among the windows covering that block. We then merged consecutive predictions with the same label and removed blank labels to generate the text prediction continuously.

During algorithm iterations, we analyzed and identified challenges that EchoSpeech faced with and tried to address them with data augmentation. Each data augmentation approach was provided to address a specific challenge, which we detail below.

As indicated above, sliding window was used during testing. With this approach, there is no guarantee that there is a silent utterance at the center of each window. To let the model see the utterances as well as the transitions between utterances, we merge consecutive silent utterances to form longer utterances with pauses in between. For instance, when a user said “One” “Pause” “Alexa” consecutively, we not only used samples such as “One” “Pause” and “Alexa” for training, but samples “One Pause,” “Pause Alexa” and “One Pause Alexa” were also added to the training set. Such operation also improves EchoSpeech's ability to adapt to different speaking speeds, as the same window may cover different number or portion of silent utterances for different users. During training, consecutive silent utterances that last no more than 800 echo frames (9.6 s) were added. This means that samples with 1 to 4-6 silent utterances were all included during training. Further increasing this window size leads to marginally improved performance, but significantly increased training time.

During training, all pixels were multiplied by a random factor between 0.95 and 1.05, as random noise. This operation was adopted to increase variance in the samples and avoid over-fitting.

Also, random padding was applied to shift the position of the samples on the time axis and to adapt the model to variable lengths. In order to increase efficiency, samples in a batch were expected to have the same lengths. Due to the vast variance of sample lengths (from less than 100 to 800), we further applied random padding to adapt the model to variable sample lengths. We first sorted all samples according to their lengths. We then took consecutive samples after sorting to form batches. In this way, samples in the same batch have similar lengths. During training, for each batch, in 50% of the cases, we simply pad all samples to the longest sample in that batch. For the other 50% of the cases, we pad all samples to a random length between the longest length and 800.

A robust SSI should be able to recognize speech across different scenarios such as remounting the devices, walking, in noisy environments, etc. One method is to collect training data from participants in all these scenarios. However, it is neither feasible nor practical. In order to make the system robust across various real-world scenarios, we synthesize training samples by adding scenario-specific noises.

We found that EchoSpeech can capture clear echo reflections from the surrounding environment. If the user is static, since echoes from the environment are constant, they can be easily removed while calculating the differential echo profiles. However, if the user is in motion (e.g., a mobile setting), since the device itself is constantly moving, such echoes will leave scenario-specific noises in the echo profiles. We noticed that such noises were mostly linearly added to static echo profiles. Therefore, we applied data augmentation by randomly adding such noises to echo profiles in the static setting to synthesize echo profiles in the mobile setting.

To collect these noises while walking, researchers wore the EchoSpeech device while walking without moving their lips. Using this data, we created noise profiles. During training, a random slice of noise profiles is multiplied by a random factor between 0 and 1 and then linearly added to training samples.

Similar to scenario-specific noises, acoustic noise in the environment can also pollute the signal. Please note that we did apply band-pass filtering. This removed most of the environmental noises, which mostly only occupies lower frequencies. However, certain noises can still extend beyond audible ranges and mix with the EchoSpeech acoustic signals, such as, for example, in a restaurant setting with silverware touching each other, items dropping on the ground, clapping, etc.

The signals that we used in this embodiment are FMCW. It is possible to decode them frame by frame to improve signal-noise-ratio. However, that will inevitably sacrifice spatial resolution. We adopted an approach similar to scenario-specific noises by recording common noises and linearly adding them into training samples to synthesize noisy data. A researcher recorded noises using EchoSpeech devices that includes the following scenarios: people talking and background music playing in a restaurant, vehicles passing by near a road, home appliances running (washer, dryer, fridge, air conditioner), tap water running. During training, 1-3 random slices of noises of random lengths were multiplied by random factors between 0 and 1 and then mixed and added to training samples at random position.

We illustratively utilized a two-step training process to minimize training effort for new participants as well as to improve performance. The system is still user-dependent, but for each new participant, instead of training a customized model from scratch, we only need to finetune the model trained with other people's data. In this way, the entire training process is divided into two steps: 1) pre-train a model using data provided by other participants. The model in this step is denoted as the user-independent (UI) model. And 2) fine-tune the UI model with the new participant's data. In practice, we found that this process improves performance and significantly reduces training time for new participants at the same time.

In order to evaluate the example EchoSpeech system with this approach, we first pre-trained a UI model for each participant using a leave-one-participant-out process. We then fine-tuned the UI model using a different number of training sessions for each participant.

In both steps, we used an Adam optimizer with cosine scheduler and an initial learning rate of 0.0002. The batch size was set to 5. For the pre-training step, the model was trained for 100 epochs. For the fine-tuning step, the entire model was fine-tuned for 15 epochs.

In a user study described below, we evaluated EchoSpeech with a setup that is natural and close to real-life applications. To achieve this, we first designed two sets of commands to examine EchoSpeech's ability in recognizing discrete and continuous speech. We also considered two most common use cases, choosing static (sitting at a desk) and mobile (walking) as the evaluation scenarios. We first evaluate how well EchoSpeech works under these scenarios. Then we further explore the practical implications, especially on how much data a user needs to provide before being able to use EchoSpeech in both scenarios. To better encourage a natural way of speaking, we did not require users to speak slowly. Instead, we instructed users to speak at their normal speed and control the pace of the study themselves. We elaborate on these considerations in the following description.

An ideal silent speech recognition system should be able to recognize any words without limitations, similar to current speech recognition based on voice. However, training such a system requires substantial resources. Thus, the vocabulary in illustrative embodiments is designed to strike a balance between usability and training practicality, thereby allowing us to evaluate EchoSpeech in a variety of different application scenarios including real-time use cases.

We configured a number of example recognition commands for each of the following popular speech interaction scenarios, including 1) hands-free music player control; 2) interacting with smart devices; 3) digits input; 4) activation commands for voice assistants. In total, we have 31 commands for discrete silent speech recognition, as illustrated in Table 7. It is to be appreciated that additional or alternative commands can be used, involving a wide variety of different interaction scenarios, in other embodiments.

TABLE 7
Command set for discrete command recognition

| Scenario | Commands |
|---|---|
| Hands-free music | Play, Stop, Resume, Pause, Previous, Next, Volume |
| player control | |
| Interacting with | Left, Right, Up, Down, OK, Cancel, Menu, Dial, |
| smart devices | Hang up, Open, Close |
| Digits input | Zero, One, Two, Three, Four, Five, Six, Seven, |
| | Eight, Nine |
| Activating voice | Hey Google, Hey Siri, Alexa |
| assistant | |

In addition to the commands, we explored using SSI for continuous input. As discussed previously, continuous recognition is a challenging yet critical step towards adopting SSI in real-world applications. Instead of recognizing a set of pre-defined sentences, we are specifically interested in recognizing unseen combinations from existing vocabulary. We combine this task with voiceless passcode input/authentication. In this use case, users can silently utter a three- to six-figure passcode quickly without pauses in between. In total, there are 1,111,000 different possible combinations (from “000” to “999999”), which cannot be iterated and learned as a whole and can only be learned through breaking down silent utterances into words.

The main study mainly examines how EchoSpeech works in the static environment (sitting at a desk), as well as in the mobile environment (walking) if no training data from the mobile environment is provided. The main study was split into discrete and continuous sections, with the former focusing on the isolated commands while the later on connected digits. The study was conducted in a large room on campus. Each participant came in twice to finish the two sections, each lasting 70-90 minutes. For each section, 18 sessions of data were collected. Participants were instructed to remount the device (take off the device and put it back on) after each session. During data collection, instructions were presented on a laptop screen, which showed the participant the command they need to perform. The laptop's webcam was used to record videos of the session with a clear view of the participant's face for reference. Participants were instructed to “mouth the word silently with lip movements similar or slightly larger than how you would have moved your lips when speaking out loud.”

As indicated previously, the hardware used in the study are illustrated in parts (a) through (c) of FIG. 38. Participants wore the glass frame with sensors installed as shown in part (c) of FIG. 38. The sensors were connected to a Teensy 4.1 microcontroller with a customized audio amplifier add-on board and configured to communicate with a laptop (MacBook Pro 2021) via a USB cable, as illustrated in part (e) of FIG. 38. At the start of each session, the laptop initiated a signal that started recording on Teensy. Meanwhile participants were instructed to clap their hands. We later manually found the clap in the video and audio to synchronize the audio with the ground truth. Clapping of hands was also used at the end of the session in case the one at the beginning was not captured.

During data collection, instructions on the laptop screen included the silent utterance itself (in large font to make sure participants saw them clearly), progress bar of the current utterance (to let the participant know how much time was left before the system jumped to the next utterance), and progress and estimated time left of the current session, as shown in part (f) of FIG. 38. In the discrete section, the maximum duration for each silent utterance was 3 seconds. The system would jump to the next utterance after 3 seconds passed. In the continuous section, the participant had 4 seconds to finish each utterance. It was longer because the length of sequence varied with a maximum length of 6 digits long. However, actual utterances were much faster because the participants were told that they should use the space bar (or the right arrow) to jump to the next utterance once the they finished the current one. This was applied to encourage the participants to speak at their natural pace and speed instead of waiting and pausing. The participants were instructed to use the “x” key (or left arrow) on the keyboard, if they made a mistake in the utterance, wanted to adjust the device or wanted a pause (by constantly pressing). In these cases, the current utterance was repeated.

Silent utterances were given in random order. In the discrete section, each command was repeated 4 times in each session. In the continuous section, each session had 60 connected digits with sequence lengths ranging from three to six. These combinations of digits were generated randomly so that each length (3 to 6 digits) had 15 occurrences and each digit (0-9) had the same amount of occurrences (27 times) in each session. In both sections, for sessions 1 through 13, participants sat naturally at a desk. For sessions 14 through 18, participants walked in the room. They were instructed to walk in the room in the way, path and speed as they wished. Sessions 1 and 14 were used for participants to get familiarized with the system and not used during training nor testing.

Each participant finished 2 sections (continuous and discrete). Therefore, there were 24 sections in total. In 12 of the 24 sections, participants were asked to hold the laptop in their arms while walking. In the other 12, the laptop was placed on a moving table so that the participant could push it around while walking. This change was adopted because some participants reflected that the laptop was too heavy as well as to increase variance in the way of walking. No significant difference in performance was observed between these two walking styles.

A follow-up study was conducted after the above-described main study by 12 users that did not participate in the main study. The follow-up study mainly focused on the mobile environment. The main purpose was three-fold: 1) provide more data to conduct thorough evaluation on the mobile environment, 2) improve performance on the main study with new data and analysis, and 3) explore directions for future optimization on the mobile environment.

The follow-up study shared almost the same configuration and procedures as the main study except that there were 17 sessions. Participants walked in the room for sessions 1 through 13 and sat at a desk for sessions 14 through 17. Session 1 was used as a practicing session. Since participants finished the walking sessions first, they did not need to practice again for sitting sessions. In addition, the laptop was always placed on a moving table. It is worth noting that the follow-up study and the main study were conducted in different rooms. The room for the main study was quiet and had carpeted floors. The room for the follow-up study had a noisy ventilation system and hard concrete floors.

In the main study, 12 participants (all college students, 5 self-identified as male, 7 female, average age 23.5: from 18 to 32, std 4.4) were recruited. Hardware malfunction happened twice (broken cable on P3, SD card full on P11) but the participants returned to redo the lost sessions. On average, each session lasted 3.3 minutes in the discrete section, and 3.0 minutes in the continuous section. After removing the practice sessions, 23808 valid silent utterances were collected for the discrete section, in which 17856 were collected when participants were static, while 5952 were collected when participants were in motion. 11520 valid silent utterances (51840 digits uttered) were collected for the continuous section, in which 8640 (38880 digits) were collected when participants were static, and 2880 (12960 digits) were collected when they were in motion. Data collected in the main study is denoted as the main dataset in later text.

Allowing the participants to finish each silent utterance early using keyboard reduced study time. On average, participants spent 1.51 seconds on each discrete silent utterance and 2.67 seconds on connected ones. Variance is also observed: the slowest participants spent 1.83 s while the fastest one spent 1.22 s on each discrete silent utterance. On continuous silent utterance, the difference is 2.27 s (fastest) and 3.09 s (slowest).

The follow up study only included the discrete section. 12 participants that did not participate in the main study were recruited (5 self-identified as male, 7 female, average age 25.4: from 19 to 35, std 5.0). Each session lasted 2.6 minutes on average. Participants spoke generally faster. The average silent utterance duration was 1.20 seconds (fastest: 0.93 s, slowest: 1.53 s). Data collected in this study forms the follow-up dataset.

We now further describe the experiments conducted to evaluate EchoSpeech. We start by presenting the evaluation metric. We then present the experiments conducted on the main dataset and the follow-up dataset, respectively. After that, we present further experiments and analysis to improve performance and reduce training effort.

As indicated previously, the evaluation metric used in these example embodiments was WER. WER is commonly used in speech recognition-related tasks. Compared with accuracy, WER is better at gauging continuous predictions. For instance, for sequence “Volume up,” if the prediction is “Volume,” using accuracy as metric will treat the prediction as wrong while the WER will be 0.5, better reflecting that the model finishes half the job. This is especially useful in longer sequences. WER of around 5% is usually considered human performance and is acceptable in conversations.

We calculate the metric in the unit of each silent utterance as recorded during the user study. For each silent utterance, we compare the text prediction generated using the sliding window approach as previously described with the ground truth and calculate WER as:

$$W E R = \frac{S + D + I}{S + D + C} \qquad ( 2 )$$

where S, D, I and C are the numbers of substitutions, deletions, insertions and corrected words, respectively.

Experiments on the main study mainly examine how EchoSpeech works in recognizing discrete and continuous silent speech in the static environment. In addition, we also utilize the mobile sessions in the main study to evaluate how EchoSpeech works while walking without providing training data from the mobile environment.

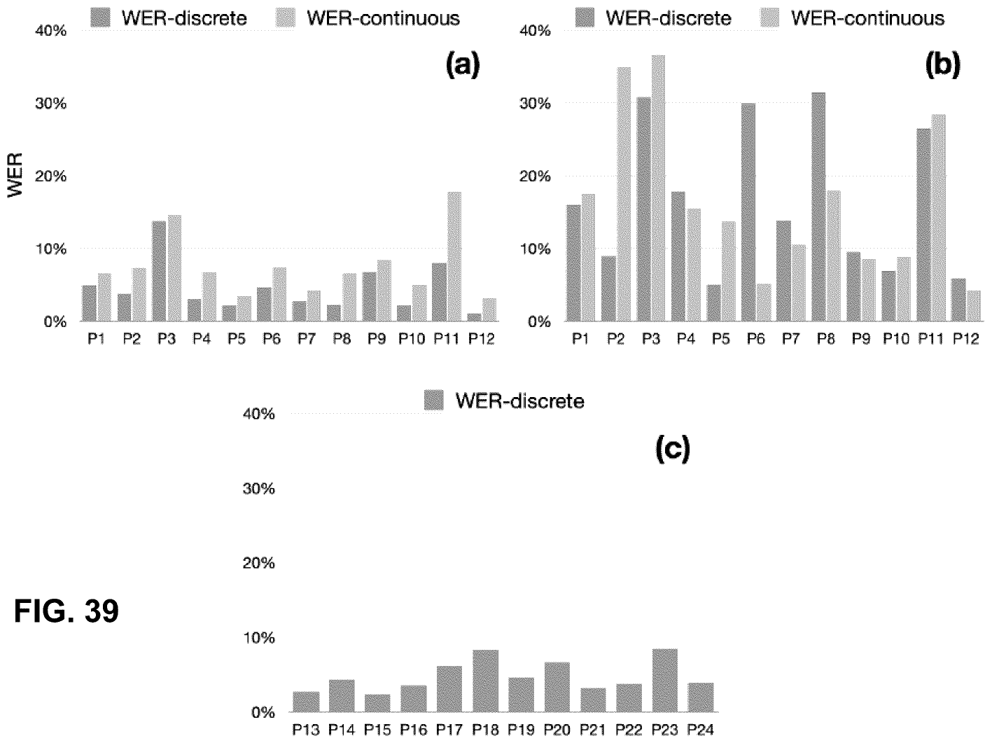

FIG. 39 shows discrete and continuous speech recognition performance, across participants, with part (a) showing performance in the static setting, part (b) showing performance in the mobile setting, and part (c) showing performance in the mobile setting on new participants from the follow-up study.

We evaluated EchoSpeech's capability to recognize discrete speech using the algorithm pipeline described previously. We adopted the two-step training process, training a leave-one-participant-out (LOPO) UI model for each participant first, and fine-tuning the UI model using the same participant's data. To remove random factors, we performed a 6-fold cross-validation on the 12 static sessions. To achieve this, we utilized 2 sessions as testing (sessions 2,3, sessions 4,5, . . . , sessions 12,13) and used the remaining 10 sessions to fine-tune the model. We used the model after the last epoch to evaluate. The discrete speech recognition results across participants are shown in part (a) of FIG. 39.

More particularly, for discrete speech recognition, the average WER across 12 participants was 4.5%, ranging from 1.0% (P12) to 13.7% (P3), std=3.5%. We specifically looked into the two participants with worst performance (P3, P11), we found out that they both pushed the glass frame multiple times as the glass frame frequently slipped down their nose during the study. Since the sensors of EchoSpeech were pointing downwards, pushing the glass frame introduces significant noise in the signals.

We evaluated EchoSpeech's capability in recognizing continuous speech using a similar approach to that of discrete speech. Results indicate that the average WER across 12 participants is 6.1%, ranging from 2.1% (P12) to 16.3% (P11), std=4.2%. Results for each participant are shown in FIG. 39 (b). Similar to that of isolated digits, pushing the glass frame was found to cause most issues in participants with worst performances (P3 and P11). For P11, an additional observation was that the participant made some mistakes but did not remove them from the samples. This was observed by watching the recorded study videos. It was difficult to remove all such bad samples, since the utterances were silent and difficult to make out from the video due to limited lip movement and fast speaking speed. If P11 is removed from the study, average WER was improved to 5.2%.

The results presented above were achieved with 10 sessions (around 30 minutes) of training data collected from the same user. This already represents a significant advancement relative to conventional approaches. However, we wish to further minimize training effort from new participants, pushing towards higher practicability. Therefore, we conducted several experiments to demonstrate how to minimize training effort from new participants.

We demonstrate that users can provide as little as 2 sessions (6-8 minutes) and still achieve acceptable performance. We experimented with different numbers of fine-tuning sessions. When no data was used for fine-tuning, the system works user-independently. In this way, WER for recognizing discrete and continuous speech is around 40%. The impact of the amount of data used for fine-tuning was assessed by using data from the same user collected in the same setup to fine-tune the model, using data from the same user collected in the static setup to fine-tune the model for the mobile setup, and adding other people's data to training to improve performance.

It was found that performance improves with more training sessions applied, while flattens after about 4 sessions of data applied. With only 2 sessions of training data, EchoSpeech is already able to recognize 31 isolated commands or 3-6-figure connected digits with 9.5% and 14.4% WER, respectively.

Using the 4 mobile sessions from each user, we evaluated how EchoSpeech performs when the user was in motion without providing training data while walking. This can minimize training effort. We applied data augmentation as described previously by adding motion noises to static data and evaluated EchoSpeech without any training data collected in mobile settings. The motion noises were collected by researchers at different locations from the study. We trained a model using data collected from all participants in the static setting, applied data augmentation, and evaluated on all participants' data collected in the mobile setting. Results show that average WER across 12 participants is 16.8% for both discrete and continuous speech (std: 10.3%, 11.0%, respectively), as demonstrated in part (b) of FIG. 39. This result is significantly worse than the static setting. Additional techniques to improve this result are described below.

As discussed earlier, the follow-up study was conducted to provide more data for thorough evaluation on the mobile environment, improve the mobile performance in the main study, and explore directions for further optimization.

The richness of new data allowed us to train a user-dependent model similar to that in the main study to explore the limit of EchoSpeech when the user was in motion. Adopting the same two-step training process as described previously, we trained a LOPO UI model for each user first, then fine-tuned it with 10 mobile sessions from the same user. Results shown in part (c) of FIG. 39 demonstrate consistent performance compared with when the user was static: average WER is 4.7% (std 2.1%), ranging from 2.3% (P15) to 8.4% (P23). This result demonstrates that with enough training data, EchoSpeech can adapt to different scenarios with robust performance.

To reduce training effort, we experimented with different numbers of fine-tuning sessions, similar to the main study. The results are also similar. It was found that performance improves with more training sessions applied, and flattens after about 4 sessions of data applied. With only 2 sessions of training data (about 68 minutes), EchoSpeech is already able to recognize 31 isolated commands in motion with 8.2% WER (std 2.5%).

As indicated above, performance on the mobile environment was significantly worse even after applying data augmentation. We demonstrate that even without new data from the same user, this performance can be improved by incorporating other users' walking data into training. Adding 11 other users' walking data into training from the original study, performance on discrete and continuous speech recognition improved from 16.8% to 13.1% and 13.2%, respectively. Continuing to add the 12 new users' data from the follow-up study, performance on discrete speech recognition further improved to 10.7%. It was found that performance steadily improved with more other users' data being added. This also points a future direction for further optimizing performance and reducing training effort with scaled up data collection.

To explore further reducing training effort, we conducted evaluation on the follow-up study, utilizing all available data from other users. With this approach, for each user, with 4 static sessions as training and no mobile sessions, EchoSpeech achieves 8.7% (std 2.8%) in recognizing 31 discrete commands. With only 2 static sessions, performance can still reach 13.2%.

Combined with the previously-described results, this means that a new user only needs to provide 6-8 minutes of static training data to use the system in both static and mobile environments with acceptable performance. Additionally, with potential large-scale deployment in the future, this performance can be further improved and the training effort can be further reduced. These results indicate that illustrative embodiments can provide a practical SSI useful in daily life.

While recognizing continuous speech, we are interested in how the errors distribute among sequences with different lengths. We calculated the average WER for 3-6 digit silent utterances separately. Results demonstrate that although longer sequences take more time and have more syllables, no significant performance discrepancy is observed in the recognition performance.

In addition, we also examined the impact of speaking speed on the performance. Results show that for discrete speech, performance decreases if the duration is shorter than 1.4 s and stays steady if participants spoke slower. For continuous speech, no significant trend is observed.

As described previously, EchoSpeech utilizes 2 pairs of speakers and microphones, enabling four major signal paths. In order to examine how each path contributes to the performance, we conducted an experiment isolating each path by applying different band-pass filters. We adopted one-step training to save time. Sessions 12-13 of all participants were used for testing and sessions 2-11 of all participants were used for training.

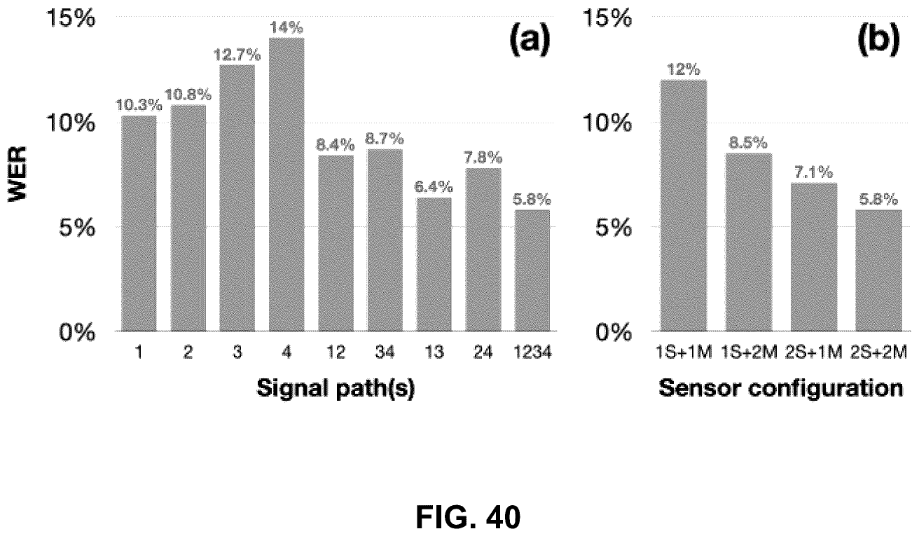

FIG. 40 shows the impact of different signal paths and sensor configurations. Part (a) of the figure illustrates variation in WER for different signal paths, and part (b) of the figure illustrates variation in WER for different sensor configurations, where 1S+1M denotes using one speaker and one microphone, etc.

The results shown in FIG. 40 indicate that performance degrades from 5.8% to 12.0% on average if only one path (one speaker and one microphone) is used. Path 1 and path 2 are more useful than path 3 and 4. This confirms that four paths all contribute positively to the system. However, considering the device size, cost, computation load and power consumption, such degradation can be acceptable in certain scenarios. We demonstrate herein that a low-power variation of EchoSpeech with only one speaker and two microphones can operate at as low as 73.3 mW and run in real-time on a smartphone.

In order to examine how EchoSpeech works in noisy environments, we experimented with noise injection by mixing noises into the data we collected. A researcher used the same device as used in the user study to record two types of noise: 1) street noise. The researcher walked along a busy street for 5 minutes. Cars passed by frequently. Using the NIOSH Sound Level Meter App on an iPhone 12, the noise level was 64 dB(A). 2) restaurant noise. The researcher went into a noisy restaurant and recorded for 5 minutes. Background music and crowd chatting could be heard. The same app measured the noise level at 76 dB(A).

A spectrum analysis of the injected noises and the EchoSpeech acoustic signals was performed. It was found that most of the noise components are below the range of the EchoSpeech acoustic signals. For those that do overlap, the amplitude of the EchoSpeech acoustic signals is much stronger than the noise.

We also mixed the two types of noise into each session collected during the user study. We used models trained and fine-tuned on clean data and directly tested them on noisy data. The results show that performance in static setting slightly decreases around 2% for street noise and around 3% for restaurant noise. However, there was almost no change in performance in the mobile setting. We hypothesize that noisy patterns on the echo profiles from walking makes the model robust to different noises on the echo profiles, thus providing extra resilience against environmental noises.

We then applied the data augmentation as described previously. One researcher collected the noises from different places. The data augmentation was applied during the fine-tuning stage without the need to re-train the model. After applying data augmentation, EchoSpeech becomes even more resilient against acoustic noises, yielding almost the same performance as when no noise was present.

As is apparent from the foregoing description, EchoSpeech can be used as an alternative hands-free and eyes-free input method in a variety of applications. We implemented the system in several sample applications and demonstrated them in the above-described experiments. Although these functions can all be achieved by using traditional speech interfaces, traditional speech recognition requires the user to speak aloud which is frequently inconvenient or socially inappropriate. EchoSpeech provides a new input form, that can be integrated with other existing interactive technologies or used alone.

For example, EchoSpeech can be used with CAD software. CAD software usually involves many options, configurations and dimensions. It can be challenging to incorporate them with the natural way of design (e.g., directly drawing on canvas) because users need to switch between options, specifications and the graph itself constantly. Furthermore, users often need to work at quiet places (e.g., library, lab) while working on these design tasks. Thus, speech recognition is not feasible. EchoSpeech provides an option to use silent utterance as an extra interface, without disturbing others with voice commands. We have demonstrated this use case by using EchoSpeech to draw basic shapes on CAD. Here EchoSpeech provides an additional input modality that can be used together with existing stylus input smoothly. The user first selected the types of shapes with silent commands. Then the user naturally drew the shape with a stylus and used silent commands to specify the dimensions.

As another example, silent utterances can be recognized by EchoSpeech in numerous mobile use applications. More particularly, while in motion, it is usually inconvenient and even dangerous to engage in interactions with hands and/or eyes. In such cases, uttering the interaction intention can be a good alternative. EchoSpeech provides a solution where users have access to a hands-free and eyes-free interface without needing to speak out loud, which can be particularly suitable for mobile use.

In addition to the applications discussed above, EchoSpeech can be used in certain scenarios as a replacement or improvement to existing interfaces. These scenarios particularly focus on cases where the users have occupied hands or inaccessible devices, and are presented as illustrations of the position of EchoSpeech. In addition, the EchoSpeech system in other embodiments can be fully integrated into real glasses or other form factors, so that the sensors are effectively invisible in terms of outward appearance. Such arrangements allow EchoSpeech to be used with minimal level of social awkwardness, thus facilitating the following use cases, among numerous others.

For example, EchoSpeech can be integrated with earphone/headsets to control music players. Voice has already been used to control music players. EchoSpeech provides an alternative approach without making sound, which could expand the use cases of voice music player control.

As another example, EchoSpeech can be used to assist with text input on mobile phones. Inputting punctuation and symbols using the keyboard on a smartphone is not very convenient, as it requires users to switch to secondary keyboards. In such cases, if these keys can be silently mouthed, then users can keep their focus on the main input without switching between keyboards. With a larger vocabulary, it is also possible to integrate more words and functions to realize a dictation-style input interface that is even more natural and smooth.

Example implementations of the above-described use cases were developed using a low-power variant of EchoSpeech and deploy the processing pipeline on a smartphone. We employed the wireless module with nRF52840 microcontroller for Bluetooth Low Energy (BLE) data transmission. Since the module only supports one-channel audio transmission, we used the one speaker (S1) and two microphones (M1+M2) setup. With this setup, we measured the power consumption of the entire module while transmitting data via BLE using a current ranger. Results show that the system operates at 73.3 mW (3.96 V, 18.5 mA).

We implemented the data processing and deep learning pipeline on an Android phone (Xiaomi Redmi K40) using PyTorch Mobile, for multiple example applications. For each application, one researcher collected a small amount of training data (1-6 minutes) with a command set including all the desired commands. The phone handled all processing and prediction and transmitted results to an ESP32 that registered itself as a Bluetooth keyboard. The ESP32 analyzed the predictions and sent corresponding action keys to the device that it paired with. For instance, when controlling a music player, the ESP32 paired with the phone that is playing music. When it received the command “Next,” it sent a “Next song” key to the phone.

As described previously, EchoSpeech uses a CNN-based model for both discrete and continuous silent speech recognition. It is also possible to use other types of neural network models, such as RNN models that include LSTM or GRU layers at the end of CNN layers to extract temporal patterns. We experimented on such convolutional RNN (CRNN) CRNN models, including, for example, attaching LSTM and GRU components after the CNN encoder in some implementations. The results generally indicated that GRU works better than LSTM. In most cases, CNN and CRNN networks work similarly. However, CNN converges faster than CRNN with the same number of epochs. In certain cases, the latter had trouble converging. Also, CNN without RNN layers needs less computational resources and runs faster. For these reasons, we used the CNN model without RNN layers. We attribute the success of CNN to the feature representation and customized pooling strategy of illustrative embodiments herein. With the echo profile calculation, we converted all temporal features into spatial ones. For instance, speech at different speeds will be reflected in the echo profiles as having different lengths. The one-dimension average pooling preserves temporal information and enables the network to cope with silent utterances with variable lengths without losing information.

In order to minimize power consumption as well as to reduce the potential impact on the user and the surrounding environment, we conducted an experiment on speaker power. One researcher collected data with 10 different signal amplitude configurations, ranging from 0.67% to 100% (using the amplitude used during the user study as 100%). For each amplitude configuration, 8 sessions of data of a smaller command set (10 digits) were collected. For each amplitude, 8-fold cross-validation were performed to minimize randomness. All 80 sessions were collected in random order to make sure that results are maximally directly comparable. The data was collected in a quiet environment while we injected noises later. Noise augmentation was also performed.

The results show that in a quiet environment, even with very low amplitude, the system still worked reliably. However, when the restaurant noise was injected, performance significantly degraded. The larger the amplitude, the less degradation happened. When noise augmentation was applied, performance significantly improved except for very low amplitude. The flattening point was between 10% and 20%. For speaker amplitude greater than 20%, the system performance was basically not impacted by noises when data augmentation was applied. At 20% amplitude, each speaker roughly consumes 1.2 mW, compared with 28 mW at 100%. This further reduced the system's power signature to around 50 mW with both speakers, compared with 73.3 mW with 1 speaker.

In the above-described real-time smartphone implementation, EchoSpeech operates at 73.3 mW, which can last for over a day on AR glasses such as Google Glass, Espon Moverio, and Microsoft HoloLens which all have a battery size of over 800 mAh. Adjusting the amplitude further reduced power consumption to around 50 mW. Further reduction of power consumption can be achieved by adjusting the duty cycle. For instance, it is possible to adjust EchoSpeech to operate at low sweeping rate when not actively used. Once an activation is detected, the system can be turned on at full speed.

With regard to the impact of native/non-native speakers, some studies have found out that native speakers tend to perform better in silent speech tasks. In the EchoSpeech study, all participants were fluent with English, but only P7 and P12 were native speakers. While their performance was indeed better than average (average WER 1.9% vs. 4.6% on isolated commands), the sample size is too small to draw any conclusion. We believe that just like voiced speech, SSI should be developed for all fluent speakers regardless of whether they are native speakers or not.

With regard to health implications on ultrasound exposure, it is noted that EchoSpeech uses near ultrasound as the sensing medium. NIOSH recommendation of noise exposure mainly focuses on noises below 16 kHz, which we did not use. A review focusing on airborne ultrasound exposure recommends 75-85 dB SPL as the limit for long-term exposure for frequencies near 20 kHz. To investigate the sound pressure level of the system, one researcher wore the device and placed a microphone near the edge of the left ear canal, the one closer to the speakers. At 100% amplitude, the RMS value of the recorded sound is 1107 (−26.4 dB FS). Taking the sensitivity (−26 dB FS @ 1 kHz, 94 dBSPL) and frequency response (+15 dB at 20 kHz) data into account, the estimated intensity at the car canal is 78.6 dB SPL, near the edge of the strict versions of recommendations. However, as described above, reducing the amplitude to 20% has little impact on performance. At 20% amplitude, the RMS value of recorded sound is 167 (−42.8 dB FS), and the estimated intensity is 62.2 dB SPL, well below recommended levels.

The acoustic sensing signal in illustrative embodiments ranges from 18 to 24.5 kHz. To most adults, this range is not audible. However, it may still be audible to children and certain animals. To minimize impact on the environment, EchoSpeech can be used in an activate-to-speech way. For instance, it is possible to define an activation gesture such as nodding and integrate an IMU module on the glass frame to detect system activation. In this way, both power and computational resources can be saved, meanwhile bringing less disturbance into the environment.

With regard to impact of form factor and shape of face, different sizes of glass frame may have some impact on the performance in that the signal paths will be different. Intuitively, a lager glass frame usually has lower edges, which makes the sensors closer to the mouth. However, based on limited experiments, we did not observe discrepancy in different glass frames. During early stages of the exploration, researchers experimented on three different glasses: a small one that tightly fits the face, a light yet large one with lower edges, and the one used in the user study. All glass frames were commercial products purchased online or at a local store. We utilized the particular one shown in the illustrative embodiment of FIG. 36 because its size is easier to fit different head shapes: the small one was too small for some people while the large one slid down too easily.

We also examine possible impacts of different shapes of face. We measured the height and width of participants' face from the video and compared them against the size of the glass frame to obtain the actual sizes. The face shape was not found to have any correlation with performance, although the current sample size (12) is too small to draw any conclusion.

It should be noted that performance is degraded when objects get too close to the sensors, such as pushing glasses with fingers. We believe that this issue might be improved by applying data augmentation. However, we also believe that such a limitation might be acceptable. Research already shows that users are willing to tolerate more errors for silent speech system. Pushing glasses in the EchoSpeech system may be viewed as comparable to coughing or sneezing as to voiced speech interfaces.

Several participants reflected that the glass frame was not particularly stable during the study (P7, P8, P11). They all have relatively small faces. This issue may negatively impact performance. We believe that more glass frames size options or personalized glass frame can mitigate this issue.

Activating the system before use can save significant power and computational resources. Although EchoSpeech uses a segmentation-free pipeline that automatically detects the start and end of speech, it was not evaluated specifically for activation purposes. To be used with activation, the system needs to be able to tell certain activation gestures apart from various other activities, even including speech. Other embodiments can be specifically configured to include such functionality.

The above-described EchoSpeech embodiments provide a minimally-obtrusive contact-free SSI on a glass frame that can recognize both discrete and continuous speech. EchoSpeech strives to address the key challenges faced by wearable SSIs by placing two pairs of speakers and microphones on either side of a glass frame. Such configuration allows EchoSpeech to capture subtle yet highly-informative skin deformations with acoustic sensing at a close-up yet comfortable position. A customized deep learning pipeline enables EchoSpeech to recognize discrete and continuous speech without segmentation. A user study with 12 participants shows that EchoSpeech achieves a WER of (std 3.5%) and 6.1% (std 4.2%) on recognizing 31 isolated commands and 3-6 figure connected digits, respectively. Further evaluation demonstrates EchoSpeech's robustness across different scenarios such as walking and injected noises. Finally, we describe a real-time implementation that operates at 73.3 mW with pipelines running on a smartphone to show example use cases.

Illustrative embodiments disclosed herein provide acoustic interface systems for silent speech recognition and other applications. For example, some embodiments are configured to recognize silent speech, although it is to be appreciated that the disclosed techniques are more widely applicable to numerous other acoustic signal processing contexts.

One embodiment of an acoustic interface system as disclosed herein comprises a wearable device which uses acoustics to track the oral cavity or lung cavity of a human subject through the nostrils. The wearable device comprises one or more high frequency microphones or speakers positioned just below each nostril (e.g., one speaker under right nostril, one microphone under left nostril). These acoustic components can be embedded in any form factor positioning them under the nose (e.g., virtual reality (VR) headset, face mask, eyeglass frame, etc.). Acoustic signals generated by the speaker traverse through the nostril and are reflected back out and detected by the microphone. Depending on the shape of the oral tract or lungs (e.g., speaking, eating, moving tongue, breathing, etc.), acoustic attenuations will be altered. The system can be used for silent speech recognition, eating/drinking detection, tongue tracking, breathing detection and in a wide variety of other applications.

It is to be appreciated that the foregoing and other arrangements disclosed herein are only examples, including examples of potential applications of the disclosed techniques, and numerous alternative arrangements are possible.

These and other illustrative embodiments include but are not limited to systems, methods, apparatus, processing devices, integrated circuits, and computer program products comprising processor-readable storage media having software program code embodied therein.

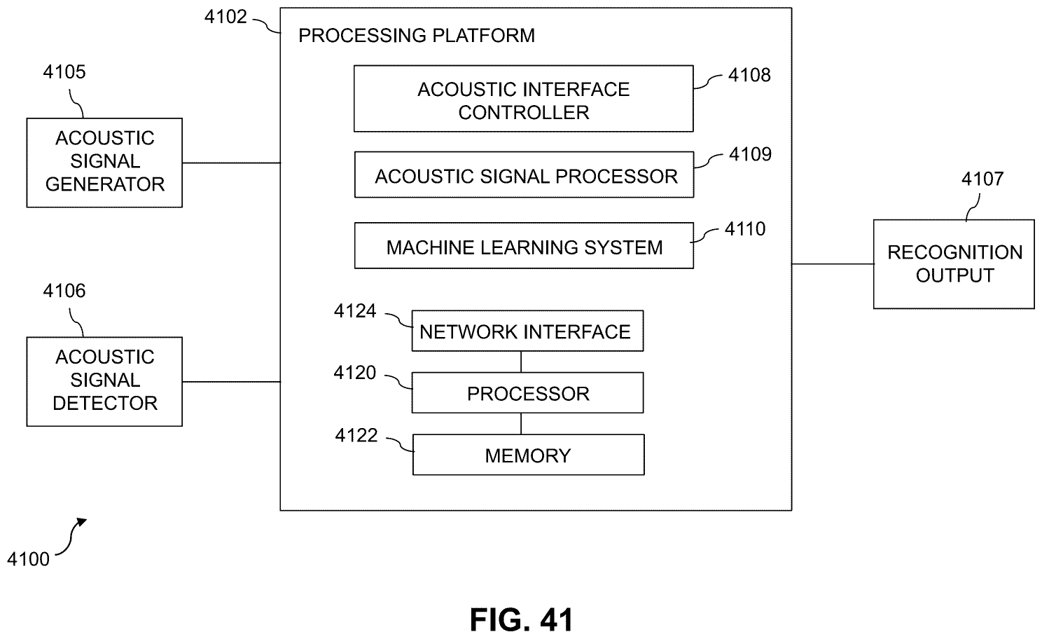

FIG. 41 shows an information processing system comprising an acoustic interface system that includes a processing platform configured to implement machine learning based acoustic signal processing in an illustrative embodiment.

In some embodiments, an acoustic interface system is configured to track activities inside the upper (e.g., oral tract, throat) and lower (e.g., lungs) respiratory system from outside the mouth in a minimalist form factor, illustratively using an inexpensive microphone and speaker. Numerous other applications can be implemented using the information processing system as illustrated in FIG. 41, including by way of example acoustics-based eye tracking and acoustics-based silent speech recognition, as previously described.

Illustrative embodiments overcome drawbacks of conventional approaches, in some implementations by using one or more nostril openings as a window into the respiratory tract cavities to detect various mouth-related activities and/or other activities, such as lung-related activities. For example, some techniques disclosed herein operate in a manner that is at least partially analogous to that of the human vocal folds, except that instead of sending sound at low frequencies (e.g., 80-300 Hz) through the pharynx and up into the oral cavity, the acoustic interface system is sending high frequency sound waves (e.g., 18 kHz+), illustratively from what is also referred to herein as an acoustic signal source, through the nasal cavity and into the underlying cavities (e.g., oral and lungs) to capture mouth-related and/or lung-related activities.

The disclosed embodiments have numerous diverse applications, including speech recognition, silent speech recognition, tongue tracking for human-computer input, breathing or coughing detection, eating/drinking detection, throat inflammation detection, etc. For example, illustrative embodiments of an acoustic interface system can be configured to recognize whenever the shape of the respiratory tract changes, even if due to minimal activity such as the tongue wiggling or a slight inhalation. Again, numerous other applications are possible, as is apparent from other description herein.

FIG. 41 more particularly shows an information processing system 4100 implementing machine learning based acoustic signal processing in an illustrative embodiment. The information processing system 4100 may be viewed as one possible example of what is also referred to herein as an “acoustic interface system” and is illustratively configured to interface with one or more human users. The system 4100 comprises a processing platform 4102. Coupled to the processing platform 4102 are at least one acoustic signal generator 4105 and at least one acoustic signal detector 4106, and the processing platform generates recognition output 4107.

The acoustic signal generator 4105 may be implemented, for example, utilizing one or more speakers, and the acoustic signal detector 4106 may be implemented, for example, utilizing one or more microphones, although it is to be appreciated that various types of alternative transducers or other acoustic components can be used. The recognition output 4107 in some embodiments comprises control signals or other types of signals generated by the processing platform 4102, possibly to control one or more external processing devices that are not explicitly shown. In some embodiments, the processing platform 4102, the acoustic signal generator 4105, the acoustic signal detector 4106 and the recognition output 4107 are part of the same device or set of devices, such as a VR headset or other type of wearable device. Other examples of wearable devices that can be used to implement at least portions of the system 4100 include face masks and eyeglass frames, among numerous others.

The processing platform 4102 comprises an acoustic interface controller 4108, an acoustic signal processor 4109 and a machine learning system 4110. The machine learning system 4110 in the present embodiment more particularly implements one or more machine learning algorithms, such as neural network based machine learning algorithms configured to facilitate the generation of recognition output relating to acoustic signal processing of the type described elsewhere herein, although other arrangements are possible. For example, in some embodiments, the machine learning system 4110 implements at least one neural network, such as a Resnet-18 neural network, which is a type of CNN that is 18 layers deep. It is to be appreciated that numerous other neural networks can be used, including a wide variety of alternative types of CNNs and/or RNNs, in any combination.

In operation, the system 4100 is illustratively configured to generate an acoustic signal via the acoustic signal generator 4105, and to direct the acoustic signal into at least a portion of a respiratory cavity (e.g., a nasal cavity and/or an oral cavity) of a human user. The system 4100 is further configured to detect the acoustic signal as reflected back from at least a portion of the respiratory cavity, utilizing the acoustic signal detector 4106, to process information characterizing at least the reflected acoustic signal in the machine learning system 4110, and to obtain recognition output 4107 from the machine learning system 4110 based at least in part on the processing of the information characterizing at least the reflected acoustic signal.

The information characterizing at least the reflected acoustic signal may comprise, for example, the reflected acoustic signal itself, and/or other information generated by acoustic signal processing of the input acoustic signal and the reflected acoustic signal in the acoustic signal processor 4109.

The above-noted operations are illustratively performed by or under the control of one or more processing devices of the processing platform 4102, with each such processing device comprising a processor coupled to a memory. For example, in some embodiments, the acoustic interface controller 4108 controls the performance of the above-noted operations, which may further involve directing the acoustic signal processor 4109 to provide appropriate control signals to drive the acoustic signal generator 4105 and to perform acoustic signal processing utilizing the input acoustic signal from the acoustic signal generator 4105 and the reflected acoustic signal detected by the acoustic signal detector 4106.

In some embodiments, the recognition output 4107 obtained from the machine learning system 4110 is indicative of one or more characteristics of at least one of speaking, eating, tongue movement and breathing of the human user.

Additionally or alternatively, the recognition output obtained from the machine learning system 4110 in some embodiments comprises silent speech recognition output.

In some embodiments, directing the acoustic signal into at least a portion of the respiratory cavity of the human user illustratively comprises directing the acoustic signal into a first nostril of the human user.

In such an embodiment, detecting the acoustic signal as reflected back from at least a portion of the respiratory cavity illustratively comprises detecting the reflected acoustic signal at a second nostril of the human user. Additionally or alternatively, detecting the acoustic signal as reflected back from at least a portion of the respiratory cavity illustratively comprises detecting the reflected acoustic signal at a mouth of the human user.

As indicated previously, the recognition output 4107 can include one or more control signals. For example, silent speech recognition output of the processing platform 4102 can be used to control an external device, such as a computer, mobile telephone, television, gaming console or other type of processing device.

The recognition output 4107 in some embodiments is illustratively configured to trigger at least one automated action in at least one processing device that implements the processing platform 4102, and/or in at least one additional processing device external to the processing platform 4102. For example, as mentioned above, one or more control signals that are part of the recognition output 4107 may be transmitted over a network from a first processing device that implements at least a portion of the processing platform 4102 to trigger at least one automated action in a second processing device that is external to the processing platform 4102.

As a more particular example, the control signal generated by the processing platform 4102 illustratively comprises at least one control signal configured to automatically adjust one or more parameters of an external computer or other processing device.

It is to be appreciated that the term “machine learning system” as used herein is intended to be broadly construed to encompass at least one machine learning algorithm configured to facilitate acoustic signal processing through utilization of one or more machine learning techniques. The processing platform 4102 may therefore be viewed as an example of a “machine learning system” as that term is broadly used herein.

Although the acoustic interface controller 4108, the acoustic signal processor 4109 and the machine learning system 4110 are all shown as being implemented on processing platform 4102 in the present embodiment, this is by way of illustrative example only. In other embodiments, the acoustic interface controller 4108, the acoustic signal processor 4109 and the machine learning system 4110 can each be implemented on a separate processing platform. A given such processing platform is assumed to include at least one processing device comprising a processor coupled to a memory.

Examples of such processing devices include computers, servers or other processing devices arranged to communicate over a network.

The network can comprise, for example, a global computer network such as the Internet, a WAN, a LAN, a satellite network, a telephone or cable network, a cellular network such as a 4G or 5G network, a wireless network implemented using a wireless protocol such as Bluetooth, WiFi or WiMAX, or various portions or combinations of these and other types of communication networks.

It is also possible that at least portions of other system elements such as the acoustic signal generator 4105 and/or the acoustic signal detector 4106 can be implemented as part of the processing platform 4102, although shown as being separate from the processing platform 4102 in the figure. For example, in some embodiments, all of these components of the system 4100 can be implemented in a VR headset or other wearable.

Examples of automated actions that may be taken in the system 4100 responsive to recognition output 4107 generated by the machine learning system 4110 include controlling one or more processing devices over a network.

A wide variety of additional or alternative automated actions may be taken in other embodiments. The particular automated action or actions will tend to vary depending upon the particular application in which the system 4100 is deployed.

For example, some embodiments disclosed herein implement acoustic interface systems for silent speech recognition and numerous other applications, as described in more detail elsewhere herein. It is to be appreciated that the term “automated action” as used herein is intended to be broadly construed, so as to encompass the above-described automated actions, as well as numerous other actions that are automatically driven based at least in part on outputs of a machine learning algorithm as disclosed herein.

The processing platform 4102 in the present embodiment further comprises a processor 4120, a memory 4122 and a network interface 4124. The processor 4120 is assumed to be operatively coupled to the memory 4122 and to the network interface 4124 as illustrated by the interconnections shown in the figure.

The processor 4120 may comprise, for example, a microprocessor, an application-specific integrated circuit (ASIC), a field-programmable gate array (FPGA), a central processing unit (CPU), a graphics processing unit (GPU), a tensor processing unit (TPU), an arithmetic logic unit (ALU), a digital signal processor (DSP), or other similar processing device component, as well as other types and arrangements of processing circuitry, in any combination. At least a portion of the functionality of at least one machine learning system and its associated machine learning algorithms provided by one or more processing devices as disclosed herein can be implemented using such circuitry.

In some embodiments, the processor 4120 comprises one or more graphics processor integrated circuits. Such graphics processor integrated circuits are illustratively implemented in the form of one or more GPUs. Accordingly, in some embodiments, system 4100 is configured to include a GPU-based processing platform. Such a GPU-based processing platform can be cloud-based configured to implement one or more machine learning systems for processing data associated with a large number of system users. Similar arrangements can be implemented using TPUs and/or other processing devices.

Numerous other arrangements are possible. For example, in some embodiments, a machine learning system can be implemented on a single processor-based device, such as a smart phone, client computer, wearable device or other user device, utilizing one or more processors of that device. Such embodiments are also referred to herein as “on-device” implementations of machine learning systems.

The memory 4122 stores software program code for execution by the processor 4120 in implementing at least portions of the functionality of the processing platform 4102. For example, at least portions of the functionality of acoustic interface controller 4108, acoustic signal processor 4109 and machine learning system 4110 can be implemented using program code stored in memory 4122.

A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, flash memory, ROM, magnetic memory, optical memory, or other types of storage devices in any combination.

Articles of manufacture comprising such processor-readable storage media are considered embodiments of the invention. The term “article of manufacture” as used herein should be understood to exclude transitory, propagating signals.

Other types of computer program products comprising processor-readable storage media can be implemented in other embodiments.

In addition, illustrative embodiments may be implemented in the form of integrated circuits comprising processing circuitry configured to implement processing operations associated with one or more of acoustic interface controller 4108, acoustic signal processor 4109 and machine learning system 4110 as well as other related functionality. For example, at least a portion of the machine learning system 4110 is illustratively implemented in at least one neural network integrated circuit of a processing device of the processing platform 4102.

The network interface 4124 is configured to allow the processing platform 4102 to communicate over one or more networks with other system elements, and may comprise one or more conventional transceivers.

It is to be appreciated that the particular arrangement of components and other system elements shown in FIG. 41 is presented by way of illustrative example only, and numerous alternative embodiments are possible. For example, other embodiments of information processing systems can be configured to implement machine learning system functionality of the type disclosed herein.

As indicated previously, the system 4100 can be configured to support a wide variety of distinct applications, in numerous diverse contexts, as disclosed in conjunction with the description of other illustrative embodiments herein.

It is to be appreciated that the particular arrangements described above are examples only, intended to demonstrate utility of illustrative embodiments, and should not be viewed as limiting in any way.

Automated actions taken based on outputs generated by a machine learning system of the type disclosed herein can include particular actions involving interaction between a processing platform implementing the machine learning system and other related equipment utilized in one or more of the applications described above. For example, outputs generated by a machine learning system can control one or more components of a related system. In some embodiments, the machine learning system and the related equipment are implemented on the same processing platform, which may comprise a computer, mobile telephone, wearable device, gaming system or other arrangement of one or more processing devices.

It should also be understood that the particular arrangements shown and described in conjunction with FIGS. 1 through 41 are presented by way of illustrative example only, and numerous alternative embodiments are possible. The various embodiments disclosed herein should therefore not be construed as limiting in any way. Numerous alternative arrangements of machine learning based acoustic signal processing can be utilized in other embodiments. Those skilled in the art will also recognize that alternative processing operations and associated system configurations can be used in other embodiments.

It is therefore possible that other embodiments may include additional or alternative system elements, relative to the entities of the illustrative embodiments. Accordingly, the particular system configurations and associated algorithm implementations can be varied in other embodiments.

A given processing device or other component of an information processing system as described herein is illustratively configured utilizing a corresponding processing device comprising a processor coupled to a memory. The processor executes software program code stored in the memory in order to control the performance of processing operations and other functionality. The processing device also comprises a network interface that supports communication over one or more networks.

The processor may comprise, for example, a microprocessor, an ASIC, an FPGA, a CPU, a GPU, a TPU, an ALU, a DSP, or other similar processing device component, as well as other types and arrangements of processing circuitry, in any combination. For example, at least a portion of the functionality of at least one machine learning system, and its machine learning algorithms for acoustic signal processing applications, provided by one or more processing devices as disclosed herein, can be implemented using such circuitry.

The memory stores software program code for execution by the processor in implementing portions of the functionality of the processing device. A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, ROM, flash memory, magnetic memory, optical memory, or other types of storage devices in any combination.

As mentioned previously, articles of manufacture comprising such processor-readable storage media are considered embodiments of the invention. The term “article of manufacture” as used herein should be understood to exclude transitory, propagating signals. Other types of computer program products comprising processor-readable storage media can be implemented in other embodiments.

In addition, embodiments of the invention may be implemented in the form of integrated circuits comprising processing circuitry configured to implement processing operations associated with implementation of a machine learning system.

An information processing system as disclosed herein may be implemented using one or more processing platforms, or portions thereof.

For example, one illustrative embodiment of a processing platform that may be used to implement at least a portion of an information processing system comprises cloud infrastructure including virtual machines implemented using a hypervisor that runs on physical infrastructure. Such virtual machines may comprise respective processing devices that communicate with one another over one or more networks.

The cloud infrastructure in such an embodiment may further comprise one or more sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the information processing system.

Another illustrative embodiment of a processing platform that may be used to implement at least a portion of an information processing system as disclosed herein comprises a plurality of processing devices which communicate with one another over at least one network. Each processing device of the processing platform is assumed to comprise a processor coupled to a memory. A given such network can illustratively include, for example, a global computer network such as the Internet, a WAN, a LAN, a satellite network, a telephone or cable network, a cellular network such as a 4G or 5G network, a wireless network implemented using a wireless protocol such as Bluetooth, WiFi or WiMAX, or various portions or combinations of these and other types of communication networks.

Again, these particular processing platforms are presented by way of example only, and an information processing system may include additional or alternative processing platforms, as well as numerous distinct processing platforms in any combination, with each such platform comprising one or more computers, servers, storage devices or other processing devices.

A given processing platform implementing a machine learning system as disclosed herein can alternatively comprise a single processing device, such as a computer, mobile telephone, wearable device or other processing device, that implements not only the machine learning system but also at least portions of one or more other system elements. It is also possible in some embodiments that one or more such system elements can run on or be otherwise supported by cloud infrastructure or other types of virtualization infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system. Such components can communicate with other elements of the information processing system over any type of network or other communication media.

As indicated previously, components of the system as disclosed herein can be implemented at least in part in the form of one or more software programs stored in memory and executed by a processor of a processing device. For example, certain functionality disclosed herein can be implemented at least in part in the form of software.

The particular configurations of information processing systems described herein are exemplary only, and a given such system in other embodiments may include other elements in addition to or in place of those specifically shown, including one or more elements of a type commonly found in a conventional implementation of such a system.

For example, in some embodiments, an information processing system may be configured to utilize the disclosed techniques to provide additional or alternative functionality in other contexts.

It should again be emphasized that the particular embodiments described herein are intended to be illustrative only. As will be appreciated by those skilled in the art, other embodiments can be implemented utilizing a wide variety of different types and arrangements of systems, methods and devices than those utilized in the particular illustrative embodiments described herein, and in numerous alternative processing contexts. In addition, the particular assumptions made herein in the context of describing certain embodiments need not apply in other embodiments. These and numerous other alternative embodiments will be readily apparent to those skilled in the art.

What is claimed is:

1. A wearable system, comprising:
at least one imaging sensor configured to capture one or more image(s) of a facial feature of a wearer of the wearable system and to output image data corresponding to the one or more image(s);
a processor that receives the image data from each of the at least one imaging sensor; and
a physical memory, the physical memory comprising instructions that when executed by the processor cause the processor to:
generate a profile based on the image data from each of the at least one imaging sensor;
compare the profile to a model;
assign a deformation to the profile, the assigned deformation having a predetermined degree of correspondence to a selected one of a plurality of deformations in the model when compared to the profile; and
communicate a facial output based on the assigned deformation.

2. The wearable system of claim 1, wherein the at least one imaging sensor comprises an acoustic camera or an acoustic sensor configured to:
transmit at least one acoustic signal towards the wearer's face, wherein the at least one acoustic signal is a frequency modulated continuous-wave acoustic signal with a frequency above 18 kHz and within a range of 18 kHz to 24.5 kHz, including all 0.1 kHz values and ranges therebetween; and
detect at least one reflected acoustic signal from the wearer's face, wherein the at least one transmitted acoustic signal is reflected differently based on a change in eyeball shape and/or skin deformation associated with ocular movement.

3. The wearable system of claim 2, wherein the acoustic camera or the acoustic sensor comprise one or more speaker(s) and one or more microphone(s), each of the one or more speaker(s) configured to transmit the at least one acoustic signal towards the wearer's face and each of the one of more microphone(s) configured to receive the at least one reflected acoustic signal from the wearer's face.

4. The wearable system of claim 1, wherein the image data comprises at least one transmitted signal and at least one reflected signal, and wherein generating the profile comprises:
filtering the at least one transmitted signal and the at least one reflected signal; and
calculating a cross-correlation between the at least one filtered transmitted signal and the at least one filtered reflected signal.

5. The wearable system of claim 4, wherein filtering the at least one transmitted signal and the at least one reflected signal comprises removing data outside of a target frequency range, and wherein the target frequency range is 17.5 kHz to 25 kHz, including all 0.1 kHz values and ranges therebetween.

6. The wearable system of claim 1, wherein the assigned deformation is associated with a shape of the wearer's eyes and/or a deformation of skin in an orbital region around the wearer's eyes.

7. The wearable system of claim 1, wherein the communicated facial output comprises a gaze position of the wearer.

8. The wearable system of claim 7, wherein the gaze position comprises one or more position coordinate(s) associated with a Cartesian coordinate system, a polar coordinate system, or a spherical coordinate system.

9. The wearable system of claim 1, wherein the profile comprises an echo profile.

10. The wearable system of claim 1, wherein comparing the profile to the model comprises:
generating a second profile based on the image data;
generating a differential profile based on the profile and the second profile; and
comparing the differential profile to the model.

11. The wearable system of claim 10, wherein the profile comprises an echo profile and the differential profile comprises a differential echo profile.

12. The wearable system of claim 1, wherein the at least one imaging sensor is positioned on the wearable system to capture image data of a first facial feature on a first side of a sagittal plane of the wearer and to capture image data of a second facial feature on a second side of the sagittal plane of the wearer.

13. The wearable system of claim 12, wherein the first facial feature and the second facial feature are each associated with an orbital region of the wearer.

14. The wearable system of claim 1, wherein the at least one imaging sensor is positioned on the wearable system to capture image data of an orbital region of the wearer.

15. The wearable system of claim 1, wherein the model is trained using machine learning, and wherein the training comprises:
receiving one or more orbital region image(s) of a subject, each of the orbital region images corresponding to a gaze position of a plurality of gaze positions of the subject;
receiving one or more image(s) of the subject from the at least one imaging sensor, each of the images from the at least one imaging sensor also corresponding to a gaze position of the plurality of gaze positions of the subject; and
correlating, for each of the gaze positions, the one or more image(s) from the at least one imaging sensor corresponding to a particular gaze position to the one or more orbital region image(s) corresponding to the particular gaze position.

16. The wearable system of claim 1, wherein the at least one imaging sensor comprises a first imaging sensor and a second imaging sensor, the first imaging sensor positioned on the wearable system to capture first image data of a first facial feature of the wearer, and the second imaging sensor positioned on the wearable system to capture second image data of a second facial feature of the wearer,
wherein comparing the profile to the model comprises comparing a first profile associated with the first image data of the first facial feature of the wearer to the model and comparing a second profile associated with the second image data of the second facial feature of the wearer to the model,
wherein assigning a deformation to the profile comprises assigning a first deformation to the first profile and a second deformation to the second profile, and
wherein the facial output being based on the assigned first deformation and the assigned second deformation.

17. The wearable system of claim 16, wherein the first imaging sensor and the second imaging sensor are configured to transmit acoustic signals within different frequency ranges.

18. The wearable system of claim 17, wherein the first imaging sensor is configured to transmit acoustic signals in a frequency range of 18-21 kHz and the second imaging sensor is configured to transmit acoustic signals in a frequency range of 21.5-24.5 kHz.

19. The wearable system of claim 16, wherein the first imaging sensor and the second imaging sensor are configured in a symmetrical orientation on the wearable system relative to a sagittal plane of the wearer.

20. The wearable system of claim 16, wherein the first imaging sensor is positioned on the wearable system to capture image data of the first facial feature on a first side of a sagittal plane of the wearer, and the second imaging sensor is positioned on the wearable system to capture an image of the second facial feature on a second side of the sagittal plane of the wearer.

21. The wearable system of claim 20, wherein the first facial feature comprises a left side of an orbital region of the wearer, and the second facial feature comprises a right side of the face of the orbital region of the wearer.

22. The wearable system of claim 1, wherein the wearable system comprises glasses, smart glasses, goggles, spectacles, or another head-borne device to which the at least one imaging sensor is attached.

23. The wearable system of claim 1, wherein the physical memory comprises further instructions that when executed by the processor cause the processor to:
compare the assigned deformation to a second model; and
assign the facial output based on the assigned deformation, the assigned facial output having a predetermined degree of correspondence to a selected one of a plurality of deformations in the second model when compared to the assigned deformation.

24. The wearable system of claim 23, wherein the second model is trained using machine learning, and wherein the training comprises:
receiving one or more orbital region image(s) of a subject, each of the orbital region images corresponding to a gaze position of a plurality of gaze positions of the subject;
receiving one or more image(s) of the subject from the at least one imaging sensor, each of the images from the at least one imaging sensor also corresponding to a gaze position of the plurality of gaze positions of the subject; and
correlating, for each of the gaze positions, the one or more image(s) from the at least one imaging sensor corresponding to a particular gaze position to the one or more orbital region image(s) corresponding to the particular gaze position.

25. The wearable system of claim 1, further comprising a computing device that receives and displays the communicated facial output.

26. The wearable system of claim 1, wherein the physical memory comprises further instructions that when executed by the processor cause the processor to:
receive a second set of image data from each of the at least one imaging sensor;
generate a second profile based on the second set of image data from each of the at least one imaging sensor;
compare the second profile to the model;
assign a second deformation to the second profile, the assigned second deformation having a predetermined degree of correspondence to a selected one of the plurality of deformations in the model when compared to the second profile; and
communicate a second facial output based on the assigned second deformation.

27. The wearable system of claim 26, further comprising a computing device that receives and displays the communicated facial output and the communicated second facial output, wherein the communicated facial output and the communicated second facial output are gaze positions of the wearer, the communicated second facial output being displayed subsequent to the communicated facial output to illustrate a motion of gaze positions.

28. A method to determine a facial output using a wearable system, comprising:
positioning a first imaging sensor of a wearable system to image a first facial feature of a wearer;
imaging the first facial feature of the wearer using the first imaging sensor;
comparing, via a processor, the imaged first facial feature to a first model; and
assigning, via the processor, a facial output corresponding to the imaged first facial feature selected from one of a plurality of facial outputs in the first model.

29. The method of claim 28, wherein the act of positioning the first imaging sensor of the wearable system comprises positioning the first imaging sensor in a vicinity of eyes of the wearer facing inward to include within a field of view an orbital region of one side of the wearer's face.

30. A method to determine a facial output using a wearable system, comprising:
positioning a first imaging sensor of a wearable system to image a first facial feature of a wearer;
positioning a second imaging sensor of the wearable system to image a second facial feature of the wearer;
imaging the first facial feature of the wearer using the first imaging sensor;
imaging the second facial feature of the wearer using the second imaging sensor;
comparing, via a processor, the imaged first facial feature and the imaged second facial feature to a model; and
assigning, via the processor, a facial output selected from one of a plurality of facial outputs in the model corresponding to the imaged first facial feature and the imaged second facial feature.
